(19) United States
(12) Patent Application Publication
(10) Pub. No.: US 2020/0314163 A1
(43) Pub. Date: Oct. 1, 2020

(54) IMAGE PROCESSING DEVICE AND METHOD THEREOF

(71) Applicant: SONY CORPORATION, TOKYO (JP)

(72) Inventors: TOSHIYA HAMADA, SAITAMA (JP); MITSURU KATSUMATA, TOKYO (JP); MITSUHIRO HIRABAYASHI, TOKYO (JP)

(21) Appl. No.: 16/088,357

(22) PCT Filed: Mar. 17, 2017
(86) PCT No.: PCT/JP2017/010872

§ 371 Date: Sep. 25, 2018

(30) Foreign Application Priority Data
Mar. 31, 2016 (JP) 2016-072172

(51) Int. Cl. H04L 29/06; H04L 29/08; G10L 19/00

(52) U.S. Cl. CPC H04L 65/607; G10L 19/0017; H04L 67/06; H04L 65/608

(57) ABSTRACT

The present disclosure relates to an information processing device and a method thereof capable of more stably transmitting content data. Information regarding switching across first management units for managing a data group of same content of data to be reproduced is set in management information for managing reproduction of data of the content. The present disclosure is applicable to, for example, an information processing device, a file generation device, a distribution server, a reproduction terminal or the like.

### TECHNICAL FIELD

The present disclosure relates to an information processing device and a method thereof, and especially relates to an information processing device and a method thereof capable of more stably transmitting content data.

### BACKGROUND ART

Conventionally, Moving Picture Experts Group phase-Dynamic Adaptive Streaming over HTTP) (MPEG-DASH) is developed for streaming distribution of video and music data via the Internet (for example, refer to Non-Patent Document 1). Furthermore, as a means for delivering high-quality video and music to users, streaming distribution using MPEG-DASH using International Organization for Standardization (ISO) Base Media File Format (ISOBMFF) file prescribed by ISO/IEC 14496-12 is considered. The quality of video and music data is improved, and at the same time, distribution of higher-quality data is also required.

For example, for high-quality encoding of music, Direct Stream Digital (DSD) is known as a high-quality encoding system. Since DSD data is of a high rate, a lossless compression system (DSD lossless compression system) is considered. In recent years, a new DSD lossless compression encoding system with a smaller load is also considered.

### CITATION LIST

### Non-Patent Document

Non-Patent Document 1: MPEG-DASH (Dynamic Adaptive Streaming over HTTP) (URL:http://mpeg.chiariglione.org/standards/mpeg-dash/media-presentation-description-and-segment-formats/text-isoiec-23009-12012-dam-1)

### SUMMARY OF THE INVENTION

### Problems to be Solved by the Invention

Even when high-quality data is distributed in this manner, from the viewpoint of transmission band and compatibility, it is required to also use conventional low-quality data distribution. That is, it is required to perform switching (switching of distribution data) between data of different encoding systems.

However, in Media Presentation Description (MPD) of MPEG-DASH, data of different encoding systems are managed by different Adaptation Sets. In addition, in the conventional MPEG-DASH standard, switching across the Adaptation Sets is not taken into consideration, and it is difficult to realize such switching. Therefore, it is difficult to stably distribute higher-quality content data.

The present disclosure is achieved in view of such a situation, and an object thereof is to make it possible to transmit the content data more stably.

### Solutions to Problems

An information processing device according to one aspect of the present technology is an information processing device provided with a setting unit which sets information regarding switching across first management units for managing a data group of same content of data to be reproduced in management information for managing reproduction of data of the content.

The information regarding the switching may be information for designating a management unit allowed as a switching destination of the switching across the first management units of the data to be reproduced.

The information for designating the management unit may be information for designating another first management unit allowed as the switching destination or information for designating a second management unit for managing each data in the other first management unit.

The setting unit may set the information for designating the management unit in the first management unit of the management information or the second management unit for managing each data in the first management unit of the management information.

The information regarding the switching may be information for designating timing at which the switching across the first management units of the data to be reproduced is allowed.

The timing may be a boundary of a second management unit which is a management unit in a reproduction time direction of the data, and the information for designating the timing may be information for designating the boundary of the second management unit at which the switching across the first management units of the data to be reproduced is allowed.

The information for designating the timing may be information for designating the timing by the number of second management units until next timing.

Reproduction time may coincide between switching source data and switching destination data at the timing.

The setting unit may set the information for designating the timing in a first management unit of the management information or a second management unit for managing each data in the first management unit of the management information.

The information regarding the switching may be information regarding priority order of the switching across the first management units of the data to be reproduced.

The information regarding the priority order may be information indicating the priority order of the first management unit.

The information regarding the priority order may be information indicating priority order of a group of the first management units.

The setting unit may set the information regarding the priority order in the first management unit.

The data may be a file of a file format compliant with ISO/IEC 14496 which stores a DSD lossless stream acquired by lossless encoding of direct stream digital (DSD) data acquired by performing ΔΣ modulation on an audio analog signal.

A file generation unit which generates a file of the management information on the basis of setting of the setting unit may be further provided.

A data generation unit which generates the data may be further provided, in which the file generation unit may be configured to generate the file of the management information of data generated by the data generation unit.

A transmission unit which transmits the file generated by the file generation unit to a server may be further provided.

An information processing method according to one aspect of the present technology is an information processing method of setting information regarding switching across first management units for managing a data group of same content of data to be reproduced in management information for managing reproduction of data of the content.

An information processing device according to another aspect of the present technology is an information processing device provided with an analysis unit which analyzes information regarding switching across first management units for managing a data group of same content of data to be reproduced included in management information for managing reproduction of data of the content, and a control unit which controls the switching of the data to be reproduced on the basis of an analysis result of the analysis unit.

An information processing method according to another aspect of the present technology is an information processing method of analyzing information regarding switching across first management units for managing a data group of same content of data to be reproduced included in management information for managing reproduction of data of the content, and controlling the switching of the data to be reproduced on the basis of an analysis result.

In an information processing device and a method thereof according to one aspect of the present technology, information regarding switching across first management units for managing a data group of same content of data to be reproduced in management information for managing reproduction of data of the content is set.

In an information processing device and a method thereof according to another aspect of the present technology, information regarding switching across first management units for managing a data group of same content of data to be reproduced included in management information for managing reproduction of data of the content is analyzed, and the switching of the data to be reproduced is controlled on the basis of an analysis result.

### Effects of the Invention

According to the present disclosure, information may be processed. Especially, content data may be transmitted more stably.

### BRIEF DESCRIPTION OF DRAWINGS

FIG. 1 is a view for illustrating an example of a state of data transmission using MPEG-DASH.

FIG. 2 is a view illustrating a configuration example of MPD.

FIG. 3 is a view for illustrating a temporal break of content.

FIG. 4 is a view illustrating an example of a hierarchical structure of Period and lower order in the MPD.

FIG. 5 is a view for illustrating a configuration example of an MPD file on a time axis.

FIG. 6 is a view for illustrating a DSD system.

FIG. 7 is a view for illustrating an example of a state of bit rate variation of streaming distribution.

FIG. 8 is a block diagram illustrating a principal configuration example of a compression encoding device.

FIG. 9 is a view for illustrating a method of creating a data generation count table pretable.

FIG. 10 is a view for illustrating a conversion table table1.

FIG. 11 is a block diagram illustrating a configuration example of an encode unit.

FIG. 12 is a flowchart for illustrating compression encoding processing.

FIG. 13 is a block diagram illustrating a principal configuration example of a decoding device.

FIG. 14 is a flowchart for illustrating decoding processing.

FIG. 15 is a view illustrating a principal configuration example of a DSD lossless stream.

FIG. 16 is a view illustrating an example of syntax of the DSD lossless stream.

FIG. 17 is a view illustrating a configuration example of the MPD.

FIG. 18 is a view illustrating a configuration example of the MPD.

FIG. 19 is a view for illustrating @ContentSwitchingAlignmentCycle.

FIG. 20 is a view illustrating a configuration example of the MPD.

FIG. 21 is a view illustrating a description example of the MPD.

FIG. 22 is a view illustrating a description example of the MPD.

FIG. 23 is a view illustrating a configuration example of the MPD.

FIG. 24 is a view illustrating a description example of the MPD.

FIG. 25 is a view illustrating a configuration example of the MPD.

FIG. 26 is a view illustrating a description example of the MPD.

FIG. 27 is a view illustrating a description example of the MPD.

FIG. 28 is a view illustrating a configuration example of the MPD.

FIG. 29 is a view illustrating a description example of the MPD.

FIG. 30 is a block diagram illustrating a principal configuration example of a distribution system.

FIG. 31 is a block diagram illustrating a principal configuration example of a file generation device.

FIG. 32 is a flowchart for illustrating an example of a flow of distribution data generation processing.

FIG. 33 is a flowchart for illustrating an example of a flow of MPD file generation processing.

FIG. 34 is a block diagram illustrating a principal configuration example of a reproduction terminal.

FIG. 35 is a flowchart for illustrating an example of a flow of reproduction processing.

FIG. 36 is a flowchart for illustrating an example of a flow of parsing processing.

FIG. 37 is a flowchart for illustrating an example of a flow of content file acquisition processing.

FIG. 38 is a view illustrating an example of switching limitation.

FIG. 39 is a view illustrating an example of @stabilityRanking.

FIG. 40 is a view illustrating an example of switching control using @stabilityRanking.

FIG. 41 is a view illustrating a description example of the MPD.

FIG. 42 is a view illustrating an example of switching control using @stabilityRanking.

FIG. 43 is a block diagram illustrating a principal configuration example of a file generation device.

FIG. 44 is a flowchart for illustrating an example of a flow of MPD file generation processing.

FIG. 45 is a block diagram illustrating a principal configuration example of a reproduction terminal.

FIG. 46 is a flowchart for illustrating an example of a flow of parsing processing.

FIG. 47 is a flowchart for illustrating an example of a flow of content file acquisition processing.

FIG. 48 is a flowchart for illustrating an example of a flow of switching processing.

FIG. 49 is a view illustrating an example of @stabilityRanking and @stabilityRankingGroup.

FIG. 50 is a view illustrating an example of switching control using @stabilityRanking and @stabilityRankingGroup.

FIG. 51 is a view illustrating an example of switching control using @stabilityRanking and @stabilityRankingGroup.

FIG. 52 is a view illustrating an example of switching control using @stabilityRanking and @stabilityRankingGroup.

FIG. 53 is a view illustrating an example of switching control using @stabilityRanking and @stabilityRankingGroup.

FIG. 54 is a block diagram illustrating a principal configuration example of a file generation device.

FIG. 55 is a flowchart for illustrating an example of a flow of MPD file generation processing.

FIG. 56 is a view for illustrating an example of a state of grouping and priority order addition.

FIG. 57 is a block diagram illustrating a principal configuration example of a reproduction terminal.

FIG. 58 is a flowchart for illustrating an example of a flow of parsing processing.

FIG. 59 is a flowchart for illustrating an example of a flow of content file acquisition processing.

FIG. 60 is a flowchart for illustrating an example of a flow of switching processing.

FIG. 61 is a block diagram illustrating a principal configuration example of a computer.

### MODE FOR CARRYING OUT THE INVENTION

Modes for carrying out the present disclosure (hereinafter, referred to as embodiments) are hereinafter described. Meanwhile, the description is given in the following order.

1. Switching across Adaptation Sets

2. First Embodiment (Distribution System: Switching Destination Designation Information and Timing Designation Information)

3. Second embodiment (Distribution System: Selection Priority Order Information)

4. Third embodiment (Distribution System: Group Information)

5. Others

<1. Switching across Adaptation Sets>

<Distribution of Video and Audio>

Recently, streaming distribution via the Internet is expected as a means for delivering video and music to consumers. However, the Internet as a transmission means is unstable in transmission as compared with broadcasting and optical disks. First, a highest rate of a transmission band significantly changes depending on an environment of a user. Furthermore, even for the same user, a constant transmission band is not always secured and this varies with time. Also, variation in transmission band means that a response time to a request from a client is not constant.

Moving Picture Experts Group-Dynamic Adaptive Streaming over HTTP (MPEG-DASH) has been developed as standards for such transmission via the Internet. This is a pull-type model in which a plurality of files of different data sizes is placed on a server side and the client refers to Media Presentation Description (MPD) to select an optimum file. A general HyperText Transfer Protocol (HTTP) server may be used by using not a special protocol but http. A file format is not only Moving Picture Experts Group-Transport Stream (MPEG-TS) but also International Organization for Standardization Base Media File Format (ISOBMFF).

<MPEG-DASH>

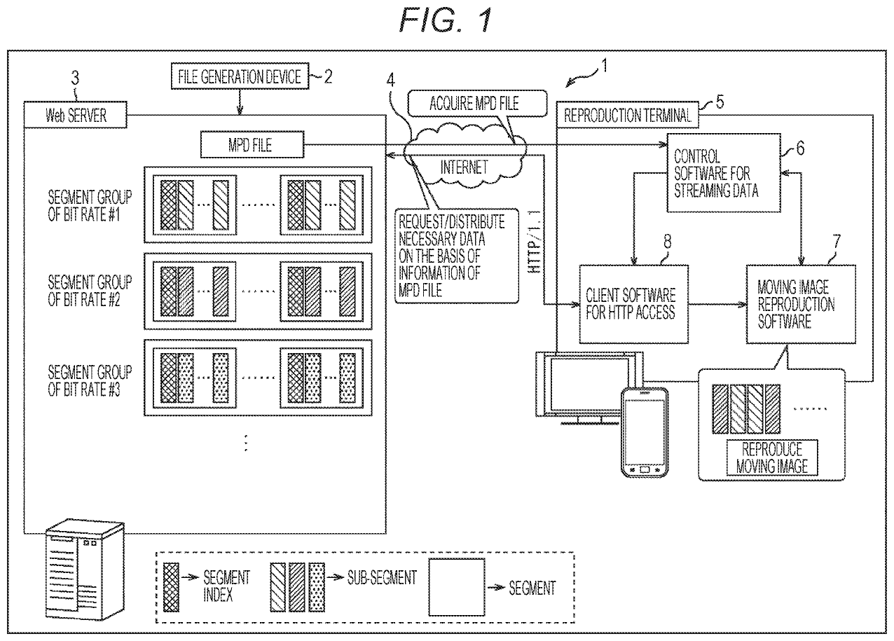

An example of a state of data transmission using the MPEG-DASH is illustrated in FIG. 1. In an information processing system 1 in FIG. 1, a file generation device 2 generates video data and audio data as moving image content, encodes the same, and converts the same into a file in a file format for transmission. For example, the file generation device 2 files (segments) the data every approximately 10 seconds. The file generation device 2 uploads the generated Segment file to a web server 3. In addition, the file generation device 2 generates an MPD file (management file) for managing moving image content and uploads the same to the web server 3.

The web server 3 as a DASH server live distributes the file of the moving image content generated by the file generation device 2 to a reproduction terminal 5 via the Internet 4 in a system compliant with the MPEG-DASH. For example, the web server 3 stores the Segment file and MPD file uploaded from the file generation device 2. Also, in response to a request from the reproduction terminal 5, the web server 3 transmits the stored Segment file and MPD file to the reproduction terminal 5.

The reproduction terminal 5 (reproduction device) executes software for controlling streaming data (hereinafter, also referred to as control software) 6, moving image reproduction software 7, client software for HTTP access (hereinafter, also referred to as access software) 8 and the like.

The control software 6 is software for controlling the data to be streamed from the web server 3. For example, the control software 6 acquires the MPD file from the web server 3. Also, the control software 6 instructs the access software 8 to request to transmit the Segment file to be reproduced on the basis of, for example, reproduction time information indicating reproduction time and the like designated by the MPD file, the moving image reproduction software 7 and the like, and a network band of the Internet 4.

The moving image reproduction software 7 is software for reproducing an encoded stream acquired from the web server 3 via the Internet 4. For example, the moving image reproduction software 7 designates the reproduction time information in the control software 6. In addition, when the moving image reproduction software 7 acquires notification of reception start from the access software 8, this decodes the encoded stream supplied from the access software 8. The moving image reproduction software 7 outputs the video data and audio data acquired as a result of decoding.

The access software 8 is software for controlling communication with the web server 3 using HTTP. For example, the access software 8 supplies the notification of reception start to the moving image reproduction software 7. Also, the access software 8 transmits a request to transmit the encoded stream of the Segment file to be reproduced to the web server 3 in response to the instruction of the control software 6. Furthermore, the access software 8 receives the Segment file of a bit rate according to a communication environment and the like transmitted from the web server 3 in response to the transmission request. Then, the access software 8 extracts the encoded stream from the received file and supplies the same to the moving image reproduction software 7.

<MPD>

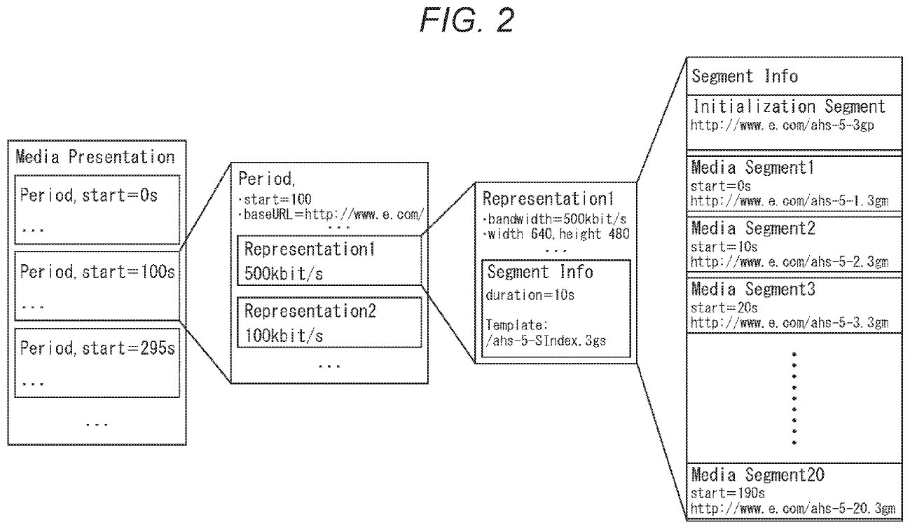

Next, the MPD is described. The MPD has a configuration as illustrated in FIG. 2, for example. When analyzing (parsing) the MPD, the client (the reproduction terminal 5 in a case of the example in FIG. 1) selects an optimum one from attributes of Representations included in Period of the MPD (Media Presentation in FIG. 2).

The client reads a leading Segment of the selected Representation, acquires an Initialization Segment, and processes the same. Subsequently, the client acquires subsequent Segments and reproduces the same.

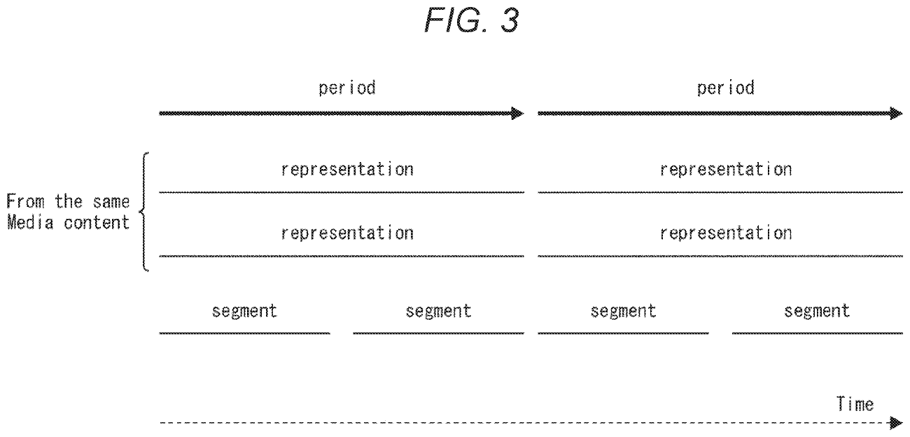

Meanwhile, a relationship among the Period, the Representation, and the Segment in the MPD is as illustrated in FIG. 3. That is, one media content may be managed for each Period being a data unit in a time direction, and each Period may be managed for each Segment being a data unit in the time direction. Also, for each Period, it is possible to configure a plurality of Representations with different attributes such as a bit rate.

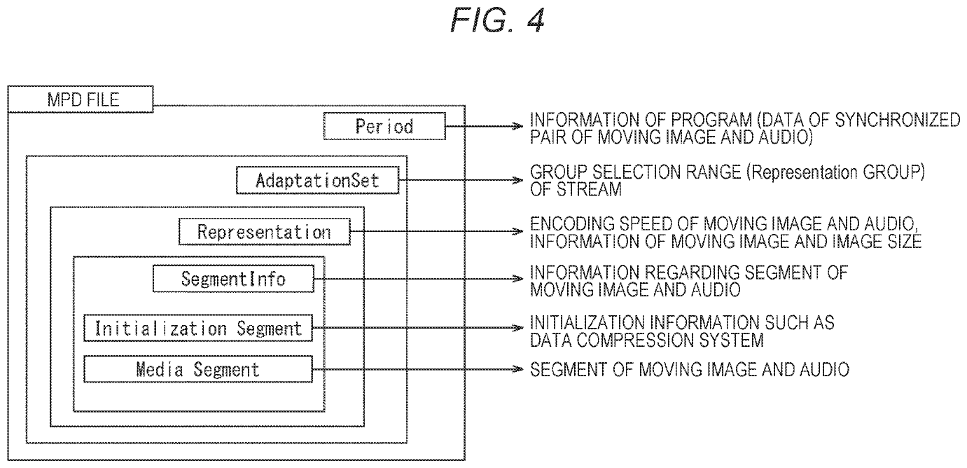

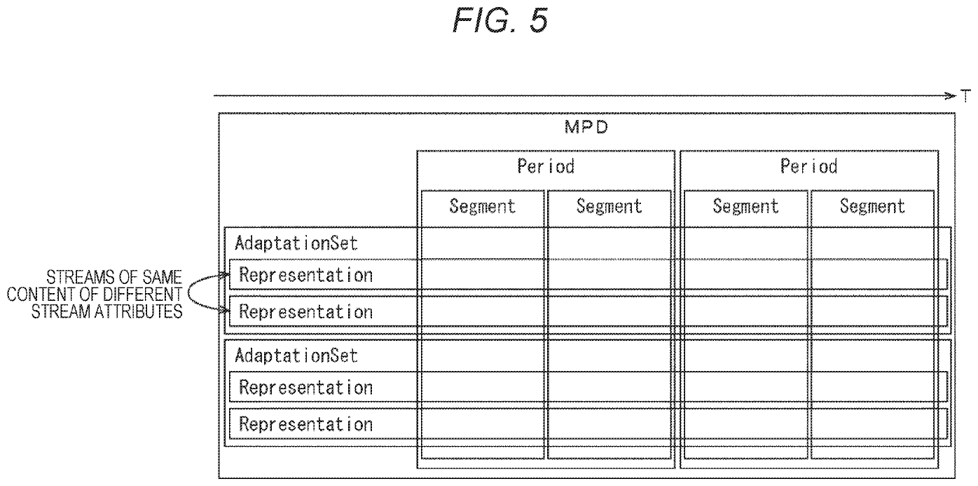

Therefore, the file of the MPD (also referred to as the MPD file) has a hierarchical structure as illustrated in FIG. 4 in the Period and lower levels. Also, when the structure of the MPD is arranged on a time axis, this is as illustrated in an example in FIG. 5. As is apparent from the example in FIG. 5, there is a plurality of Representations for the same Segment. By adaptively selecting one of them, the client may acquire and reproduce appropriate stream data according to the communication environment, decoding capability thereof and the like.

<DSD>

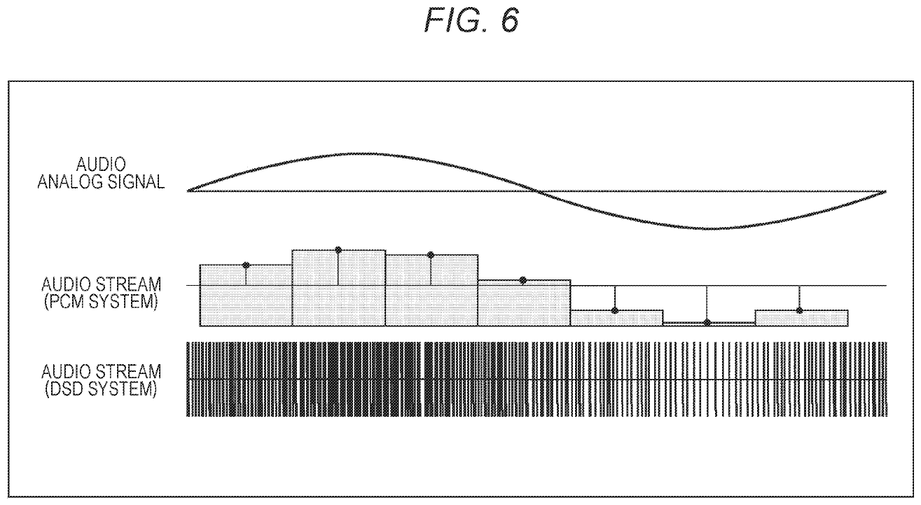

Incidentally, a quality of video and music data is improved, and at the same time, distribution of higher quality data is also required in distribution. For example, direct stream digital (DSD) is known as a high-quality modulation system for audio signals (FIG. 6). As illustrated in FIG. 6, in a case of pulse code modulation (PCM), a signal value at each sampling time of an audio analog signal is converted into fixed number-bit digital data, whereas in a case of the DSD, the audio analog signal is subjected to ΔΣ modulation and is converted into one-bit digital data.

In the case of the DSD, since a sampling frequency is as high as 2.8 MHz, 5.6 MHz, and 11.2 MHz, for example, the bit rate also becomes 5.6 Mbps, 11.2 Mbps, and 22.4 Mbps by two channels, respectively. Therefore, a system for compressing such high-rate DSD data in a lossless manner is devised.

<DST>

For example, as a lossless compression encoding system of the DSD data, there is Direct Stream Transfer (DST) developed for Super Audio Compact Disc (SACD) and standardized by MPEG4 Advanced Audio Coding (AAC) (International Organization for Standardization/International Electrotechnical Commission (IEC/ISO) 14496-3). However, this DST having too much load is not suitable for processing by software.

<New DSD Lossless Compression Encoding System>

Therefore, a new DSD lossless compression encoding system which may be realized also by software processing in an embedded processor is also developed by a method different from that of the DST. By using a DSD lossless stream generated by this new DSD lossless compression encoding system in distribution, it becomes possible to suppress a band required for transmission, and real time decoding in the software processing by a client such as PC or mobile terminal may be expected.

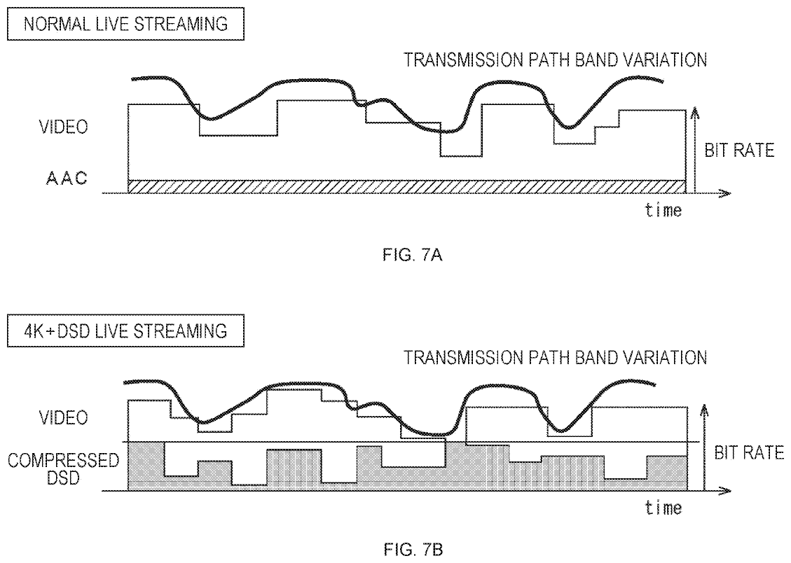

For example, as illustrated in A of FIG. 7, in a case of general live streaming using the AAC as the encoding system of the audio data, since the bit rate is constant, the bit rate of the video data is selected according to band variation of a transmission path. On the other hand, in a case of live streaming (4K+DSD) adopting the DSD lossless encoding system as the encoding system of the audio data, as illustrated in B of FIG. 7, the DSD lossless stream has large local rate variation. That is, a band margin caused by this rate variation may be allocated to transmission of the video data, which enables higher-quality video data transmission.

<Configuration Example of Compression Encoding Device>

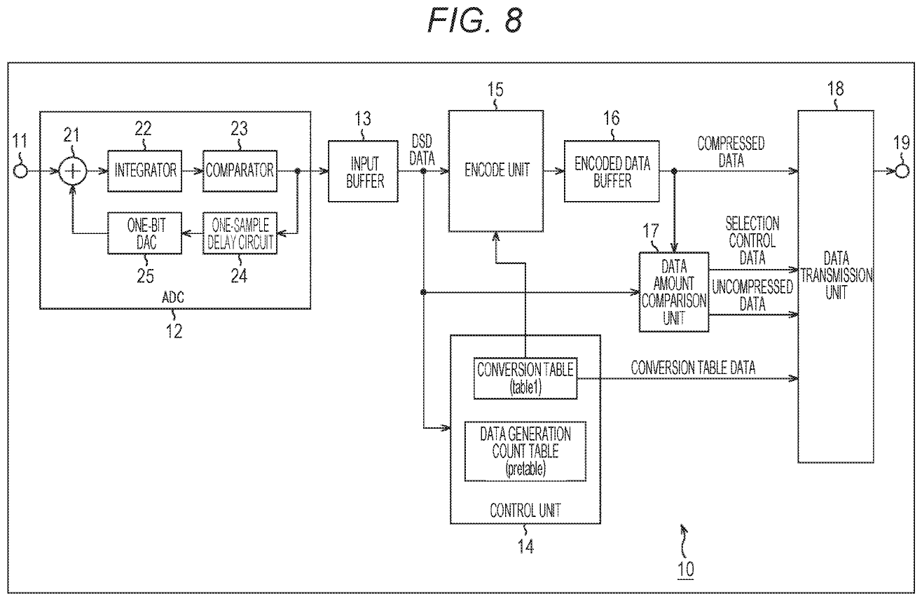

Next, this new DSD lossless compression encoding system is described. A principal configuration example of a compression encoding device supporting this new DSD lossless compression encoding system is illustrated in FIG. 8. The compression encoding device 10 illustrated in FIG. 8 is a device which converts the analog audio signal into a digital signal by ΣΔ (sigma-delta) modulation and compression encodes the converted audio signal to output. That is, the compression encoding device 10 is a device which modulates the audio signal by the DSD system and digitizes the same, encodes digital data (DSD data) by the above-described new DSD lossless compression encoding system, and generates the DSD lossless stream.

The analog audio signal is input from an input unit 11 and supplied to an analog digital converter (ADC) 12. The ADC 12 digitizes the supplied analog audio signal by the ΣΔ modulation and outputs the same to an input buffer 13.

The ADC 12 includes an adder 21, an integrator 22, a comparator 23, a one-sample delay circuit 24, and a one-bit digital analog converter (DAC) 25. The audio signal supplied from the input unit 11 is supplied to the adder 21. The adder 21 adds the analog audio signal one sampling period before supplied from the one-bit DAC 25 to the audio signal from the input unit 11, and outputs the same to the integrator 22. The integrator 22 integrates the audio signal from the adder 21 and outputs the same to the comparator 23. The comparator 23 compared with midpoint potential of the input audio signal one-bit quantizes for each sampling period. A frequency (sampling frequency) of the sampling period is a frequency 64 times or 128 times that of conventional 48 kHz and 44.1 kHz. The comparator 23 outputs the one-bit quantized audio signal to the input buffer 13 and also supplies the same to the one-sample delay circuit 24. The one-sample delay circuit 24 delays the audio signal from the comparator 23 by one sampling period and outputs the same to the one-bit DAC 25. The one-bit DAC 25 converts the digital signal from the one-sample delay circuit 24 into the analog signal and outputs the same to the adder 21.

The ADC 12 configured as described above converts (A/D converts) the audio signal supplied from the input unit 11 into a one-bit digital signal and outputs the same to the input buffer 13. According to the ΣΔ modulation A/D conversion, by making the frequency of the sampling period (sampling frequency) sufficiently high, it is possible to acquire a digital audio signal with a wide dynamic range even with a small number of bits, for example, one bit. For example, a stereo (two-channel) audio signal is input from the input unit 11 to the ADC 12, and the ADC 12 A/D converts the same into a one-bit signal with the sampling frequency of 128 times 44.1 kHz and outputs the same to the input buffer 13. Meanwhile, in the ΣΔ modulation, the number of bits of the quantization may be two or four.

The input buffer 13 temporarily accumulates the one-bit digital audio signal supplied from the ADC 12 and supplies the same to a control unit 14, an encode unit 15, and a data amount comparison unit 17 on a subsequent stage in a one frame unit. Herein, one frame is a unit to divide the audio signals into a predetermined time (period) to regard as one group. For example, three seconds may be made one frame. In other words, the input buffer 13 supplies the audio signals to the control unit 14, the encode unit 15, and the data amount comparison unit 17 in a unit of three seconds. As described above, the audio signal input from the input unit 11 is a stereo (two-channel) signal and is A/D converted into the one-bit signal with the sampling frequency of 128 times 44.1 kHz, so that a data amount per one frame is 44100 (Hz)*128*2(ch)*3(sec)=5.6 Mbits. Hereinafter, the ΔΣ modulated digital signal supplied from the input buffer 13 is also referred to as the DSD data.

The control unit 14 controls operation of an entire compression encoding device 1. Also, the control unit 14 has a function of creating a conversion table table1 required for the encode unit 15 to perform compression encoding, and supplying the same to the encode unit 15. For example, the control unit 14 creates a data generation count table pretable using one-frame of DSD data supplied from the input buffer 13, and further creates a conversion table table1 from the data generation count table pretable. The control unit 14 supplies the created conversion table table1 to the encode unit 15 and a data transmission unit 18. The conversion table table1 is created (updated) in a one-frame unit and supplied to the encode unit 15.

Using the conversion table table1 supplied from the control unit 14, the encode unit 15 compression encodes the DSD data supplied from the input buffer 13 in units of four bits. Therefore, the DSD data is supplied from the input buffer 13 to the encode unit 15 at the same time as this is supplied to the control unit 14, but in the encode unit 15, processing stands by until the conversion table is supplied from the control unit 14. The encode unit 15 encodes the four-bit DSD data into two-bit data or six-bit data, and outputs the data to an encoded data buffer 16.

The encoded data buffer 16 temporarily buffers compressed data which is the DSD data compression encoded by the encode unit 15, and supplies the same to the data amount comparison unit 17 and the data transmission unit 18.

The data amount comparison unit 17 compares the data amount of the DSD data (hereinafter also referred to as uncompressed data) supplied from the input buffer 13 with the data amount of the compressed data supplied from the encoded data buffer 16 in a frame unit. This is because, since the encode unit 15 encodes the four-bit DSD data into the two-bit data or the six-bit data as described above, there might be a case where the data amount after the compression exceeds the data amount before the compression in algorithm. Therefore, the data amount comparison unit 17 compares the data amount of the compressed data with the data amount of the uncompressed data, selects the one with a smaller data amount, and supplies selection control data indicating the selected one to the data transmission unit 18. Meanwhile, in a case of supplying the selection control data indicating that the uncompressed data is selected to the data transmission unit 18, the data amount comparison unit 17 also supplies the uncompressed data to the data transmission unit 18. As seen from a device on a reception side which receives transmission data, the selection control data may be said to be a flag indicating whether or not the audio data transmitted from the data transmission unit 18 is the data compression encoded by the encode unit 15.

On the basis of the selection control data supplied from the data amount comparison unit 17, the data transmission unit 18 selects either the compressed data supplied from the encoded data buffer 16 or the uncompressed data supplied from the data amount comparison unit 17 and transmits the same to a counterpart device via an output unit 19 together with the selection control data. Also, in a case of transmitting the compressed data, the data transmission unit 18 also adds data of the conversion table table1 supplied from the control unit 14 to the compressed data and transmits the same to the counterpart device. The data transmission unit 18 may add a synchronization signal and an error correction code (ECC) to the digital signals for each predetermined number of samples to transmit as the transmission data.

<Method of Creating Data Generation Count Table>

Next, a method of creating the data generation count table pretable by the control unit 14 is described.

The control unit 14 creates the data generation count table pretable for the one frame of DSD data; the DSD data supplied from the input buffer 13 is expressed in units of four bits as follows.

. . . D4[n−3], D4[n−2], D4[n−1], D4[n], D4[n+1], D4[n+2], D4[n+3], . . .

Herein, D4[n] represents four-bit continuous data, and hereinafter also referred to as D4 data (n>3).

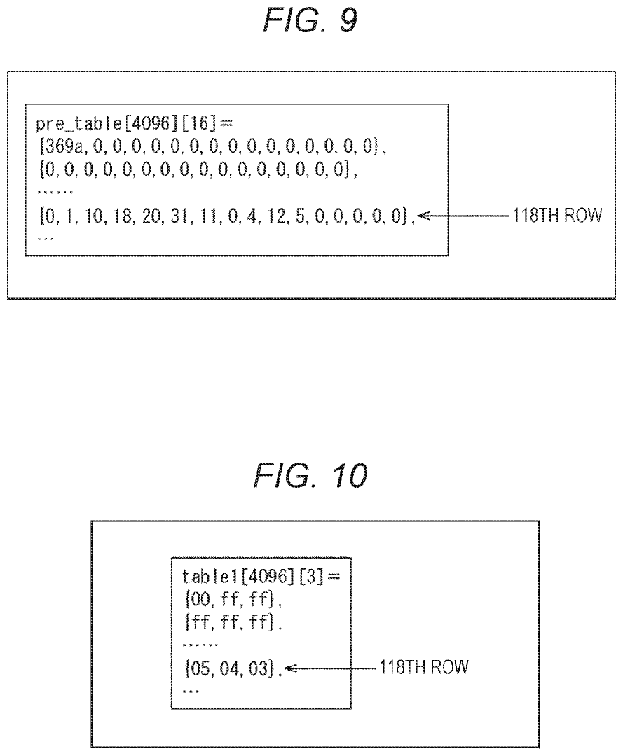

The control unit 14 counts the number of times of generation of D4 data next to past three D4 data (past 12-bit data) and creates a data generation count table pretable[4096][16] illustrated in FIG. 9. Herein, [4096] and [16] of the data generation count table pretable[4096][16] indicate that the data generation count table is a table (matrix) of 4096 rows and 16 columns, and each row from [0] to corresponds to a value (past bit pattern) which the past three D4 data may take, and each column from [0] to [15] corresponds to a value which next D4 data may take.

For example, pretable[0][0] to [0][15] being a first row of the data generation count table pretable indicate the number of times of generation of next data when the past three D4 data D4[n−3], D4[n−2], and D4[n−1] is “0”={0000, 0000, 0000}; this indicates the number of times that next four bits when the past three data are “0” is “0” is 369a (HEX notation), and there is no other data. Pretable [1][0] to [1][15] being a second row of the data generation count table pretable indicates the number of times of generation of the next data when the past three D4 data D4[n−3], D4[n−2], and D4[n−1] is “1”={0000, 0000, 0001}. The fact that all elements in the second row of the data generation count table pretable are “0” indicates that there is no data in which the three D4 data are “1” as the past data in this one frame. Also, in FIG. 9, pretable [117][0] to [117][15] being a 118th row of the data generation count table pretable indicates the number of times of generation of the next data when the past three D4 data D4[n−3], D4[n−2], and D4[n−1] is “117”={0000, 0111, 0101}. In this data, it is indicated that the number of times that the next four bits when the past three data is “117” is “0”, “1”, “2”, “3”, “4”, “5”, “6”, “7”, “8”, “9”, “10”, and “11” to “15” is 0, 1, 10, 18, 20, 31, 11, 0, 4, 12, 5, and 0, respectively.

As described above, the control unit 14 counts the number of generation of the D4 data next to the past three D4 data (past 12-bit data) for the one frame of DSD data, and creates the data generation count table pretable.

<Method of Creating Conversion Table>

Next, a method of creating the conversion table table1 by the control unit 14 is described.

The control unit 14 creates a conversion table table1[4096][3] of 4096 rows and three columns on the basis of the previously created data generation count table pretable. Herein, each of the rows [0] to [4095] of the conversion table table1[4096][3] corresponds to the value which the past three D4 data may take, and three values with higher generation frequency out of 16 values which the next D4 data of D4 may take are stored in each column [0] to [2]. In a first column [0] of the conversion table table1[4096][3], a value having a highest (first) generation frequency is stored, in a second column [1], a value having a second generation frequency is stored, and in a third column [2], a value having a third generation frequency is stored.

FIG. 10 illustrates an example of the conversion table table1[4096][3] corresponding to the data generation count table pretable illustrated in FIG. 9. In the conversion table table1[4096][3], table1[117][0] to [117][2] being a 118th row is {05, 04, 03}. This corresponds to content of pretable [117][0] to [117][15] of the 118th row of the data generation count table pretable in FIG. 9. In pretable[117][0] to [117][15] being the 118th row of the data generation count table pretable in FIG. 9, a value with a highest (first) generation frequency is “5” generated 31 times, a value with a second generation frequency is “4” generated 20 times, and a value with a third generation frequency is “3” generated 18 times. Therefore, {05} is stored in 118th row first column table1[117][0] of the conversion table table1[4096][3] in FIG. 10, {04} is stored in 118th row second column table1[117][1], and {03} is stored in 118th row third column table1[117][2]. Similarly, table1[0][0] to [0][2] being the first row of the conversion table table1[4096][3] in FIG. 10 corresponds to content of pretable[0][0] to [0][15] of the first row of the data generation count table pretable in FIG. 9.

In pretable[0][0] to [0][15] being the first row of the data generation count table pretable in FIG. 9, a value with a highest (first) generation frequency is “0” generated 369a times (HEX notation), and no other value is generated. Therefore, {00} is stored in first row first column table1[0][0] of the conversion table table1[4096][3] in FIG. 10 and {ff} indicating that there is no data is stored in first row second column table1[0][1] and first row third column table1[0][2]. A value indicating that there is no data is not limited to {ff}, and this may be determined as appropriate. Since the value stored in each element of the conversion table table1 is any one of “0” to “15”, this may be represented by four bits, but in terms of computer processing, this is represented by eight bits for ease of handling.

As described above, a 4096 rows and three columns conversion table table1[4096][3] is created on the basis of the previously created data generation count table pretable and supplied to encode unit 15.

<Compression Encoding Method by Encode Unit 15>

Next, a compression encoding method using the conversion table table1 by the encode unit 15 is described. For example, a case where the encode unit 15 encodes D4[n] out of the DSD data . . . D4[n−3], D4[n−2], D4[n−1], D4[n], D4[n+1], D4[n+2], D4[n+3], . . . supplied from the input buffer 13 is described.

In a case of encoding D4[n], the encode unit 15 regards D4[n−3],D4[n−2], and D4[n−1] being past 12-bit data immediately preceding the same as one 12-bit data and searches for three values of an address (row) indicated by D4[n−3], D4[n−2], and D4[n−1] of the conversion table table1[4096][3]: table1[D4[n−3],D4[n−2],D4[n−1]][0], table1[D4[n−3],D4[n−2],D4[n−1]][1], and table1[D4[n−3],D4[n−2],D4[n−1]][2].

In a case where there is one the same as D4[n] in the three values of the address (row) indicated by D4[n−3], D4[n−2], and D4[n−1] of the conversion table table1[4096][3]: table1[D4[n−3],D4[n−2],D4[n−1]][0], table1[D4[n−3],D4[n−2],D4[n−1]][1], and table1[D4[n−3],D4[n−2],D4[n−1]][2] and this is the same as table1[D4[n−3],D4[n−2],D4[n−1]][0], the encode unit 15 converts D4[n] into two bits as “01b”, and in a case where this is the same as table1[D4[n−3],D4[n−2],D4[n−1]][1], this converts D4[n] into two bits as “10b”, and in a case where this is the same as table1[D4[n−3],D4[n−2],D4[n−1]][2], this converts D4[n] into two bits as “11b”. Also, when there is not the same one in the three values of the address (row) indicated by D4[n−3], D4[n−2], and D4[n−1] of the conversion table table1[4096][3], the encode unit 15 converts into six bits by adding “00b” before D4[n] as “00b+D4[n]”. Herein, b in “01b”, “10b”, “11b”, and “00b+D4[n]” indicates that they are in binary notation.

As described above, the encode unit 15 converts the four-bit DSD data D4[n] into two-bit data “01b”, “10b”, or “11b”, or into six-bit data “00b+D4[n]” using the conversion table table1, and outputs the same to the encoded data buffer 16.

<Detailed Configuration of Encode Unit 15>

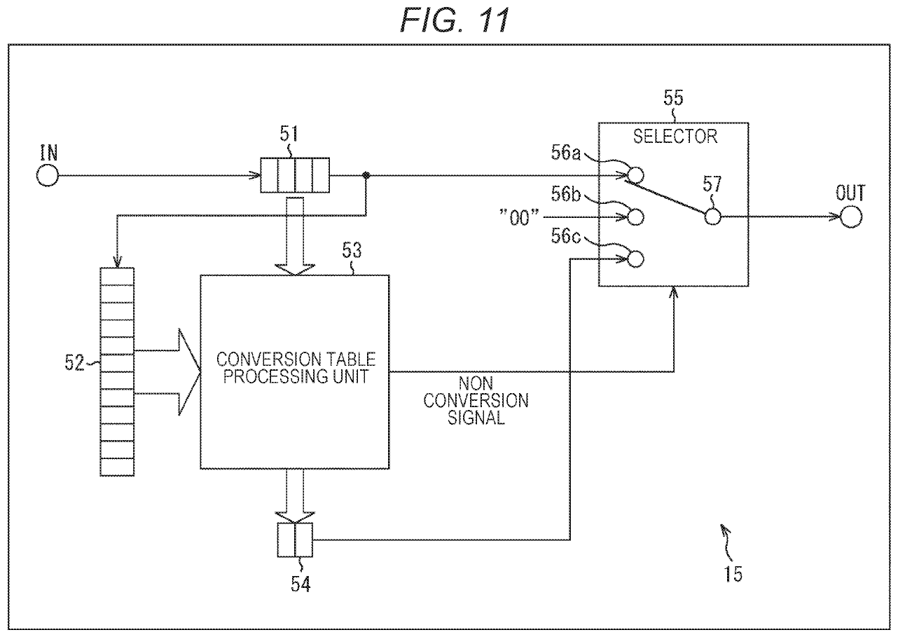

FIG. 11 is a view illustrating a configuration example of the encode unit 15 which performs the above-described compression encoding.

The four-bit DSD data (for example, D4[n]) supplied from the input buffer 13 is stored in a register 51 which stores four bits. Also, an output of the register 51 is connected to one input terminal 56a of a selector 55 and a register 52 which stores 12 bits, and the register 52 stores past 12-bit data (for example, D4[n−3], D4[n−2], and D4[n−1]) immediately preceding the four-bit DSD data stored in the register 51.

A conversion table processing unit 53 includes the conversion table table1 supplied from the control unit 14. The conversion table processing unit 53 searches whether or not there is the four-bit data stored in the register 51 (for example, D4[n]) in three values of the address indicated by the 12-bit data (for example, D4[n−3], D4[n−2], and D4[n−1]) stored in the register 52: table1[D4[n−3],D4[n−2],D4[n−1]][0], table1[D4[n−3],D4[n−2],D4[n−1]][1], and table1[D4[n−3],D4[n−2],D4[n−1]][2], and in a case where there is the same, allows a two-bit register 54 to store a value corresponding to the column in which the same value is stored, that is, any one of “01b”, “10b”, or “11b”. The data stored in the two-bit register 54 is supplied to one input terminal 56c of the selector 55. In addition, the conversion table processing unit 53 outputs to the selector 55 a signal indicating not to convert (hereinafter, referred to as non conversion signal) in a case where there is no four-bit data stored in the register 51 (for example, D4[n]) in the three values of the address indicated by the 12-bit data (for example, D4[n−3], D4[n−2], and D4 [n−1]) stored in the register 52.

The selector 55 selects one of the three input terminals 56a to 56c and outputs data acquired from the selected input terminal 56 from an output terminal 57. The four-bit DSD data (for example, D4[n]) stored in the register 51 is supplied to the input terminal 56a, “00b” is supplied to the input terminal 56b, and the two-bit conversion data stored in the register 54 is supplied to the input terminal 56c. In a case where the non conversion signal indicating not to convert is supplied from the conversion table processing unit 53, the selector 55 selects the input terminal 56b and outputs “00b” from the output terminal 57, and thereafter selects the input terminal 56a and outputs the four-bit DSD data (for example, D4[n]) stored in the register 51 from the output terminal 57. As a result, six bits “00b+D4[n]” output in a case where the one the same as D4[n] is not present in the conversion table table1 is output from the output terminal 57. Also, in a case where the non conversion signal indicating not to convert is not supplied (in a case where a conversion signal indicating that it is converted is supplied), the selector 55 selects the input terminal 56c and outputs the two-bit converted data supplied from the register 54 from the output terminal 57. As a result, two bits output in a case where the one the same as D4[n] is present in the conversion table table1, that is, any one of “01b”, “10b”, and “11b” is output from the output terminal 57.

<Compression Encoding Processing Flow>

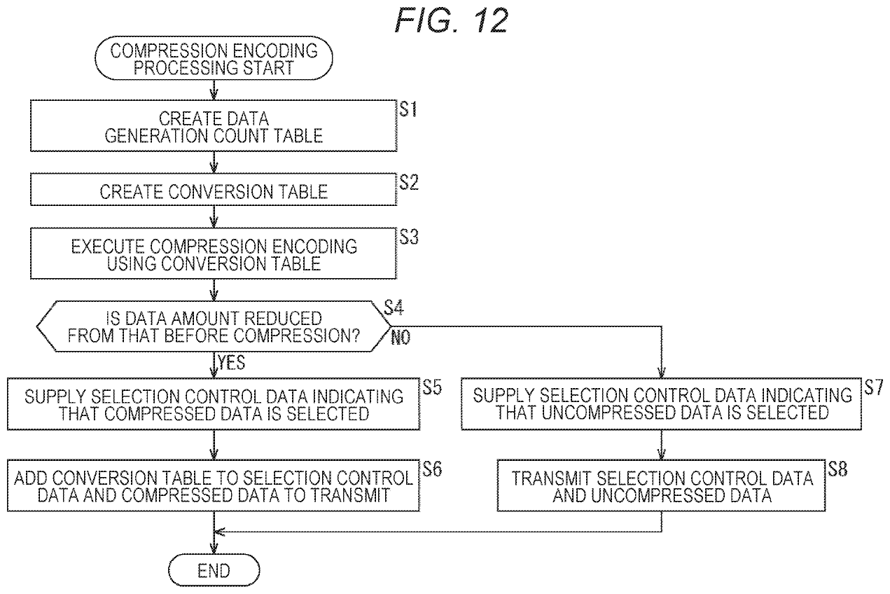

Compression encoding processing by the compression encoding device 10 is described with reference to a flowchart in FIG. 12.

Meanwhile, in a processing flow in FIG. 12, processing of the ADC 12 is not illustrated, and processing after the one frame of DSD data subjected to the ΔΣ modulation by the ADC 12 is output from the input buffer 13 is described.

First, at step S1, the control unit 14 counts the number of times of generation of the D4 data next to the past three D4 data (past 12-bit data) for the one frame of DSD data, and creates the data generation count table pretable.

At step S2, the control unit 14 creates the 4096 rows three columns conversion table table1 on the basis of the created data generation count table pretable. The control unit 14 supplies the created conversion table table1 to the encode unit 15 and a data transmission unit 18.

At step S3, the encode unit 15 executes the compression encoding on the DSD data of a one-frame period using the conversion table table1. Specifically, the encode unit 15 performs processing of converting the four-bit DSD data D4[n] into two-bit data “01b”, “10b”, or “11b”, or into six-bit data “00b+D4[n]” on the DSD data of one frame period. The compressed data acquired by the compression encoding is supplied to the encoded data buffer 16 and the data amount comparison unit 17.

At step S4, the data amount comparison unit 17 compares the data amount of the uncompressed data of one frame supplied from the input buffer 13 with the data amount of the compressed data of one frame supplied from the encoded data buffer 16, and determines whether the data amount is reduced from that before the compression.

In a case where it is determined at step S4 that the data amount is reduced from that before the compression, the procedure shifts to step S5, and the data amount comparison unit 17 supplies the selection control data indicating that the compressed data is selected to the data transmission unit 18.

At step S6, the data transmission unit 18 adds the data of the conversion table table1 (conversion table data) supplied from the control unit 14 to the selection control data indicating that the compressed data is selected (flag indicating the compression encoded data and the compressed data supplied from the encode unit 15 and transmits the same to the counterpart device.

Also, in a case where it is determined at step S4 that the data amount is not reduced from that before the compression, the procedure shifts to step S7, and the data amount comparison unit 17 supplies the selection control data indicating that the uncompressed data is selected to the data transmission unit 18 together with the uncompressed data.

At step S8, the data transmission unit 18 transmits the selection control data indicating that the uncompressed data is selected (flag indicating the data which is not compression encoded) and the uncompressed data to the counterpart device.

The compression encoding processing of the one frame of DSD data is herein finished. The processing at steps S1 to S8 described above is repeatedly executed on the DSD data of one frame unit sequentially supplied from the input buffer 13.

<Configuration Example of Decoding Device>

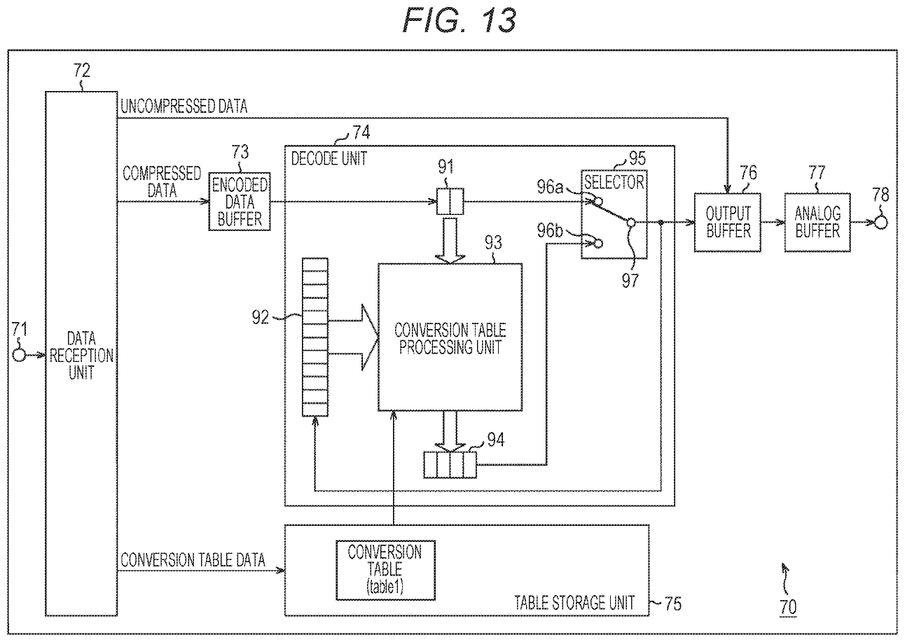

FIG. 13 illustrates a principal configuration example of a decoding device supporting the above-described new DSD lossless compression encoding system. A decoding device 70 in FIG. 13 is a device which receives the audio signal which the compression encoding device 10 in FIG. 8 compression encodes to transmit and performs extending processing (lossless decoding).

The audio signal compression encoded and transmitted by the compression encoding device 10 in FIG. 8 is received by an input unit 71 of the decoding device 70 through a network not illustrated (for example, a local area network (LAN), a public line network such as a wide area network (WAN), the Internet, a telephone line network, and a satellite communication network and the like) to be supplied to a data reception unit 72.

The data reception unit 72 separates a synchronization signal included in the received data and detects and corrects a transmission error occurring during network transmission. Then, the data reception unit 72 determines whether or not the audio signal is compression encoded on the basis of the selection control data indicating whether or not the audio signal is compression encoded included in the received data. Then, in a case where the audio signal is compression encoded, the data reception unit 72 supplies the received compressed data to the encoded data buffer 73. Also, in a case where the audio signal is not compression encoded, the data reception unit 72 supplies the received uncompressed data to the output buffer 76. Furthermore, the data reception unit 72 supplies the data (conversion table data) of the conversion table table1 included in the received data to a table storage unit 75. The table storage unit 75 stores the conversion table table1 supplied from the data reception unit 72 and supplies the same to a decode unit 74 as needed.

The encoded data buffer 73 temporarily accumulates the compressed data supplied from the data reception unit 72 and supplies the same to the decode unit 74 on a subsequent stage at a predetermined timing.

The decode unit 74 decodes (lossless decodes) the compressed data to a state before the compression and supplies the same to an output buffer 76.

<Details of Decoding Method>

A decoding method by the decode unit 74 is described. A case of decoding E2[n] is described while expressing the compressed data compression encoded and transmitted by the compression encoding device 10 in a two-bit unit as follows.

. . . E2[n−3], E2[n−2], E2[n−1], E2[n], E2[n+1], E2[n+2], E2[n+3], . . .

Herein, E2[n] represents two-bit continuous data and is also referred to as E2 data.

The decode unit 74 first determines a value of E2[n]. In a case where E2[n] is “00b”, this is data not found in the received conversion table table1[4096][3], so that four-bit data “E2[n+1]+E2[n+2]” next to E2[n] is data to be decoded. Also, in a case where E2[n] is “01b”, “10b”, or “11b”, this is data found in the received conversion table table1[4096][3], so that the data to be decoded is searched by referring to the conversion table table1[4096][3] using 12-bit D4 data D4[n−3], D4[n−2], and D4[n−1] decoded immediately before. The data to be decoded is data stored in “table1[D4[n−3],D4[n−2],D4[n−1]][E2[n]−1]”. As described above, the decode unit 74 may decode (lossless decode) the compressed data to the state before the compression. As illustrated in FIG. 13, the decode unit 74 includes a two-bit register 91, a 12-bit register 92, a conversion table processing unit 93, a four-bit register 94, and a selector 95.

The two-bit E2 data (for example, E2[n]) supplied from the encoded data buffer 73 is stored in the register 91. The output of the selector 95 is supplied to the 12-bit register 92, and the register 92 stores the 12-bit data (for example, D4[n−3], D4[n−2], and D4[n−1]) decoded immediately before the two-bit E2 data (for example, E2[n]) stored in the register 91. In a case where the two-bit E2 data (for example, E2[n]) stored in the register 91 is “00b”, the selector 95 selects the input terminal 96a and outputs four-bit data “E2[n+1]+E2[n+2]” next to E2[n] as a decoded result from the output terminal 97. In a case where the two-bit E2 data (for example, E2[n]) stored in the register 91 is “01b”, “10b”, or “11b”, the conversion table processing unit 93 allows the register 94 to store the four-bit data stored in “table1[D4[n−3],D4[n−2],D4[n−1]][E2[n]-1]” of the conversion table table1 supplied from the table storage unit 75. The selector 95 selects the input terminal 96b and outputs the data stored in the register 94 from the output terminal 97 as the decoded result.

The output buffer 76 appropriately selects either the uncompressed data supplied from the data reception unit 72 or the decoded data supplied from the decode unit 74 and supplies the same to an analog filter 77.

The analog filter 77 executes predetermined filtering processing such as a low-pass filter and a band-pass filter on the decoded data supplied from the output buffer 76 and outputs the data from an output unit 78.

<Decoding Processing Flow>

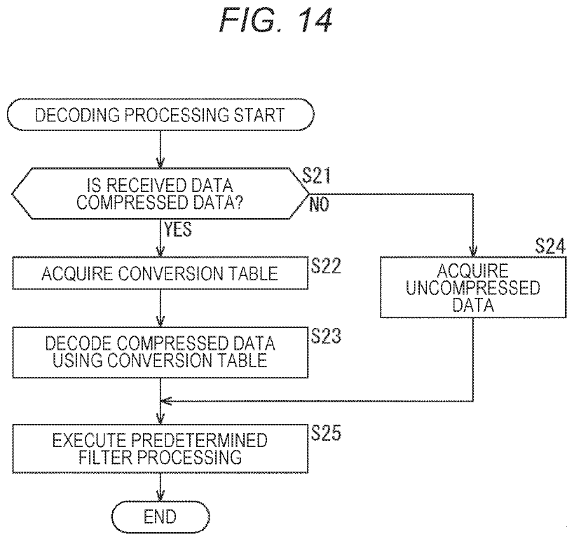

With reference to a flowchart in FIG. 14, the decoding processing of the decoding device 70 is further described.

First, at step S21, the data reception unit 72 determines whether the received data is the compression encoded compressed data on the basis of the selection control data included in the received data.

In a case where it is determined at step S21 that the received data is the compressed data, the procedure shifts to step S22, and the data reception unit 72 supplies the conversion table data included in the received data to the table storage unit 75. The conversion table processing unit 93 acquires the received conversion table table1 via the table storage unit 75. Also, at step S22, the compressed data included in the received data is supplied to the encoded data buffer 73.

At step S23, the decode unit 74 decodes the compressed data supplied from the encoded data buffer 73 using the conversion table table1 and supplies the same to the output buffer 76. That is, in a case where the two-bit E2 data (for example, E2[n]) is “00b”, the decode unit 74 supplies the four-bit data “E2[n+1]+E2[n+2]” next to E2[n] to the output buffer 76 as the decoded result, and in a case where the two-bit E2 data (for example, E2[n]) is “01b”, “10b”, or “11b”, this supplies the four-bit data stored in “table1[D4[n−3],D4[n−2],D4[n−1]][E2[n]-1]” of the conversion table table1 to the output buffer 76 as the decoded result.

Also, in a case where it is determined at step S21 that the received data is not the compressed data, that is, the uncompressed data, the procedure shifts to step S24, and the data reception unit 72 acquires the uncompressed data included in the received data and supplies the same to the output buffer 76.

By the above-described processing, the uncompressed data or the data decoded by the decode unit 74 is supplied to the output buffer 76, and the data supplied to the output buffer 76 is output to the analog filter 77.

At step S25, the analog filter 77 executes predetermined filtering processing on the data supplied via the output buffer 76. The audio signal after the filter processing is output from the output unit 78.

The above-described processing is repeatedly executed on the audio signal of one frame unit.

<Structure of DSD Lossless Stream>

In the above-described new DSD lossless compression encoding system, the DSD data is divided into Blocks of a fixed length (4096×32=131072 bits) per one channel and compressed. After the compression, Group of Blocks (GOB) is formed by adding a header to compressed data of 10 continuous blocks. A unit acquired by further adding configuration information (configuration) at the head of the GOB is a DSD_lossless_payload( ) Information necessary for extending the Block (code book; reference table) is stored in a GOB header and GOB data. A time length of the Block (Block(audio frame)) is set to be comparable to that of the AAC in consideration of stream switching with the AAC.

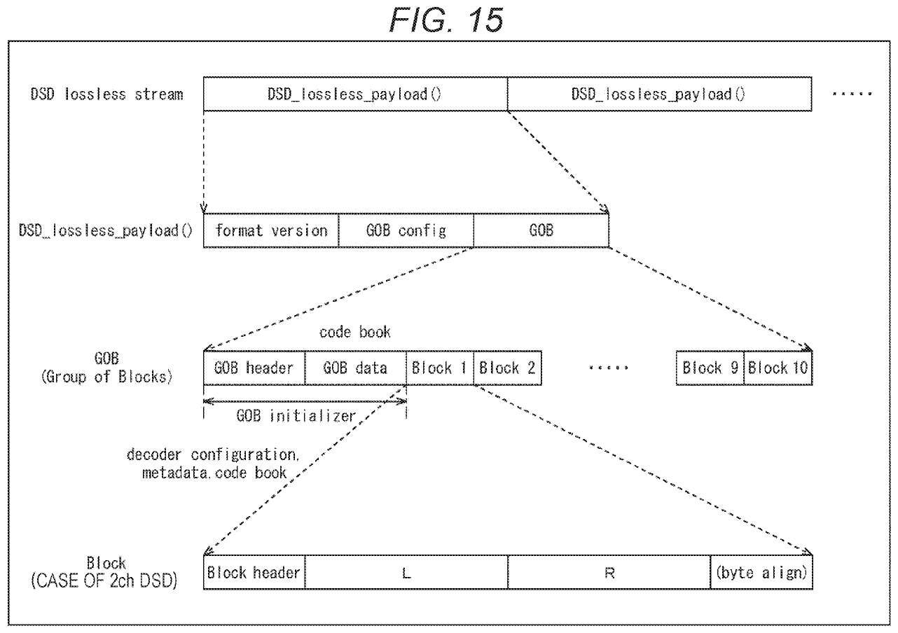

An example of a basic structure of the DSD lossless stream is illustrated in FIG. 15. As illustrated in an uppermost stage in FIG. 15, the DSD lossless stream includes a plurality of DSD_lossless_payload( ).

As illustrated in a second stage from the top in FIG. 15, one DSD_lossless_payload( ) includes format version, GOB config, and GOB.

As illustrated in a third stage from the top in FIG. 15, the GOB includes a GOB header, GOB data, and 10 Blocks (Block 1 to Block 10). The GOB header and GOB data are also referred to as GOB initializer used for decoding the GOB. The GOB initializer includes decoder configuration information (decoder configuration), metadata, code book and the like used for decoding.

As illustrated in a lowermost stage in FIG. 15, the Block includes a Block header, audio data of a left channel (L), audio data of a right channel (R), and byte align (in a case where the DSD data is of right and left two channels).

In one Block, data of 4096×32=13,1072 bits is stored in the DSD data before the compression per one channel regardless of fs. That is, a length of one Block (Block length) is approximately 46 msec in a case of the sampling frequency of 2.8 MHz, approximately 23 msec in a case of the sampling frequency of 5.6 MHz, and approximately 12 msec in a case of the sampling frequency of 11.2 MHz. For example, in a case of the sampling frequency of 2.8 MHz, data of approximately 468 msec as reproduction time is stored in 1 GOB.

<Syntax>

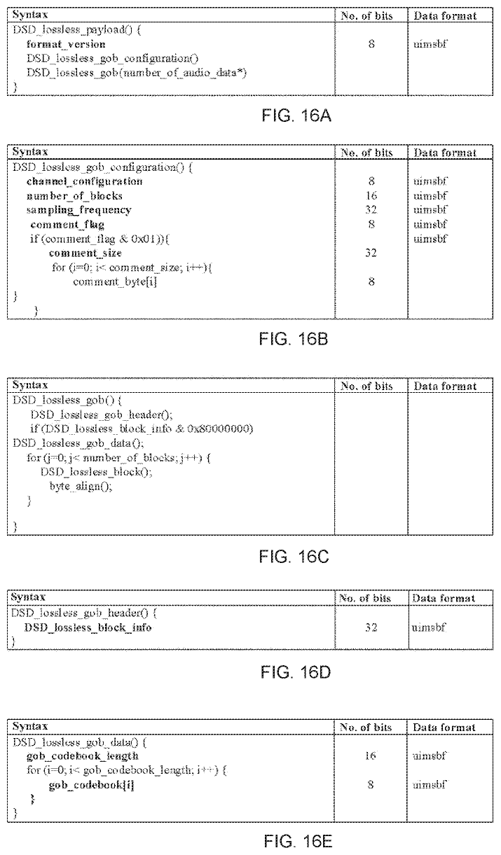

An example of syntax of the DSD_lossless_payload( ) is illustrated in A of FIG. 16. As illustrated in A of FIG. 16, for example, format version, DSD_lossless_gob_configuration( ) DSD_lossless_gob(number_of_audio_data) and the like are stored in DSD_lossless_payload( ) This format version corresponds to format version in FIG. 15. Also, DSD_lossless_gob_configuration( ) corresponds to GOB config in FIG. 15. Also, DSD_lossless_gob( ) corresponds to GOB in FIG. 15.

An example of syntax of DSD_lossless_gob_configuration( ) is illustrated in B of FIG. 16. As illustrated in B of FIG. 16, for example, channel_configuration, number of blocks, sampling_frequency, comment_flag, comment_size, comment_byte and the like are stored in DSD_lossless_gob_configuration( )

An example of syntax of DSD_lossless_gob( ) is illustrated in C of FIG. 16. As illustrated in C of FIG. 16, for example, DSD_lossless_gob header( ) DSD_lossless_gob data( ) DSD_lossless_block( ) byte_align( ) and the like are stored in DSD_lossless_gob( ) This DSD_lossless_gob header( ) corresponds to GOB header in FIG. 15. DSD_lossless_gob data( ) corresponds to GOB data in FIG. 15. DSD_lossless_block( ) corresponds to each block (Block 1 to Block 10) in FIG. 15.

An example of syntax of DSD_lossless_gob header( ) is illustrated in D of FIG. 16. As illustrated in D of FIG. 16, for example, DSD_lossless_block_info and the like is stored in DSD_lossless_gob_header( ).

An example of syntax of DSD_lossless_gob_data( ) is illustrated in D of FIG. 16. As illustrated in D of FIG. 16, for example, gob_codebook_length, gob_codebook[i] and the like are stored in DSD_lossless_gob_data( ) It corresponds to code book in FIG. 15, gob_codebook[i].

<Switching>

In a system which distributes data of content such as the image and audio (also referred to as content data), further improvement in quality of the content data to be distributed is always demanded. In addition, as the quality of the content data is improved, a new encoding system such as the above-described new DSD lossless compression encoding system is also developed from time to time.

However, even if such high-quality encoding system is newly developed and applied to distribution of the content data, actually, there is a case where distribution of the content data of a conventional low-quality encoding system is also required to be used in combination.

For example, in order to distribute the content data more stably, it is conceivable to switch a bit rate of the content data to be distributed in accordance with variation in the transmission band of the transmission path, but in that case, there is a possibility that a sufficient bit rate width cannot be secured by one encoding system. For example, in general, high-quality content data has a higher bit rate than that of low-quality content data. In order to perform more stable distribution stronger against the variation in transmission band, the content data of a low bit rate as in the conventional encoding system should also be distributable, but there might be a case where the new encoding system does not support such low bit rate. For example, in a case of the DSD lossless stream of the above-described new DSD encoding system, lossless compression of the DSD data of 2.8 Mbps or higher is performed to reduce the bit rate, but it is not possible to always maintain a low rate of 128 kbps as in advanced audio coding (AAC).

That is, as the higher-quality encoding system is developed, there is a possibility that the bit rate width which should be supported becomes wider, and there is a possibility that it becomes more difficult to support by one encoding system.

Also, for example, even if the new encoding system is applied, there is a case where a decoder used on a reproduction side does not support the encoding system and it is not possible to reproduce. Therefore, in order to improve versatility of the distribution of the content data, it is required to be able to distribute by the conventional encoding system.

Meanwhile, the same applies not only to the audio data but also to arbitrary content data such as the image data.

With the MPEG-DASH, distribution of a plurality of content data of different encoding systems may be managed by the MPD. For example, it is possible to switch the content data to be distributed according to a congestion degree of the transmission band, the encoding system supported by the decoder and the like. However, in the conventional MPD, only switching of the bit rate and the like is taken into consideration for switching of the content data during reproduction, and it is not supposed to switch the encoding system during the reproduction.

For example, in the MPD, basically, the encoding system is managed in Adaptation Set, and the content data of different encoding systems that may be mutually switched are managed in different Adaptation Sets. Also, basically, the bit rate is managed in Representation in the Adaptation Set, and the content data at different bit rates which may be mutually switched are managed in different Representations of the same Adaptation Set.

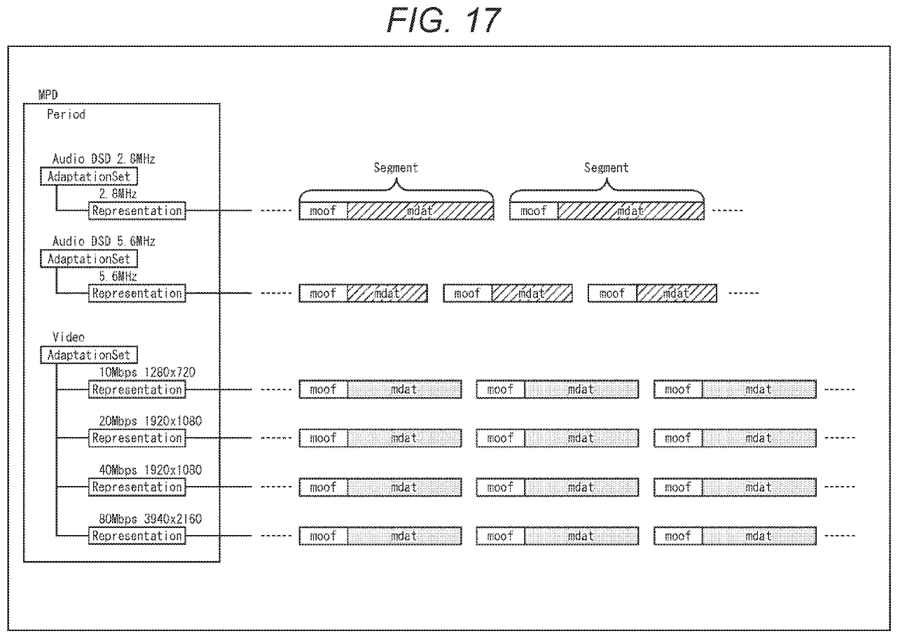

For example, Live Profile of the MPEG-DASH has a file structure as in an example illustrated in FIG. 17. For example, the content data of different encoding systems such as “Audio DSD 2.8 MHz” and “Audio DSD 5.6 MHz” are managed in different Adaptation Sets. Also, the content data of different bit rates as in examples of “10 Mbps”, “20 Mbps”, “40 Mbps”, and “80 Mbps” of “Video” are managed in different Representations of the same Adaptation Set.

Also, for example, also in a case where there is a plurality of audio streams of different languages such as in Japanese and English, they are managed in different Adaptation Sets. Especially, in a case where there is an intention to allow the user to select by user interfase (UI), since “@lang” representing a language attribute exists only in the Adaptation Set, it is necessary to manage in different Adaptation Sets.

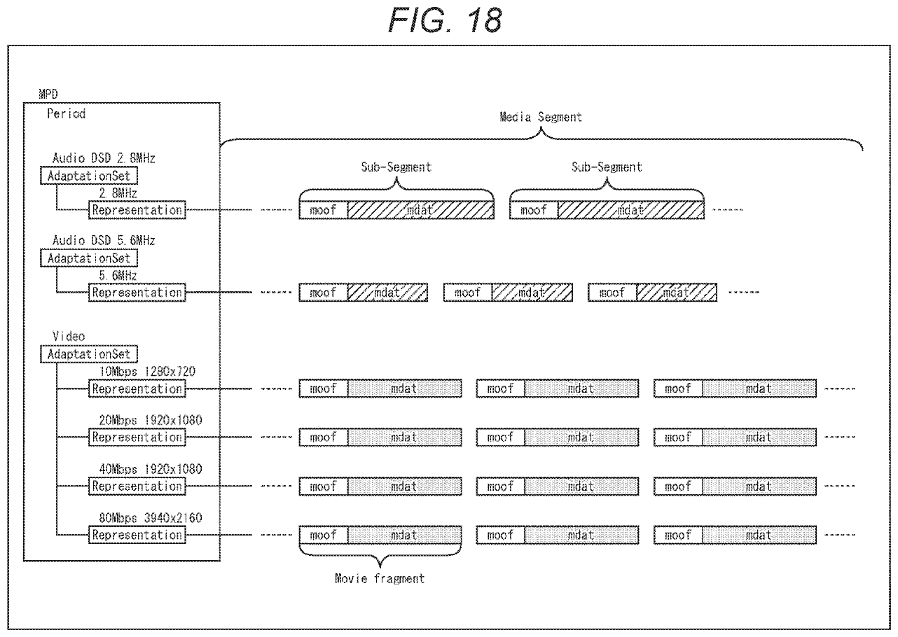

Meanwhile, a file structure in a case of On-demand profile of the MPEG-DASH is as illustrated in an example in FIG. 18. In this case also, as is the case in Live Profile, in a case where the encoding system or the like is different, it is managed using different Adaptation Sets.

Therefore, in order to switch the encoding system, switching across the Adaptation Sets is performed; however, although a mechanism for switching between Representations is prepared in the MPD, a mechanism to realize the switching across Adaptations is not prepared.

For example, in a case of the Live Profile, as illustrated in FIG. 17, the content data is managed in a Segment unit in a reproduction time direction thereof. As illustrated in FIG. 17, in a case where the content data is an MP4 file, each Segment includes Movie Fragment Box (moof) and Media Data Box (mdat) of predetermined reproduction time. Since this Segment serves as an access unit, in a case of switching the content data to be reproduced, it is performed at a boundary of Segments.

However, since the Segment length (reproduction time) may be set independently for each Adaptation Set, (the reproduction times of) the Segment boundaries are not always the same between the Adaptations. If the Segment boundaries do not match between switching source Adaptation Set and switching destination Adaptation Set, there is a possibility that discontinuity occurs such that reproduction is interrupted at the time of switching or deviation occurs in the reproduction time (jumps or returns), for example. That is, seamless switching cannot be guaranteed.

Also, in a case of the On-demand profile, for example, as illustrated in FIG. 18, the entire content data is managed as one Media Segment, and managed by being further divided into Sub-Segment unit in the reproduction time direction thereof. As illustrated in FIG. 18, in a case where the content data is the MP4 file, each Segment includes Movie Fragment Box (moof), and Media Data Box (mdat) of predetermined reproduction time. Since this Sub-Segment serves as an access unit, in a case of switching the content data to be reproduced, it is performed at a boundary of Sub-Segments.

That is, in this case also, as is the case in the Segment boundary of the Live Profile, coincidence of (the reproduction time of) the Sub-segment boundaries between Adaptations is not guaranteed, so that the seamless switching cannot be guaranteed.

In this manner, since the seamless switching is not guaranteed, it is difficult to realize the switching across the Adaptation Sets. Therefore, it is difficult to stably distribute higher-quality content data.

### 2. First Embodiment

<Setting of Information regarding Switching across Adaptations>

Therefore, in management information for managing reproduction of data of content, information regarding switching across first management units for managing a data group of the same content of the data to be reproduced is set.

By doing so, seamless switching across the first management units (switching so that reproduction continuity is maintained (seamless reproduction is possible)) may be performed, and it becomes possible to support larger band variation and the content data may be more stably transmitted.

This management information may be MPD of MPEG-DASH, and the first management unit may be Adaptation Set. By doing so, distribution using the MPEG-DASH may be performed more stably.

Meanwhile, in a case of describing regarding the MPD, it is hereinafter described using Live Profile and description of On-demand profile is omitted; however, the following description may be applied to an arbitrary profile as long as there is no contradiction especially. For example, the description of Segment of the Live Profile may also be applied to the On-demand profile by replacing the Segment with Sub-segment.

<Switching Destination Information>

The information regarding the switching may also be information regarding a switching destination of the switching across the first management units of the data to be reproduced. For example, information designating a management unit that is allowed as the switching destination (that is, the management unit that is a candidate for the switching destination) may be set as the information regarding the switching destination. For example, an attribute @ContentSwitchingDestinationId may be set as the information regarding the switching destination.

For example, in a case where the management information is the MPD, a list (row) of identification information (Id) of the management unit which is the candidate for the switching destination may be set in this attribute @ContentSwitchingDestinationId. The management unit as the candidate for the switching destination may be, for example, another Adaptation Set (another first management unit), Representation of another Adaptation Set (second management unit which manages each data in another first management unit), or both of them. Meanwhile, “another Adaptation Set (another first management unit)” refers to Adaptation Set (first management unit) other than the Adaptation Set (first management unit) that manages the content data currently being reproduced (before switching). Also, in a case of setting the Adaptation Set as the candidate for the switching destination, Representation in a lower order may be designated on the basis of a specification of the conventional MPD.

In a case of setting the Adaptation Set (first management unit) as the candidate for the switching destination, since an amount of information to be added is small and the conventional specification is also used, compatibility with the conventional MPD is high. Also, in a case of setting the Representation (second management unit) as the candidate for the switching destination, more detailed control about the switching may be performed.

<Alignment>

The management unit set as the information regarding the switching destination may be such that reproduction time of a Segment boundary matches (aligns) with that of a current management unit in at least a part of the Segments. In other words, the management unit in which the Segment boundary is aligned with that of the current management unit in at least a part of the Segments may be set as the information regarding the switching destination.

If the Segment boundaries are aligned, seamless switching may be performed even in a case of the switching across Adaptations by controlling the switching on the basis of such information regarding the switching destination in a device which reproduces.

<Setting of Switching Destination Information>

Meanwhile, the information regarding the switching destination may be set in an arbitrary management unit. For example, the attribute @ContentSwitchingDestinationId (the information regarding the switching destination) may be set in the Adaptation Set (first management unit), the Representation (second management unit), or both of them.

In a case of setting the information regarding the switching destination in the Adaptation Set (first management unit), it is possible to set the information regarding the switching destination common to the Representations belonging to the Adaptation Set and suppress an increase in amount of information. Also, in a case of setting the information regarding the switching destination in the Representation (second management unit), more detailed control may be performed regarding the switching.

Also, as the information regarding the switching destination, information designating a management unit recommended as the switching destination may be set, information designating a management unit not recommended as the switching destination may be set, or information designating a management unit prohibited as the switching destination may be set.

<Switching Timing Information>

The information regarding the switching may also be information regarding timing of the switching across the first management units of the data to be reproduced. For example, the information regarding the timing may be information designating timing at which the switching across the first management units of the data to be reproduced is allowed (information designating a candidate for the switching timing). For example, as the information regarding the timing, an attribute @ContentSwitchingAlignmentCycle may be set.

The timing being the candidate is arbitrary, but this may be, for example, a boundary of a second management unit which is a management unit in a reproduction time direction of the data to be reproduced. That is, the information designating the timing may be information designating the boundary of the second management unit at which the switching across the first management units of the data to be reproduced is allowed. At that time, the timing being the candidate may be designated by the number of second management units up to next timing.

For example, in a case where the management information is the MPD, the boundary of the Segment (second management unit) at which the switching across the Adaptation Sets (first management units) of the content data to be reproduced is allowed may be designated by the number of Segments (second management units) until the next timing. Meanwhile, setting the Segment as the second management unit herein means that this is the management unit different from the Adaptation Set being the first management unit. In addition, the Segment is the management unit also different from the Representation. That is, if not only the Adaptation Set (first management unit) but also the Representation (second management unit) are taken into consideration, the Segment may be said to be a third management unit.

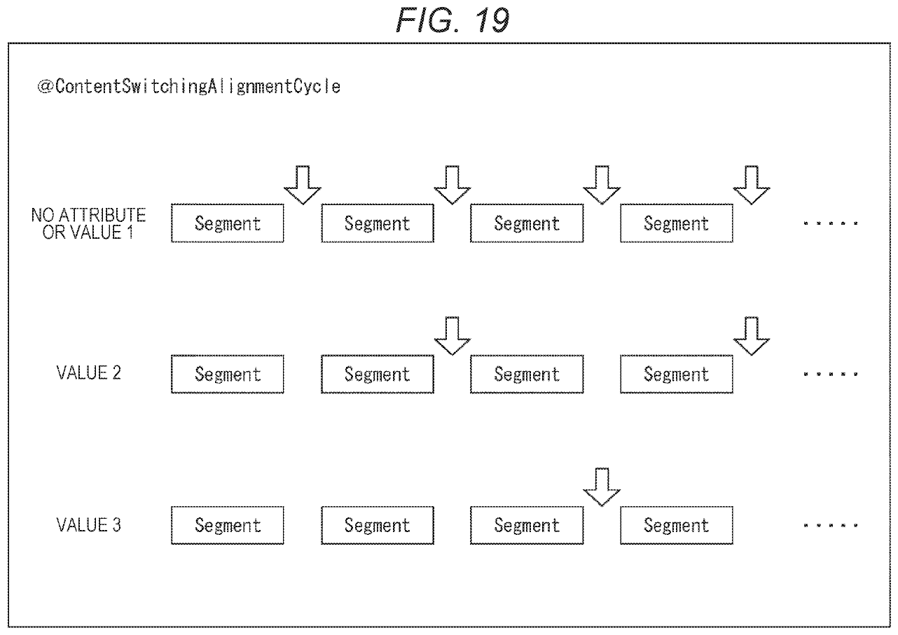

An example of a relationship between a value of the attribute @ContentSwitchingAlignmentCycle and the timing being the candidate is illustrated in FIG. 19. In FIG. 19, a quadrangle indicated by “Segment” represents the Segment, and an arrow indicates the timing being the candidate. For example, as illustrated in an uppermost stage of FIG. 19, in a case where the attribute @ContentSwitchingAlignmentCycle is not set or the value of the attribute @ContentSwitchingAlignmentCycle is set to “1”, the switching across the Adaptation Sets is allowed at each Segment boundary. Also, as illustrated in a second stage from the top, in a case where the value of the attribute @ContentSwitchingAlignmentCycle is set to “2”, the switching across the Adaptation Sets is allowed at the boundary of every two Segments (that is, at every other Segment boundary). Furthermore, as illustrated in a lowermost stage, in a case where the value of the attribute @ContentSwitchingAlignmentCycle is set to “3”, the switching across the Adaptation Sets is allowed at the boundary of every three Segments (that is, at every third Segment boundary).

Meanwhile, in the information regarding the timing, it is described that such timing at which the switching is allowed is represented by the number of Segments (=length of cycle), but the length of the cycle may also be represented by information other than the number of Segments. For example, the length of the cycle may also be represented by time (for example, seconds). Meanwhile, it is also possible to represent the timing at which the switching is allowed by information other than the length of the cycle. For example, the timing at which the switching is allowed may be represented by reproduction time (for example, Movie Time or Media Time of ISOBMFF), a Segment number and the like.

By designating the timing at which the switching is allowed by the length of the cycle, especially the number of Segments, it is possible to reduce the amount of information. Also, the timing at which the switching is allowed may be more easily grasped by a reproducing side without requirement of complicated calculations or the like.

<Alignment>

At such timing being the candidate, it is also possible that the reproduction time of switching source data matches (aligns with) that of switching destination data. For example, the Segment boundaries designated as the candidates for the switching timing may be aligned with each other.

If the Segment boundaries are aligned with each other, it is possible to perform the seamless switching even if the switching is across the Adaptations by controlling the switching on the basis of such information regarding the timing of the switching in the device which reproduces.

Meanwhile, at the switching timing (Segment boundary), it is also possible that the content data of the switching source does not align with the content data of the switching destination. For example, in a case where there is discontinuity in reproduction time of the data before and after the switching at the switching timing, fine adjustment of the reproduction time may be performed by buffering the data. Also, for example, instead of aligning the data, it is possible to align the reproduction time before and after the switching by performing processing of smoothly connecting decoded data with a double buffer configuration.

However, by aligning the data at the switching timing, the seamless switching may be performed more easily at a higher speed.

<Setting of Information regarding Timing>

Meanwhile, the above-described information regarding the timing may be set in an arbitrary management unit. For example, attribute @ContentSwitchingAlignmentCycle (information regarding timing) may be set in the Adaptation Set (first management unit), the Representation (second management unit), or both of them.

In a case of setting the information regarding the timing in the Adaptation Set (first management unit), it is possible to set the information regarding the timing common to the Representations belonging to the Adaptation Set and suppress an increase in amount of information. Also, in a case of setting the information regarding the timing in the Representation (second management unit), more detailed control may be performed regarding the switching.

Also, as the information regarding the timing, information designating timing at which the switching is recommended may be set, information designating timing at which the switching is not recommended may be set, or information designating timing at which the switching is prohibited may be set.

### Example 1 of Information Regarding Switching

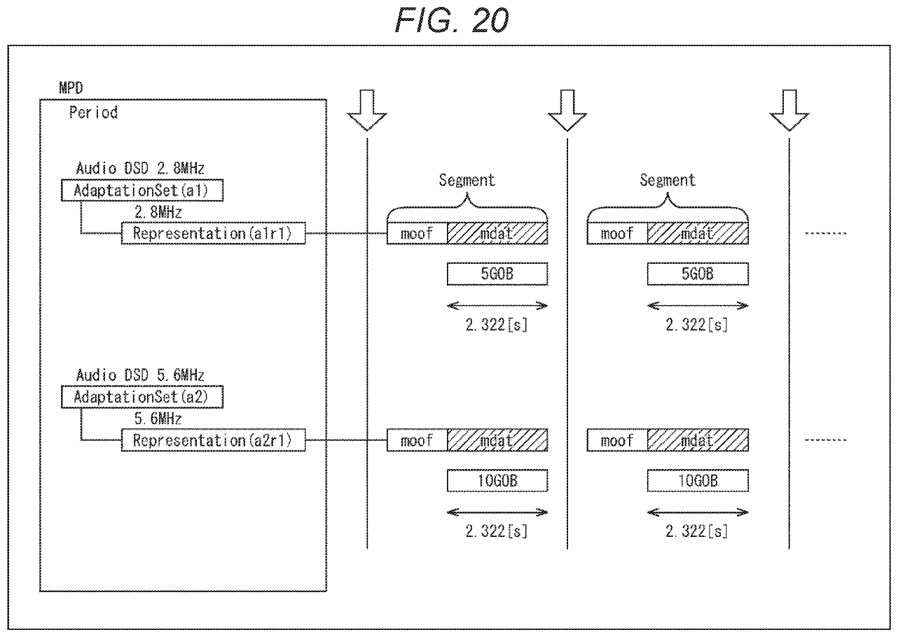

Next, an application example of the information regarding the switching (the information regarding the switching destination and the information regarding the timing) as described above is described. First, a case of setting the information regarding the switching for the MPD having a configuration as illustrated in FIG. 20 is described.

In a case of the MPD of the example in FIG. 20, an MP4 file of 2.8 MHz DSD lossless stream is managed in Representation (a1r1) of Adaptation Set (a1), and an MP4 file of 5.6 MHz DSD lossless stream is managed in Representation (a2r1) of Adaptation Set (a2). In the Representation (a1r1), 5 GOB of the 2.8 MHz DSD lossless stream is made one Segment, and the reproduction time of one Segment is approximately 2.322 seconds. In order to align the Segment boundaries of the Representation (a1r1) and the Representation (a2r1) with each other, it suffices to set the reproduction time of one Segment of the Representation (a2r1) to approximately 2.322 seconds, and for this purpose, 10 GOB of the 5.6 MHz DSD lossless stream may be set as one Segment in the Representation (a2r1). By doing so, the Segment boundaries are aligned as indicated by an arrow in FIG. 20. That is, it is possible to perform the seamless switching at an arbitrary Segment boundary between these Representations.

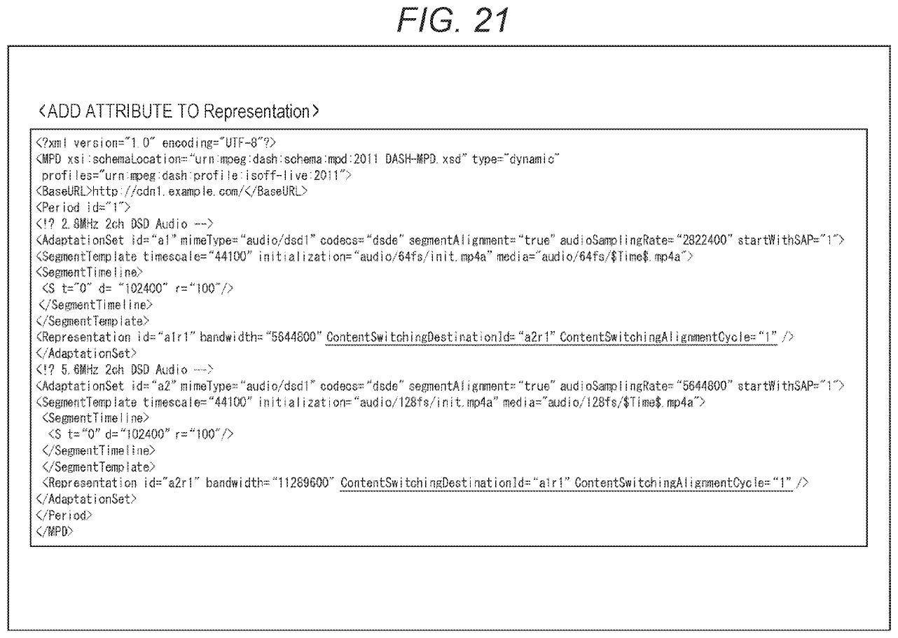

FIG. 21 is a view illustrating a description example of the MPD in a case of FIG. 20. In a case of the example in FIG. 21, the information regarding the switching across the Adaptation Sets is set in the Representation.

As indicated by an underline in FIG. 21, in the Representation (a1r1), a value “a2r1” is set in the attribute @ContentSwitchingDestinationId. That is, as the information regarding the switching destination, the Representation (a2r1) is set as the candidate for the switching destination. Also, in the Representation (a1r1), a value “1” is set in the attribute @ContentSwitchingAlignmentCycle. That is, the number of Segments for one cycle “1” is set as the information regarding the switching timing. That is, in this case, as seen from the Representation (a1r1), the candidate for the switching destination is the Representation (a2r1), and the switching is allowed at all the Segment boundaries.

Also, in the Representation (a2r1), a value “a1r1” is set in the attribute @ContentSwitchingDestinationId. That is, as the information regarding the switching destination, the Representation (a1r1) is set as the candidate for the switching destination. Also, in the Representation (a2r1), the value “1” is set in the attribute @ContentSwitchingAlignmentCycle. That is, the number of Segments for one cycle “1” is set as the information regarding the switching timing. That is, in this case, as seen from the Representation (a2r1), the candidate for the switching destination is the Representation (a1r1), and the switching is allowed at all the Segment boundaries.

As described with reference to FIG. 20, since the Segment boundaries are aligned between these Representations, it is possible to perform the seamless switching by switching according to the MPD in FIG. 21.

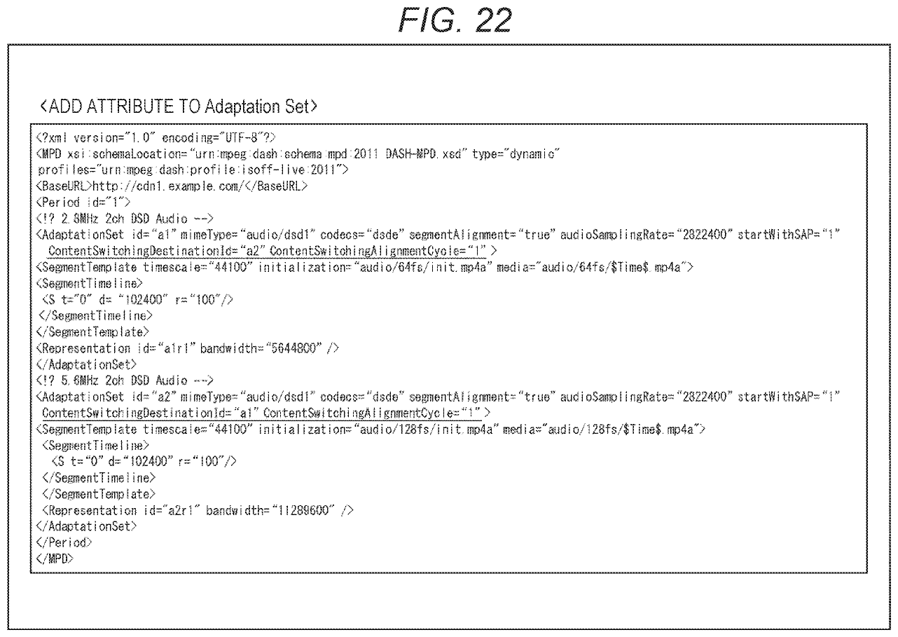

FIG. 22 is a view illustrating a description example of the MPD in a case of FIG. 20. In a case of the example in FIG. 21, the information regarding the switching across the Adaptation Sets is set in the Adaptation Set.

As indicated by an underline in FIG. 22, in the Adaptation Set (a1), a value “a2” is set in the attribute @ContentSwitchingDestinationId. That is, the Adaptation Set (a2) is designated as the candidate for the switching destination. Also, in the Adaptation Set (a1), the value “1” is set in the attribute @ContentSwitchingAlignmentCycle. That is, the number of Segments for one cycle “1” is set as the information regarding the switching timing. That is, in this case, as seen from the Adaptation Set (a1), the candidate for the switching destination is the Representation of the Adaptation Set (a2), and the switching is allowed at all the Segment boundaries.

In addition, in the Adaptation Set (a2), a value “a1” is set in the attribute @ContentSwitchingDestinationId. That is, the Adaptation Set (a1) is designated as the candidate for the switching destination. Also, in the Adaptation Set (a1), the value “1” is set in the attribute @ContentSwitchingAlignmentCycle. That is, the number of Segments for one cycle “1” is set as the information regarding the switching timing. That is, the switching across the Adaptation Sets is allowed at all the Segment boundaries.

As described with reference to FIG. 20, since the Segment boundaries are aligned between the Adaptation Sets, the seamless switching may be performed by switching according to the MPD in FIG. 21 or 22.

### Example 2 of Information Regarding Switching

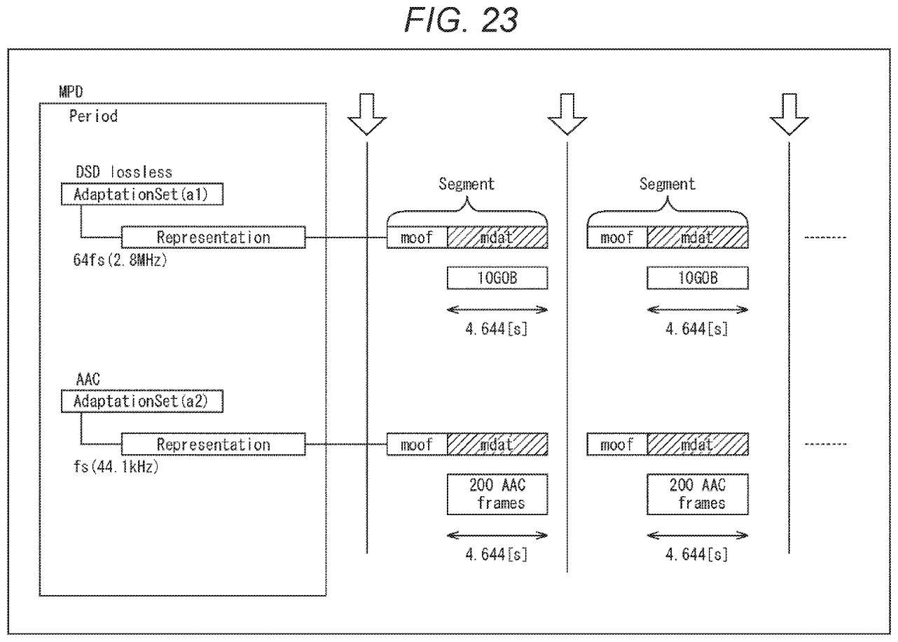

Encoding systems of the content data managed by the Adaptation Sets in which the switching across the Adaptation Sets is allowed may be different from each other. For example, as illustrated in FIG. 23, in the Representation of the Adaptation Set (a1), the MP4 file of 64fs 2.8 MHz DSD lossless stream may be managed, and the MP4 file of fs (44.1 kHz) AAC stream may be managed in the Representation of the Adaptation Set (a2).

Even in a case where the encoding systems are different in this manner, it is possible to align the Segment boundaries. For example, in the Representation of the Adaptation Set (a1), when 10 GOB of the DSD lossless stream is made one Segment, the reproduction time of one Segment is 4096×32×10/64=approximately 4.644 seconds. In order to align the Segment boundaries between the Representation of the Adaptation Set (a1) and the Representation of the Adaptation Set (a2), the reproduction time of one Segment may be made approximately 4.644 seconds also in the Representation of the Adaptation Set (a2).

For example, DSD has a sampling frequency that is a multiple of 44.1 kHz, and if fs=44.1 kHz, this may be expressed as 64 fs. In general, the sampling frequency of the AAC reproduced simultaneously with video is generally 48 kHz; however, the sampling frequency of the AAC is herein set to fs=44.1 kHz. The number of audio frames of the AAC having the sampling frequency of fs=44.1 kHz corresponding to the reproduction time of approximately 4.644 seconds described above is (4096×32×10×10/64fs)*(fs/1024)=200. Therefore, if the Segment of the AAC includes 200 AAC AudioFrames, it is possible to align the same with the Segment of the DSD lossless stream (arrow in FIG. 23). That is, it is possible to perform the seamless switching at an arbitrary Segment boundary between these Representations.

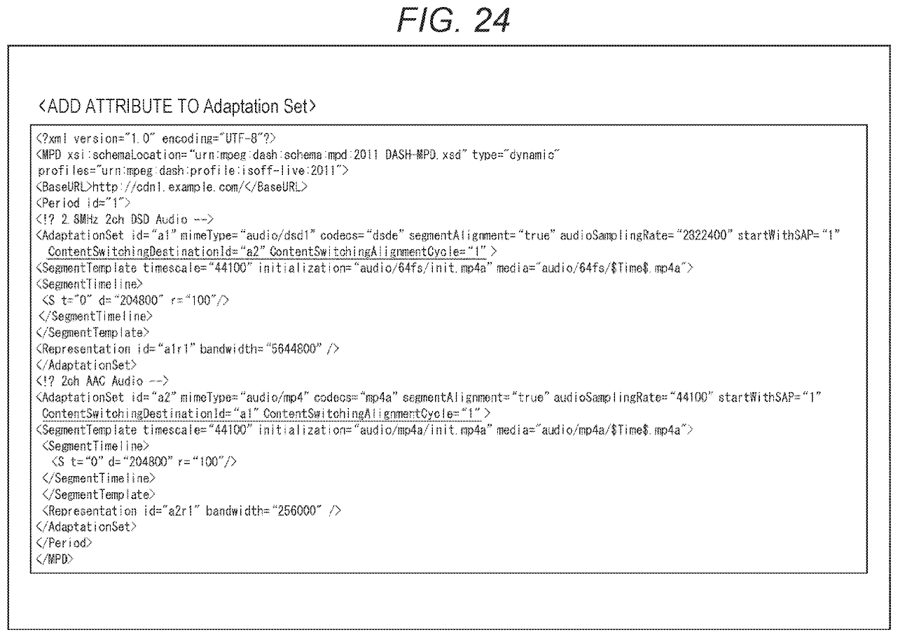

FIG. 24 is a view illustrating a description example of the MPD in a case in FIG. 23. In a case of the example in FIG. 24, the information regarding the switching across the Adaptation Sets is set in the Adaptation Set.

In this case, in the Adaptation Set (a1), a value “a2” is set in the attribute @ContentSwitchingDestinationId as indicated by an underline in FIG. 24. That is, the Adaptation Set (a2) is set as the candidate for the switching destination as the information regarding the switching destination. Also, in the Adaptation Set (a1), the value “1” is set in the attribute @ContentSwitchingAlignmentCycle. That is, the number of Segments for one cycle “1” is set as the information regarding the switching timing. That is, in this case, as seen from the Adaptation Set (a1), the candidate for the switching destination is the Adaptation Set (a2), and the switching is allowed at all the Segment boundaries.

In addition, in the Adaptation Set (a2), a value “a1” is set in the attribute @ContentSwitchingDestinationId. That is, the Adaptation Set (a1) is set as the candidate for the switching destination as the information regarding the switching destination. Also, in the Adaptation Set (a2), a value “1” is set in the attribute @ContentSwitchingAlignmentCycle. That is, the number of Segments for one cycle “1” is set as the information regarding the switching timing. That is, in this case, as seen from the Adaptation Set (a2), the candidate for the switching destination is the Adaptation Set (a1), and the switching is allowed at all the Segment boundaries.

As described with reference to FIG. 23, since the Segment boundaries are aligned between the Adaptation Sets, the seamless switching may be performed by switching at an arbitrary Segment boundary according to the MPD in FIG. 24.

### Example 3 of Information Regarding Switching

Furthermore, there may be a plurality of candidates for the switching destination. It is also possible that only a part of the timings (a part of the Segment boundaries) is set as the candidate for the switching timing. For example, it is possible that only a part of the Segment boundaries is aligned.

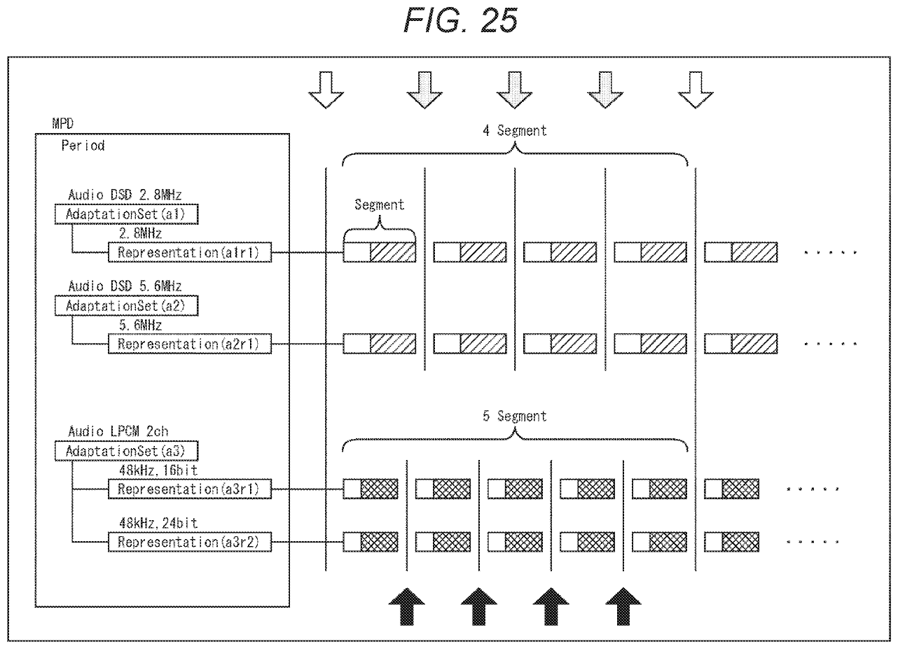

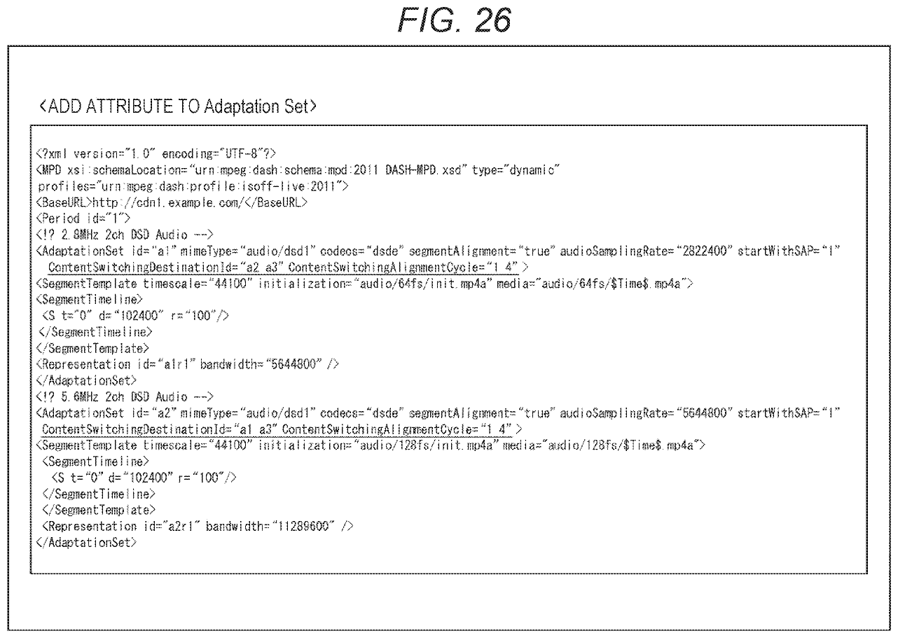

In a case of the MPD illustrated in FIG. 25, for example, an MP4 file of 2.8 MHz DSD lossless stream is managed in the Representation (a1r1) of the Adaptation Set (a1), and an MP4 file of 5.6 MHz DSD lossless stream is managed in the Representation (a2r1) of the Adaptation Set (a2). Furthermore, an MP4 file of 48 kHz 16-bit linear pulse code modulation (LPCM) is managed in the Representation (a3r1) of the Adaptation Set (a3), and an MP4 file of 48 kHz 24-bit linear pulse code modulation (LPCM) is managed in the Representation (a3r2).

Also, as illustrated in FIG. 25, between the Representation (a1r1) and the Representation (a2r1), it is aligned at all the Segment boundaries. Between the Representation (a3r1) and the Representation (a3r2) also, it is aligned at all the Segment boundaries. In addition, the segment boundaries are aligned among all the Representations for every four Segments in the Representation (a1r1) and the Representation (a2r1), and every five Segments in the Representation (a3r1) and the Representation (a3r2).

A length (reproduction time) of the Segment of the Adaptation Set (a3) is different from that of the Adaptation Set (a1) and the Adaptation Set (a2). In such a case, the Segment boundaries align at the least common multiple of the lengths of the Segments of both Adaptations. For example, assuming that the length of the Segment of the Adaptation Set (a1) and the Adaptation Set (a2) is five fourths of the length of the Segment of the Adaptation Set (a3), as illustrated in FIG. 25, the Segment boundaries align every four Segments in the Adaptation Set (a1) and the Adaptation Set (a2) and every five Segments in the Adaptation Set (a3).

The seamless switching may be performed by performing the switching at the aligned Segment boundaries as described above between these Representations.

FIG. 26 is a view illustrating a description example of the MPD in the case of FIG. 25. In the case of the example in FIG. 26, the information regarding the switching across the Adaptation Sets is set in the Adaptation Set.

In the Adaptation Set (a1), a value “a2 a3” is set in the attribute @ContentSwitchingDestinationId and a value “14 is set in the attribute @ContentSwitchingAlignmentCycle as indicated by an underline in FIG. 26. That is, in this case, as seen from the Adaptation Set (a1), the candidate for the switching destination is the Adaptation Set (a2) and the Adaptation Set (a3). Also, the candidate for the timing for switching to the Adaptation Set (a2) is all the Segment boundaries, and the candidate for the timing for switching to the Adaptation Set (a3) is every four Segment boundaries.

Also, in the Adaptation Set (a2), a value “a1 a3” is set in the attribute @ContentSwitchingDestinationId and a value “14 is set in the attribute @ContentSwitchingAlignmentCycle. That is, as seen from the Adaptation Set (a2), the candidate for the switching destination is the Adaptation Set (a1) and the Adaptation Set (a3). Also, the candidate for the timing for switching to the Adaptation Set (a1) is all the Segment boundaries, and the candidate for the timing for switching to the Adaptation Set (a3) is every four Segment boundaries.

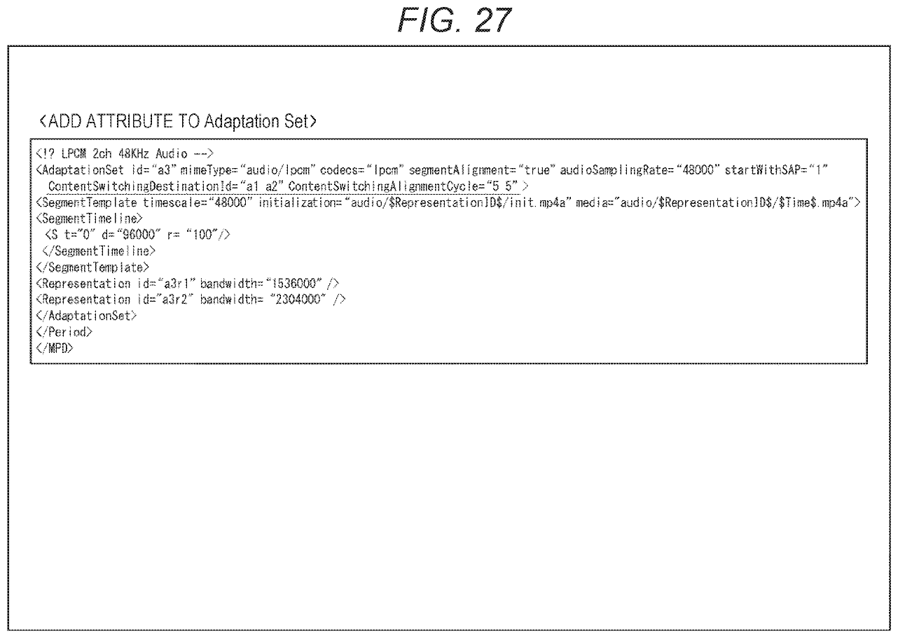

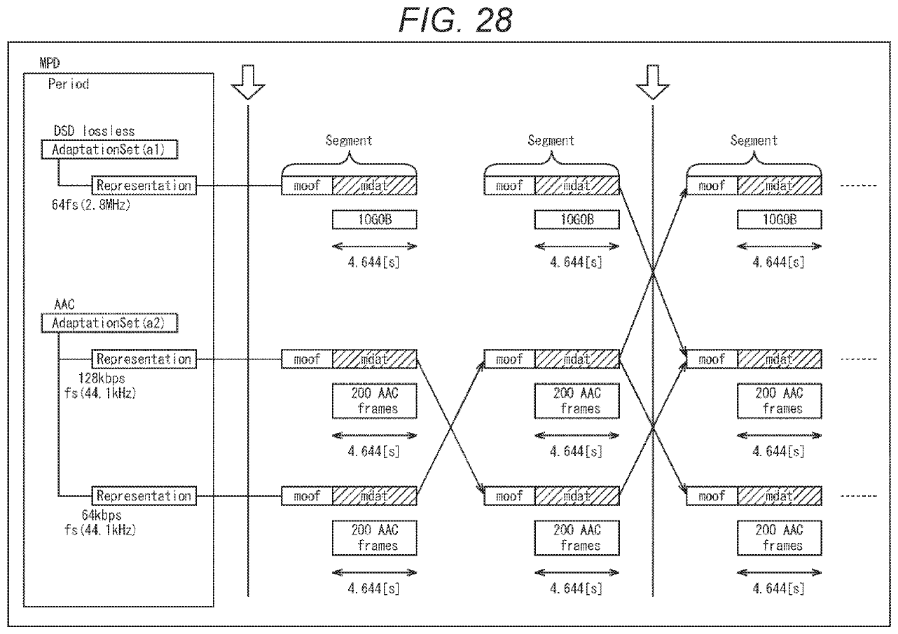

FIG. 27 is a view illustrating a description example of the MPD in this case. The description example of the MPD illustrated in FIG. 27 corresponds to the configuration in FIG. 25. In this case, in the Adaptation Set (a3), a value “a1 a2” is set in the attribute @ContentSwitchingDestinationId and a value “55” is set in the attribute @ContentSwitchingAlignmentCycle as indicated by an underline in FIG. 27. That is, as seen from the Adaptation Set (a3), the candidate for the switching destination is the Adaptation Set (a1) and the Adaptation Set (a2). Also, the candidate for the timing for switching to the Adaptation Set (a1) or the Adaptation Set (a2) is every five Segment boundaries.

In a case where the content may be created assuming the switching in advance, as in the example in FIG. 23, it is possible to synchronize the segment boundaries by forming the segment to be common multiple of an audio frame inherent to each audio stream (also referred to as an audio access unit and audio frame; often referred to as one MP4 sample from a system layer of MP4). In the example in FIG. 23, the time length of one Segment is approximately 4.6 seconds, which is an appropriate length; this is because a Block length of the DSD lossless stream is designed in consideration of the audio frame length of the AAC.

However, in general, if one Segment is formed to be common multiple of the audio frame, one Segment might become longer as several seconds or longer. From a viewpoint of random access, it is desirable to set the Segment time length to approximately three to four seconds or shorter, and depending on a use case, there is a case where one Segment cannot be formed to be common multiple of the audio frame. In the example in FIG. 25, the Segment length is limited to approximately three to four seconds in order to improve convenience of random access, so that the length of one Segment is different between DSD and LPCM.

However, due to the property that the Segment length is fixed in the Adaptation Set, there occurs a point where the Segment boundaries coincide on a certain cycle. In this manner, the Segment boundary satisfying necessary conditions for realizing the seamless switching occurs on a certain cycle.

Therefore, the seamless switching may be performed by providing the MPD with the attribute that allows the player to immediately recognize this site in the MPD as described above.

<MPD Configuration and Description Example 4>

Meanwhile, if the common multiple of the Segment length is simply a switchable site, it is not impossible to realize the switching between the Adaptation Sets by using information of Segment duration described in the MPD. For example, MultipleSegmentBaseInformation element is defined in the MPD, and a @duration attribute is present. However, in the description of the attribute @duration, it is described that a value of duration is not a strict value but an approximate value (ISO/IEC23009−1:2014; “If present, specifies the constant approximate Segment duration.”). In this manner, it is not possible to determine whether or not the Segment boundaries completely coincide on a time axis only from the information of the duration in the MPD.

In addition, by allowing the switching between the Adaptation Sets, it is conceivable that a function of suppressing switching that a content creator or the distribution side does not desire or switching with a problem in operability is required. The switching of the stream is heretofore limited within the Adaptation Set, so that the content creator or the distribution side could assume the switching which the player performs. However, when the switching between the Adaptation Sets is also allowed, there is a possibility that switching which the content creator and the distribution side cannot assume may be performed.

Therefore, the above-described extended attribute (the information regarding the switching destination and the information regarding the timing) may be used to suppress such switching not supposed by the distribution side. That is, specifically, it is possible to allow only switching at a part of the boundaries among the aligned Segment boundaries by the above-described extended attribute (the information regarding the switching destination and the information regarding the timing).

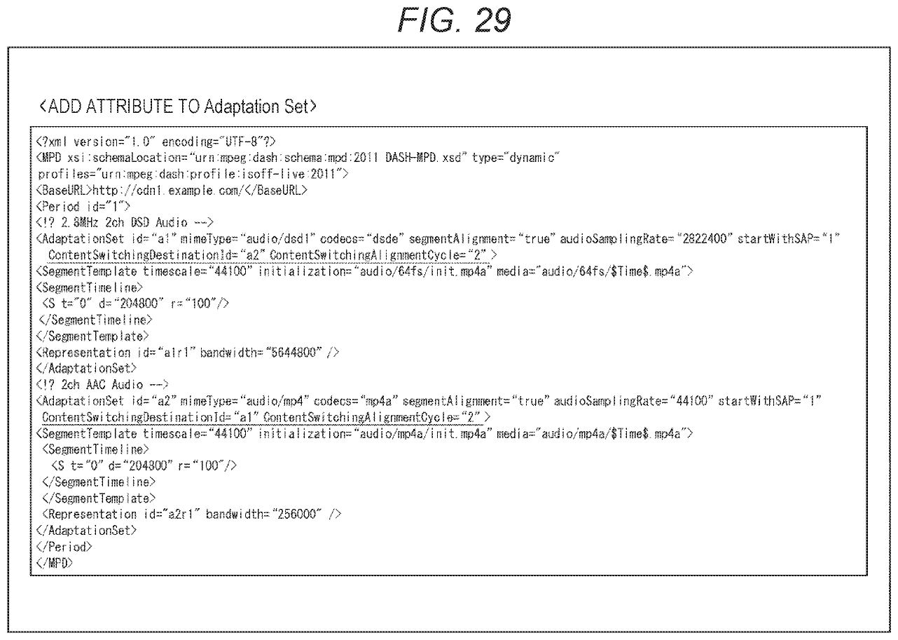

For example, in the example in FIG. 28, as in a case in FIG. 20, all the Segment boundaries are aligned among all the Representations. Therefore, although it is possible to allow the switching at all the Segment boundaries, it is also possible to allow the switching only at a part of the Segment boundaries as indicated by an arrow in FIG. 28. Furthermore, it is also possible to allow the switching only between a part of Representations (for example, only between the Representations of the AAC) as at the Segment boundary between the first Segment and the second Segment, for example. A description example of the MPD is illustrated in FIG. 29. As illustrated in an underlined part in FIG. 29, in this case, the Segment boundary at which the switching is allowed is limited to a part of the Segment boundaries.

For example, in the Segment configuration in FIG. 28, when the switching between the Adaptation Sets is performed at all the Segment boundaries, switching between a DSD lossless decoder and an AAC decoder might occur every approximately 4.6 seconds. Resetting and initial setting are required when switching the decoders with different encoding systems, and when it is switched so frequently, it is possible that operability is lowered (responsiveness is degraded) and a reproduction quality is deteriorated depending on player's hardware performance and the like. That is, in a case where the Segment length is defined in consideration of the switching “within” the Adaptation Set, this does not always match the switchable site “between” the Adaptation Sets.

Therefore, even in a case where all the Segment boundaries are aligned between the Adaptation Sets, the player may determine whether the switching between the Adaptation Sets may be performed at a higher speed when being notified of the Segment boundaries at which the switching between the Adaptation Sets may be performed by the extended attribute such as the information regarding the switching and the information regarding the timing described above. Also, since the Segment boundaries at which it may be switched are limited (reduced) as described above, it is possible to perform the seamless switching while suppressing the reduction in player's operability and a reproduction quality.

Meanwhile, the conventional player which cannot interpret the extended attribute described above may skip over the extended attribute included in the MPD. Since the conventional player only switches within the Adaptation Set as in the conventional manner, this may correctly reproduce the content data according to the description of the MPD even if this extended attribute is skipped over. That is, by using the present technology of extending the attribute (the information regarding the switching across the first management units) described above, it becomes possible to provide a new user interface (UI) while maintaining compatibility.

<Distribution System>

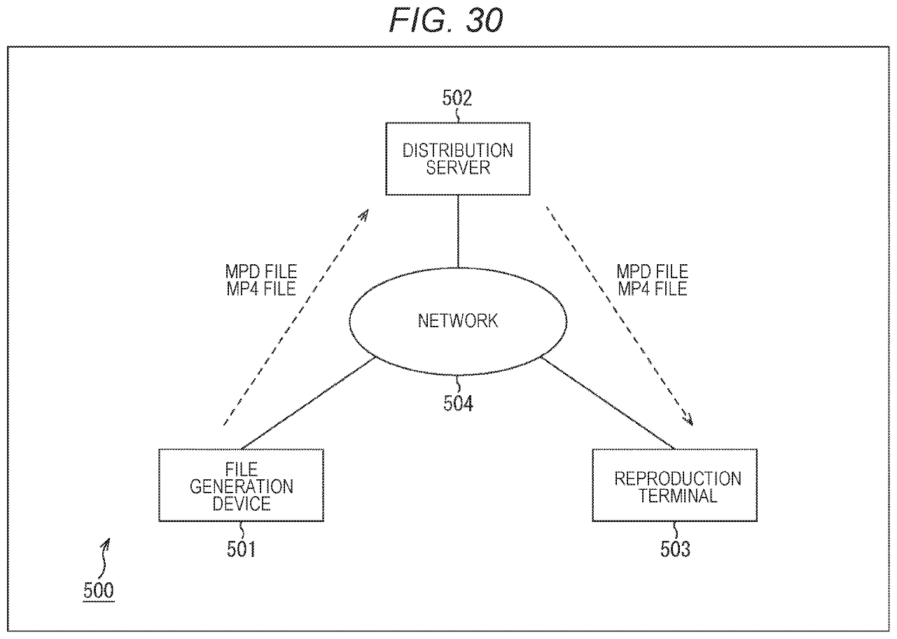

Next, a system to which the present technology as described above is applied is described. FIG. 30 is a block diagram illustrating an example of a configuration of a distribution system which is an aspect of an information processing system to which the present technology is applied. A distribution system 500 illustrated in FIG. 30 is a system which distributes data (content) such as an image and audio. In the distribution system 500, a file generation device 501, a distribution server 502, and a reproduction terminal 503 are connected to each other so as to be able to communicate via a network 504.

The file generation device 501 is an aspect of an information processing device to which the present technology is applied, and is a device which performs processing regarding generation of the MP4 file which stores audio data and the file of the MPD (also referred to as the MPD file). For example, the file generation device 501 generates the audio data, generates the MP4 file which stores the generated audio data and the MPD file which manages the MP4 file, and supplies the generated files to the distribution server 502.

The distribution server 502 is an aspect of the information processing device to which the present technology is applied, and is a server which performs processing regarding a distribution service of the content data using the MPEG-DASH (that is, the distribution service of the MP4 file using the MPD file). For example, the distribution server 502 acquires the MPD file and the MP4 file supplied from the file generation device 501 and manages them, and provides the distribution service using the MPEG-DASH. For example, in response to a request from the reproduction terminal 503, the distribution server 502 provides the reproduction terminal 503 with the MPD file. Also, in response to a request from the reproduction terminal 503 based on the MPD file, the distribution server 502 supplies the reproduction terminal 503 with the requested MP4 file.

The reproduction terminal 503 is an aspect of the information processing device to which the present technology is applied, and is a device that performs processing regarding the reproduction of the audio data. For example, the reproduction terminal 503 requests the distribution server 502 to distribute the MP4 file according to the MPEG-DASH, and acquires the MP4 file supplied in response to the request. More specifically, the reproduction terminal 503 acquires the MPD file from the distribution server 502, and acquires the MP4 file which stores desired content data from the distribution server 502 according to the information of the MPD file. The reproduction terminal 503 decodes the acquired MP4 file and reproduces the audio data.

The network 504 is an arbitrary communication network; this may be a wired communication network, a wireless communication network, or both of them. Also, the network 504 may include one communication network, or this may include a plurality of communication networks. For example, the network 504 may include a communication network or a communication path of an arbitrary communication standard such as the Internet, a public telephone line network, a wide area communication network for wireless mobile body such as so-called 3G line and 4G line, a wide area network (WAN), a local area network (LAN), a wireless communication network which performs communication compliant with the Bluetooth (registered trademark) standard, a communication path of short-range wireless communication such as near field communication (NFC), a communication path of infrared communication, and a communication network of wired communication compliant with the standard such as high-definition multimedia interface (HDMI) (registered trademark) and a universal serial bus (USB).

The file generation device 501, the distribution server 502, and the reproduction terminal 503 are connected to the network 504 so as to be able to communicate, and may exchange information with each other via the network 504. The file generation device 501, the distribution server 502, and the reproduction terminal 503 may be connected to the network 504 by wired communication, or wireless communication, or both of them.

Meanwhile, in FIG. 30, one file generation device 501, one distribution server 502, and one reproduction terminal 503 are illustrated as a configuration of the distribution system 500, but the numbers of them are arbitrary and are not necessarily the same. For example, in the distribution system 500, each of the file generation device 501, the distribution server 502, and the reproduction terminal 503 may be single or plural.

<File Generation Device>

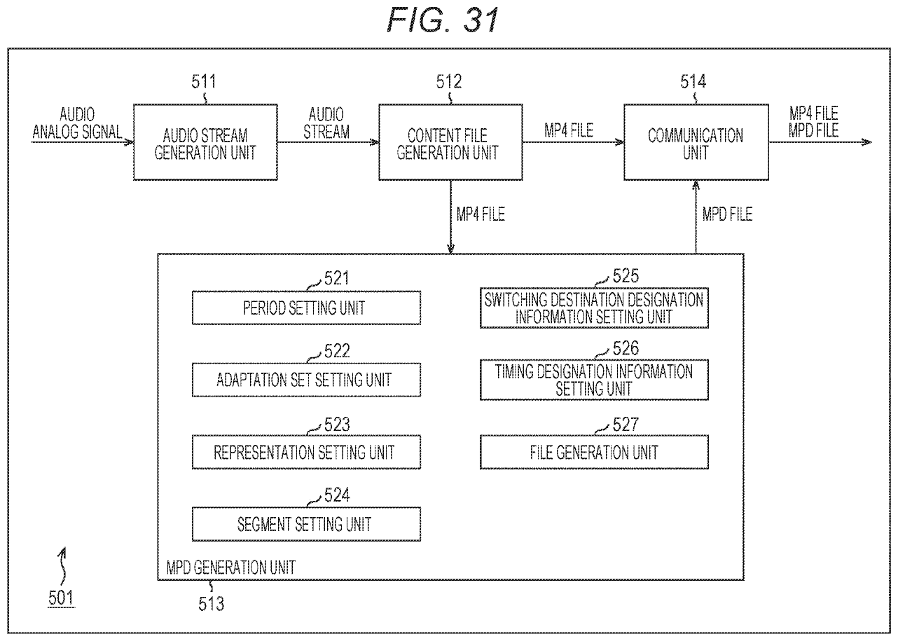

FIG. 31 is a block diagram illustrating a principal configuration example of the file generation device 501. As illustrated in FIG. 31, the file generation device 501 includes an audio stream generation unit 511, a content file generation unit 512, an MPD generation unit 513, and a communication unit 514.

The audio stream generation unit 511 performs processing regarding generation of the stream of the content data. For example, the audio stream generation unit 511 modulates, A/D converts, or encodes an input audio analog signal (also referred to as an audio signal) to generate an audio stream being a stream of audio digital data (also referred to as audio data), and supplies the same to the content file generation unit 512.

Meanwhile, the content of signal processing on the audio analog signal by the audio stream generation unit 511 is arbitrary. For example, in a case of adopting modulation or encoding, a modulation system and an encoding system are arbitrary. For example, the audio stream generation unit 511 may generate the DSD lossless stream, the AAC stream, the stream of LPCM and the like from the audio analog signal.

The content file generation unit 512 performs processing regarding generation of a file (content file) that stores the content data supplied from the audio stream generation unit 511. For example, the content file generation unit 512 generates the MP4 file which is the content file that stores the audio stream supplied as the content data from the audio stream generation unit 511, and supplies the same to the MPD generation unit 513 and the communication unit 514.

Meanwhile, a specification of the content file generated by the content file generation unit 512 is arbitrary. For example, the content file generation unit 512 may generate the MP4 file that stores the DSD lossless stream, the AAC stream, the stream of LPCM and the like. It goes without saying that the content file generation unit 512 may generate the content file other than the MP4 file.

The MPD generation unit 513 performs processing regarding generation of management information of the content file generated by the content file generation unit 512. For example, the MPD generation unit 513 generates the MPD file regarding the MP4 file supplied from the content file generation unit 512, and supplies the same to the communication unit 514. When generating the MPD file, the MPD generation unit 513 applies the above-described present technology and sets the information regarding the switching across the Adaptation Sets in the MPD using the above-described extended attribute.

The communication unit 514 performs processing regarding communication with other devices via the network 504. For example, the communication unit 514 supplies the supplied MPD file and MP4 file to the distribution server 502.

As illustrated in FIG. 31, the MPD generation unit 513 includes a Period setting unit 521, an Adaptation Set setting unit 522, a Representation setting unit 523, a Segment setting unit 524, a switching destination designation information setting unit 525, a timing designation information setting unit 526, and a file generation unit 527.

The Period setting unit 521 performs processing regarding setting of Period of the MPD. The Adaptation Set setting unit 522 performs processing regarding setting of the Adaptation Set of the MPD. The Representation setting unit 523 performs processing regarding setting of Representation of the MPD. The Segment setting unit 524 performs processing regarding setting of the Segment of the MPD. The switching destination designation information setting unit 525 performs processing regarding setting of the information regarding the switching destination of the switching across the Adaptation Sets of the MP4 file to be reproduced. The timing designation information setting unit 526 performs processing regarding setting of the information regarding the timing of the switching across the Adaptation Sets of the MP4 file to be reproduced. The file generation unit 527 performs processing regarding the generation of the MPD file.

<Flow of Distribution Data Generation Processing>

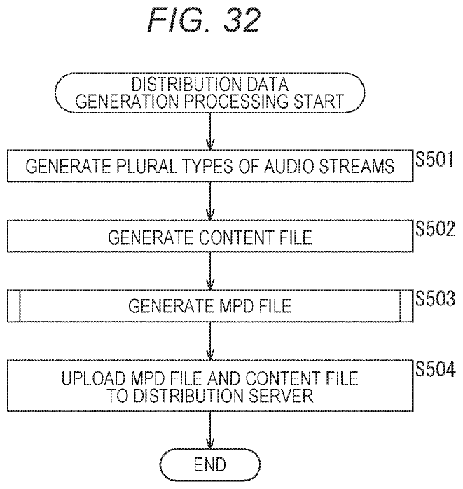

Next, an example of a flow of distribution data generation processing executed by the file generation device 501 of the distribution system 500 is described with reference to a flowchart in FIG. 32. The file generation device 501 performs this distribution data generation processing when generating the MP4 of the content data file and the MPD file.

When the distribution data generation processing is started, the audio stream generation unit 511 of the file generation device 501 generates a plurality of types of audio streams from the audio analog signal at step S501. For example, the audio stream generation unit 511 generates the DSD data by performing AZ modulation on the audio analog signal, and further encodes the DSD data by the above-described new DSD lossless compression encoding system to generate the DSD lossless stream. In addition, the audio stream generation unit 511 may also generate the stream of LPCM, the stream of AAC and the like.

At step S502, the content file generation unit 512 generates the content file (for example, MP4 file) which stores the audio stream generated at step S501.

At step S503, the MPD generation unit 513 executes MPD file generation processing and generates the MPD file which manages the content file (MP4 file) generated at step S502.

At step S504, the communication unit 514 supplies (uploads) the content file generated at step S502 and the MPD file generated at step S503 to the distribution server 502.

When the processing at step S504 is finished, the distribution data generation processing is finished.

<Flow of MPD File Generation Processing>

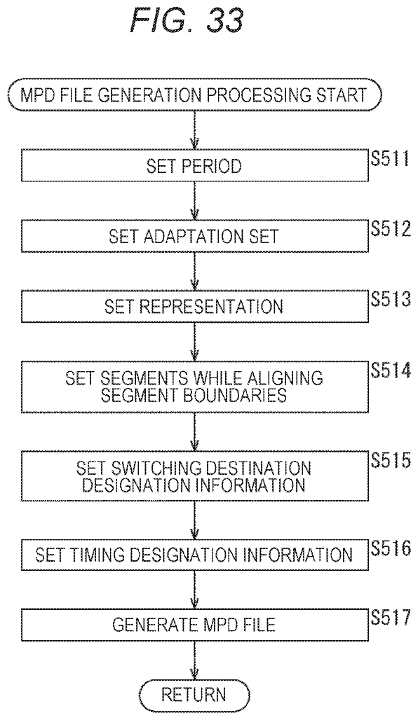

Next, an example of a flow of the MPD file generation processing executed at step S503 in FIG. 32 is described with reference to a flowchart in FIG. 33.

When the MPD file generation processing is started, the Period setting unit 521 of the MPD generation unit 513 sets the Period at step S511 for the content file (MP4 file) generated at step S502. At step S512, the Adaptation Set setting unit 522 sets the Adaptation Set. At step S513, the Representation setting unit 523 sets the Representation.

At step S514, the Segment setting unit 524 sets the Segments while appropriately aligning the Segment boundaries. Meanwhile, it is not necessary to align the Segment boundaries at all the Segment boundaries as described above. That is, it is also possible that the Segment setting unit 524 aligns only a part of the Segment boundaries. A manner of aligning the Segment boundaries is determined on the basis of, for example, arbitrary information such as specifications of each encoding system and the like, and instructions of the user and the like.

At step S515, the switching destination designation information setting unit 525 sets the switching destination designation information designating an arbitrary management unit such as the Adaptation Set or the Representation allowed as the switching destination of the switching across the Adaptation Sets. Meanwhile, this switching destination designation information is information regarding the above-described switching destination and is information to which the present technology is applied. That is, for example, the switching destination designation information setting unit 525 sets the extended attribute @ContentSwitchingDestinationId to which the present technology is applied as the switching destination designation information.

Meanwhile, the switching destination designation information may be set in an arbitrary management unit such as the Adaptation Set and the Representation, for example. The switching destination designation information setting unit 525 determines a management unit to be allowed as the switching destination on the basis of arbitrary information such as various types of information of the MP4 file, the alignment of the Segment boundaries set at step S514, the instruction of the user and the like and sets the switching destination designation information, for example.

At step S516, the timing designation information setting unit 526 sets the timing designation information for designating the timing at which the switching across the Adaptation Sets is allowed. Meanwhile, this switching designation information is information regarding the timing of the switching described above and is information to which the present technology is applied. That is, for example, the timing designation information setting unit 526 sets the extended attribute @ContentSwitchingAlignmentCycle to which the present technology is applied as the timing designation information.

Meanwhile, the switching destination designation information may be set in an arbitrary management unit such as the Adaptation Set and the Representation, for example. The timing designation information setting unit 526 determines the timing at which the switching across the Adaptation Sets is allowed on the basis of arbitrary information such as the various types of information of the MP4 file, the alignment of the Segment boundaries set at step S514, the instruction of the user and the like, for example, and sets the timing designation information.

At step S517, the file generation unit 527 generates the MPD file reflecting the various settings performed at steps S511 to S516. When the MPD file is generated, the MPD file generation processing is finished, and the procedure returns to FIG. 32.

By executing each processing as described above, the file generation device 501 may generate the MPD file having the extended attribute to which the present technology is applied. That is, the file generation device 501 may set the information regarding the switching to which the present technology is applied. Therefore, the seamless switching across the Adaptation Sets may be easily realized, and the content data may be transmitted more stably.

<Reproduction Terminal>

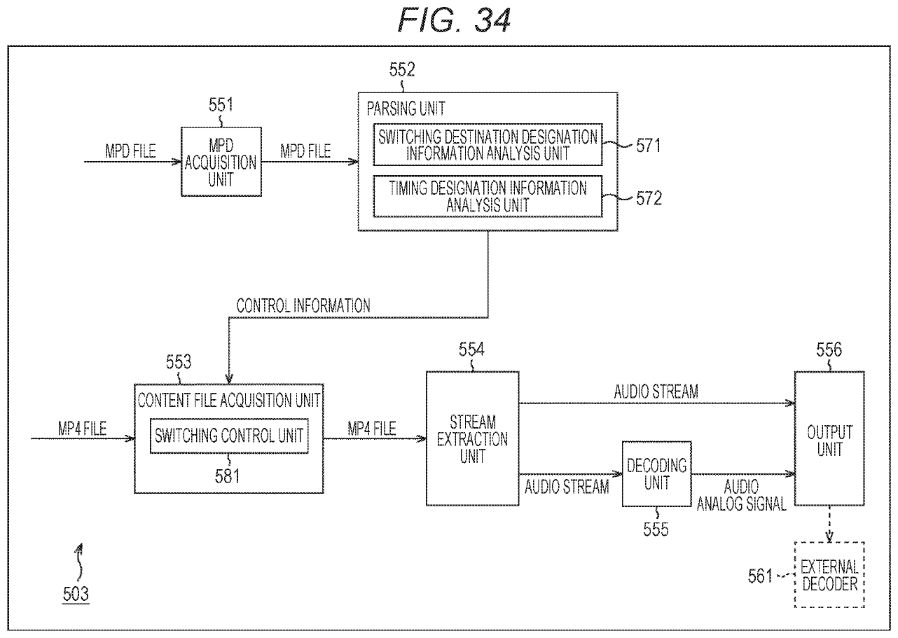

FIG. 34 is a block diagram illustrating a principal configuration example of the reproduction terminal 503. As illustrated in FIG. 33, the reproduction terminal 503 includes an MPD acquisition unit 551, a parsing unit 552, a content file acquisition unit 553, a stream extraction unit 554, a decoding unit 555, and an output unit 556.

The MPD acquisition unit 551 performs processing regarding the acquisition of the MPD file. For example, the MPD acquisition unit 551 requests the MPD file from the distribution server 502, and acquires the MPD file supplied from the distribution server 502. The MPD acquisition unit 551 supplies the acquired MPD file to the parsing unit 552.

The parsing unit 552 performs processing regarding parsing (analysis) of the MPD file. For example, the parsing unit 552 parses the MPD file supplied from the MPD acquisition unit 551, generates control information corresponding to the description of the MPD file, and supplies the same to the content file acquisition unit 553.

The content file acquisition unit 553 performs processing regarding the acquisition of the content file. For example, the content file acquisition unit 553 acquires the MP4 file as the content file from the distribution server 502 on the basis of the control information supplied from the parsing unit 552, and supplies the acquired MP4 file to the stream extraction unit 554.

The stream extraction unit 554 performs processing regarding stream extraction. For example, the stream extraction unit 554 extracts the audio stream from the MP4 file supplied from the content file acquisition unit 553. For example, in a case of decoding and outputting the audio stream, the stream extraction unit 554 supplies the extracted audio stream to the decoding unit 555. In a case of outputting the audio stream as is, the stream extraction unit 554 supplies the extracted audio stream to the output unit 556.

The decoding unit 555 performs processing regarding the decoding of the encoded data acquired by encoding the content data. For example, the decoding unit 555 decodes the audio stream supplied from the stream extraction unit 554 and restores the audio analog signal. The decoding unit 555 supplies the restored audio analog signal to the output unit 556. Meanwhile, the processing performed by the decoding unit 555 on the audio stream is arbitrary as long as this is a correct method for the stream. For example, not only decoding but also demodulation, D/A conversion, and the like may also be performed.

For example, the audio stream is the DSD lossless stream, and the decoding unit 555 decodes the DSD lossless stream, restores the DSD data, and further demodulates the same to restore the audio analog signal. Also, for example, the audio stream may be the LPCM stream or the AAC stream. The decoding unit 555 performs processing according to the data and restores the audio analog signal.

The output unit 556 performs processing regarding the output of the content data. For example, the output unit 556 includes a speaker and outputs the audio analog signal supplied from the decoding unit 555 from the speaker. Also, for example, the output unit 556 includes an analog signal output terminal and supplies the audio analog signal supplied from the decoding unit 555 to another device via the output terminal. Furthermore, for example, the output unit 556 includes an output terminal of a digital signal and supplies the audio stream supplied from the stream extraction unit 554 to another device such as an external decoder 561 and the like via the output terminal. That is, the audio stream may also be decoded by the external decoder 561 provided outside the reproduction terminal 503.

Also, as illustrated in FIG. 34, the parsing unit 552 includes a switching destination designation information analysis unit 571 and a timing designation information analysis unit 572. The switching destination designation information analysis unit 571 performs processing regarding the analysis of the switching destination designation information (information regarding the switching destination of the switching across the Adaptation Sets of the content data to be reproduced) included in the MPD file. The timing designation information analysis unit 572 performs processing regarding the analysis of the timing designation information (information regarding the timing of the switching across the Adaptation Sets of the content data to be reproduced) included in the MPD file.

Also, as illustrated in FIG. 34, the content file acquisition unit 553 includes a switching control unit 581. The switching control unit 581 performs processing regarding the control of the switching across the Adaptation Sets of the content data to be reproduced. For example, on the basis of analysis results of the switching destination designation information analysis unit 571 and the timing designation information analysis unit 572 (on the basis of the control information reflecting the analysis results of the switching destination designation information analysis unit 571 and the timing designation information analysis unit 572), the switching control unit 581 performs control of this switching.

<Flow of Reproduction Processing>

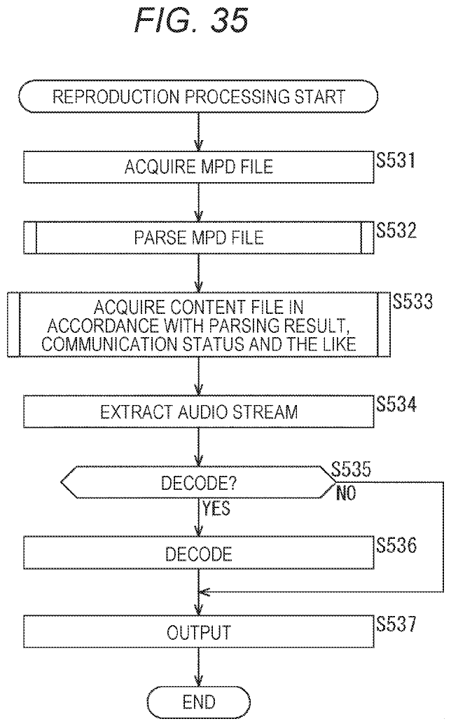

Next, an example of a flow of reproduction processing executed by the reproduction terminal 503 of the distribution system 500 is described with reference to a flowchart in FIG. 35. When the reproduction processing is started, the MPD acquisition unit 551 of the reproduction terminal 503 acquires the MPD file designated by the user or the like, for example, from the distribution server 102 at step S531.

At step S532, the parsing unit 552 executes the parsing processing to parse the MPD file acquired at step S531 and generates the control information reflecting a parsing result. At step S533, the content file acquisition unit 553 executes the content file acquisition processing and acquires the MP4 file regarding desired content from the distribution server 102 in accordance with the parsing result (control information) at step S532, a communication status such as an available band of the network 504 and the like.

At step S534, the stream extraction unit 554 extracts the audio stream from the MP4 file acquired at step S533. At step S535, the decoding unit 555 determines whether or not to decode the audio stream. In a case where it is determined to decode, the procedure shifts to step S536. At step S536, the decoding unit 555 decodes the audio stream extracted at step S534 and restores the audio analog signal. When the audio stream is decoded, the procedure shifts to step S537. Also, in a case where it is determined at step S535 that the audio stream is not decoded, the procedure shifts to step S537.

At step S537, the output unit 556 outputs the audio stream or audio analog signal. When the processing at step S537 is finished, the reproduction processing is finished.

<Flow of Parsing Processing>

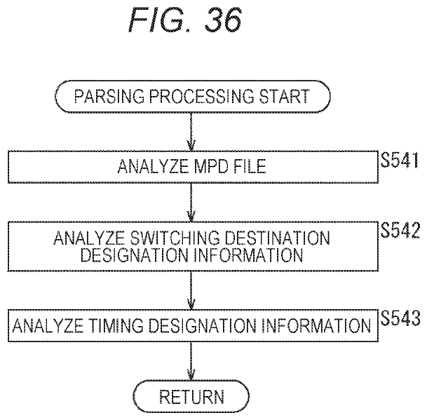

Next, an example of a flow of parsing processing executed at step S532 in FIG. 35 is described with reference to a flowchart in FIG. 36.

When the parsing processing is started, the parsing unit 552 analyzes the MPD file at step S541. At step S542, the switching destination designation information analysis unit 571 analyzes the switching destination designation information included in the MPD file. At step S543, the timing designation information analysis unit 572 analyzes the timing designation information included in the MPD file.

When the processing at step S543 is finished, the parsing processing is finished, and the procedure returns to FIG. 35. As described above, the parsing unit 552 may analyze the MPD file and further analyze the extended attribute (@ContentSwitchingDestinationId, @ContentSwitchingAlignmentCycle and the like) to which the present technology is applied.

<Flow of Content File Acquisition Processing>

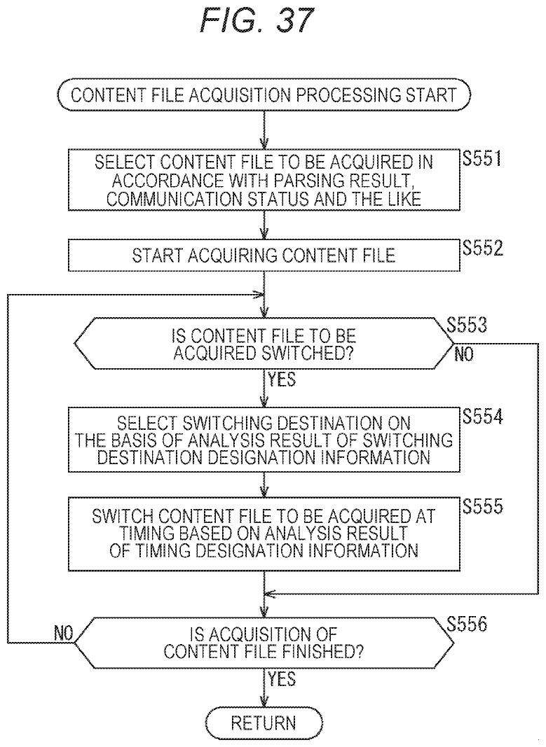

Next, an example of a flow of content file acquisition processing executed at step S533 in FIG. 35 is described with reference to a flowchart in FIG. 37. When the content file acquisition processing is started, at step S551, the content file acquisition unit 553 selects the content file (MP4 file) to be acquired according to the parsing result, the communication status and the like. When the MP4 file to be acquired is determined, at step S552, the content file acquisition unit 553 starts acquiring the MP4 file.

At step S553, the switching control unit 581 determines whether or not to switch the acquired MP4 file. For example, in a case where it is determined to switch the acquired MP4 file according to variation in the transmission band and the like, the procedure shifts to step S554.

At step S554, the switching control unit 581 selects the switching destination (that is, the MP4 file after switching) on the basis of the analysis result of the switching destination designation information. At step S555, the switching control unit 581 determines the timing to perform the switching on the basis of the analysis result of the timing designation information and switches the MP4 file to be acquired at that timing.

When the processing at step S555 is finished, the procedure shifts to step S556. Also, in a case where it is determined at step S553 that the MP4 file to be acquired is not switched, the procedure shifts to step S556.

At step S556, the content file acquisition unit 553 determines whether or not to finish acquiring the MP4 file. In a case where it is determined that the acquisition of the MP4 file of the desired content is not yet finished and the acquisition of the MP4 file is not finished, the procedure returns to step S553 and the subsequent processing is repeated. Then, in a case where it is determined at step S556 that acquisition of the MP4 file regarding the desired content is finished, the content file acquisition processing is finished.

By executing each processing as described above, the reproduction terminal 503 may acquire the content file according to the MPD file having the extended attribute to which the present technology is applied. That is, according to the MPD file, the reproduction terminal 503 may easily realize the seamless switching across the Adaptation Sets, and realize more stable transmission of the content data.

### 3. Second Embodiment

<Control of Switching Policy>

By applying the present technology described in the first embodiment, switching between Adaptation Sets is allowed, and a large degree of freedom is generated in stream switching. Depending on the degree of freedom, a combination of the switching which a content creation side/distribution side does not desire might occur.

For example, in a case where video and audio have similar bit rates, either video or audio may be switched depending on variation in transmission path band. For example, in a case of application focusing on audio, a policy to lower a rate of video first and to maintain a quality of audio as much as possible when the transmission band is lowered is conceivable. In this manner, by switching according to priority of a stream assumed by a transmission side instead of simply selecting the stream only by a bit rate value, a high quality in a state where the video and the audio are combined might be maintained.

Also, as another case, it is assumed that there is application with which DSD of a sampling_frequency of 2.8 MHz may be reproduced by all players but only a part of players support DSD of 5.6 MHz. At that time, there may be a policy that switching from DSD 5.6 MHz to DSD 2.8 MHz may be performed automatically by the player, but it is wanted that switching in the opposite way is not performed unless the user explicitly instructs to do so.

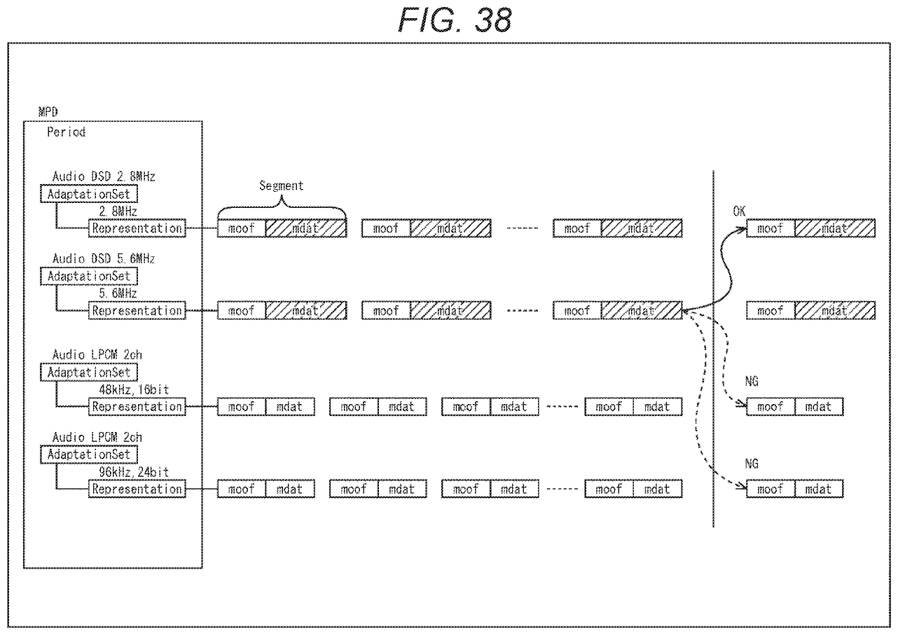

Also, as in an example illustrated in FIG. 38, there may also be a policy that the switching from DSD 5.6 MHz to DSD 2.8 MHz may be performed automatically by the player, but it is wanted to suppress switching from DSD 5.6 MHz to LPCM.

Therefore, it is also possible to notify the player side of priority order of the switching, switching directionality (switching in a certain direction is easy but that in the opposite direction is difficult), and the like desired by the distribution side, thereby controlling the switching by the player.

<Setting of Switching Priority Order>

As information regarding such switching policy, information regarding the priority order of the switching across first management units of data to be reproduced may be set. In addition, the information regarding the priority order may be information indicating the priority order of the first management unit.

By setting such information regarding the switching priority order, it is possible to control the switching policy on the player side from the distribution side. Therefore, it is possible to suppress the switching not intended by the distribution side from being performed by the player side. This makes it possible to suppress unstable transmission of content data, such as transmission of only video data, for example, which the distribution side does not expect. That is, the content data may be transmitted as intended by the distribution side. That is, the content data may be transmitted more stably.

Meanwhile, the data to be reproduced may be the content data (audio stream), management information may be MPD of MPEG-DASH, and the first management unit may be Adaptation Set. By doing so, distribution using the MPEG-DASH may be performed more stably.

For example, an attribute @stabilityRanking may be set as the information regarding the priority order. The attribute @stabilityRanking is an attribute indicating tolerance of switching, and may be set for Adaptation, for example. For example, in this attribute @stabilityRanking, a natural number indicating the tolerance of the switching of the Adaptation Set is set. The larger the value of this attribute, the more the switching is allowed, and it is controlled such that (lower-order) Adaptation Set having a larger value is switched earlier when the switching of the stream is performed. That is, it is indicated that the Adaptation Set in which the value of the attribute is “1” is the last Adaptation Set the switching of which is wanted.

<Example of Priority Rule>

The switching based on such information regarding the priority order may also be performed according to the following rule, for example.

When it becomes necessary to lower the bit rate because the transmission band cannot be secured, the switching between Representations in the Adaptation Set is performed. At that time, out of the streams being selected/reproduced, the Representation is switched in order from the (lower-order) Adaptation Set having a larger value of the attribute @stabilityRanking described above.

In addition, in a case where the transmission band cannot be secured by the switching of the Representation and the switching across the Adaptation Sets is necessary, out of the streams being selected/reproduced, the (lowest-order) Adaptation Set having the largest value of the attribute @stabilityRanking is switched to the (lower-order) Adaptation Set having a larger value of the attribute @stabilityRanking.

Furthermore, in a case where the (lowest-order) Adaptation Set having the largest value of the attribute @stabilityRanking cannot be switched any more, it is tried to switch another (one order higher) Adaptation Set having a second largest value of the attribute @stabilityRanking.

Meanwhile, in the description above, the value of the attribute @stabilityRanking is set to a natural number, but it is also possible to set a value “0” in this attribute @stabilityRanking. In that case, the value “0” may be used as a special value different from the natural number simply indicating the priority.

<Adding Example 1 of Attribute @stabilityRanking>

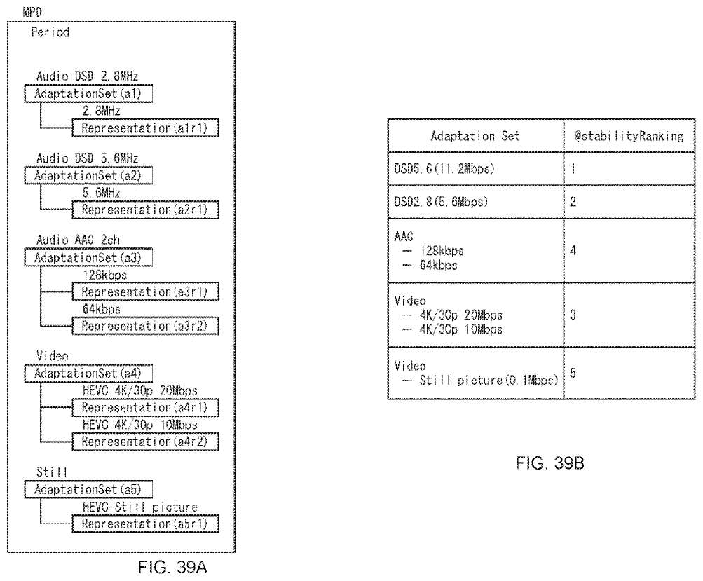

For example, B of FIG. 39 illustrates an example in which the attribute @stabilityRanking is allocated so as to prioritize the distribution of the DSD to each Adaptation Set of an MPD file having a Period configuration as illustrated in A of FIG. 39. As illustrated in a table in B of FIG. 39, in this case, smaller numbers (“1” and “2”) are set for the Adaptation Set of the DSD stream so as not to switch the DSD stream as much as possible.

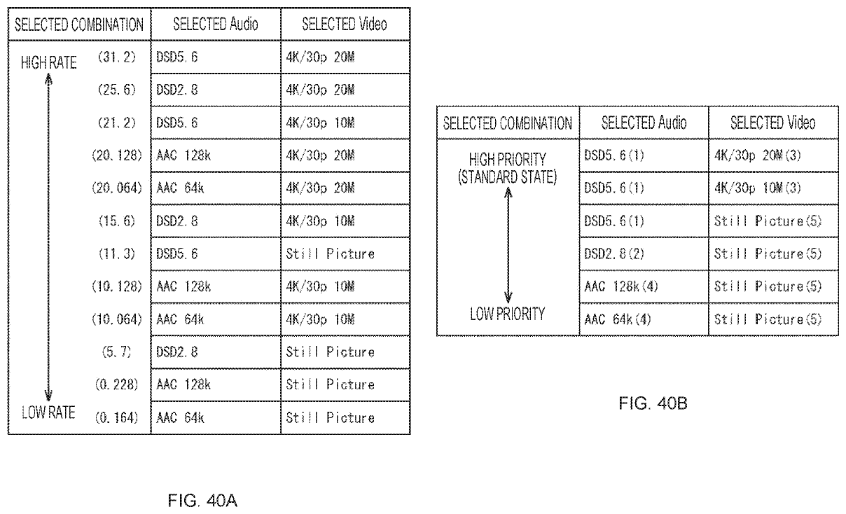

For example, in a case where the player selects video data and audio data to be reproduced in descending order of the total bit rates in accordance with the transmission (transmittable) band for the MPD having such a configuration, each data is selected in the priority order as illustrated in a table in A of FIG. 40. Therefore, in such priority order, the DSD stream cannot be preferentially selected. In addition, image and audio qualities are reversed such that an AAC stream of a low bit rate is selected in preference to the DSD stream of a high bit rate, for example.

On the other hand, by setting the attribute @stabilityRanking of the value as illustrated in the table in B of FIG. 39 for each Adaptation Set and using the same for switching control, the player may select each data in the priority order illustrated in the table in B of FIG. 40. Meanwhile, in the table in B of FIG. 40, the number in parentheses indicates the priority order of the Adaptation Set (the value of attribute @stabilityRanking).

More specifically, first, the highest-order audio and the highest-order video are selected, then the Representation is switched within the (lower-order) Adaptation Set of video having a larger value of the attribute @stabilityRanking. Next, the switching across the Adaptation Sets of (lower-order) video with a larger value of the attribute @stabilityRanking. When the value of the attribute @stabilityRanking of video cannot be increased (the order cannot be lowered) anymore, the switching across the Adaptation Sets of audio is next performed, and the value of the attribute @stabilityRanking of audio is increased (order is lowered).

By selecting in such a procedure, priority order may be selected as illustrated in B of FIG. 40. By selecting the combination of audio and video that falls within the transmission path band in such priority order, it is possible to realize switching that maintains the highest audio quality DSD 5.6 as much as possible.

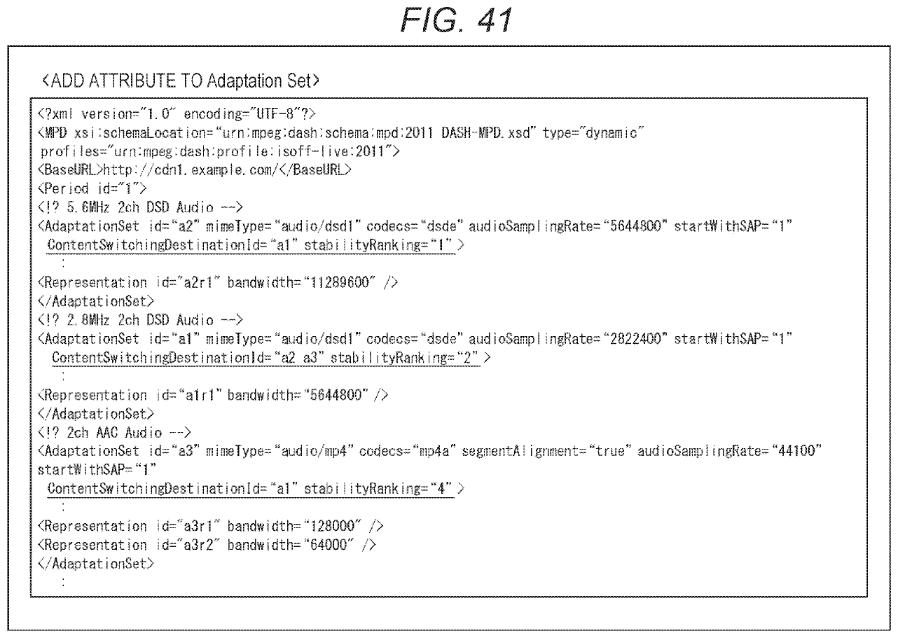

A description example of the MPD in this case is illustrated in FIG. 41. In FIG. 41, the description example of only the Adaptation Set of the audio data is illustrated. As illustrated in FIG. 41, in this case, an attribute @ContentSwitchingDestinationId and the attribute @stabilityRanking are set for each Adaptation Set.

### Adding Example 2 of Attribute @stabilityRanking

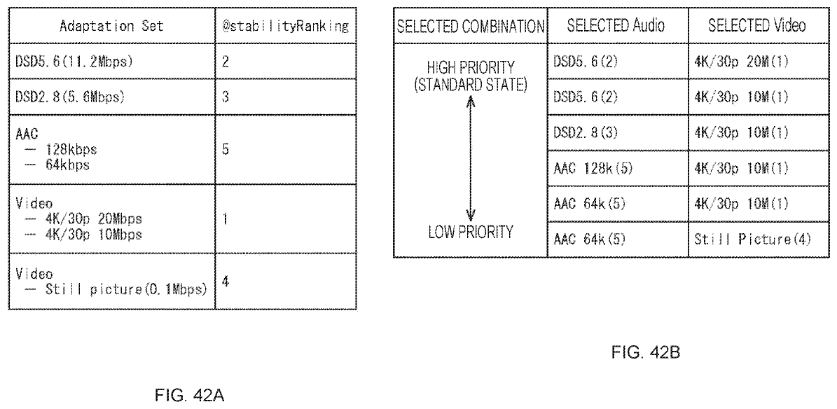

For example, A of FIG. 42 illustrates an example in which the attribute @stabilityRanking is allocated to each Adaptation Set of the MPD file having the Period configuration as illustrated in A of FIG. 39 so as to prioritize the distribution of video. As illustrated in a table in A of FIG. 42, in this case, in order not to switch the video stream as much as possible, a smaller number (“1”) than that of the Adaptation Set of DSD is set for the Adaptation Sets of the video streams (4K/30p 20 Mbps and 4K/30p 10 Mbps).

By setting the attribute @stabilityRanking of such value in each Adaptation Set and using the same for switching control, the player may select each data in the priority order as illustrated in a table in B of FIG. 42. Meanwhile, in the table in B of FIG. 42, the number in parentheses indicates the priority order of the Adaptation Set (the value of attribute @stabilityRanking).

More specifically, first, the highest-order audio and the highest-order video are selected, then it is tried to switch the (lower-order) Representation of DSD 5.6 having a larger value of the attribute @stabilityRanking, but since there is only one, the Representation of video is switched. When it becomes no longer possible to switch Representation, it is switched across the (lower-order) Adaptation Sets of audio having a larger value of the attribute @stabilityRanking. In addition, then, the switching of the (lower-order) Representation of AAC having the large value of the attribute @stabilityRanking is performed. When it becomes impossible to switch across the Adaptation sets of audio and switch the Representation of audio any more, the switching across the Adaptation Sets of video is performed.

By selecting in such a procedure, it may be selected in priority order as illustrated in B of FIG. 42. By selecting the combination of audio and video that falls within the transmission path band in such priority order, it is possible to realize switching that maintains 4K moving image as much as possible.

<File Generation Device>

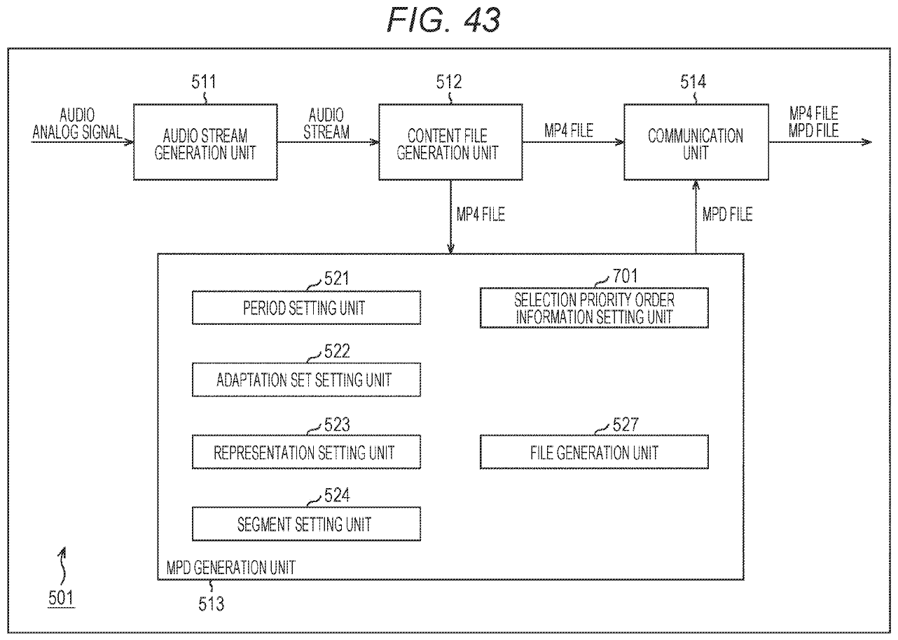

FIG. 43 illustrates a principal configuration example of the file generation device 501 in this case. In this case also, the file generation device 501 basically has the configuration similar to that in a case of the first embodiment (FIG. 31). However, in this case, the MPD generation unit 513 includes a selection priority order information setting unit 701.

The selection priority order information setting unit 701 performs processing regarding the setting of selection priority order information. The selection priority order information is information regarding the priority order of the switching across the Adaptation Sets of the content data, for example, information indicating the priority order of the Adaptation Sets and includes, for example, an extended attribute @stabilityRanking or the like to which the present technology is applied.

<Flow of MPD File Generation Processing>

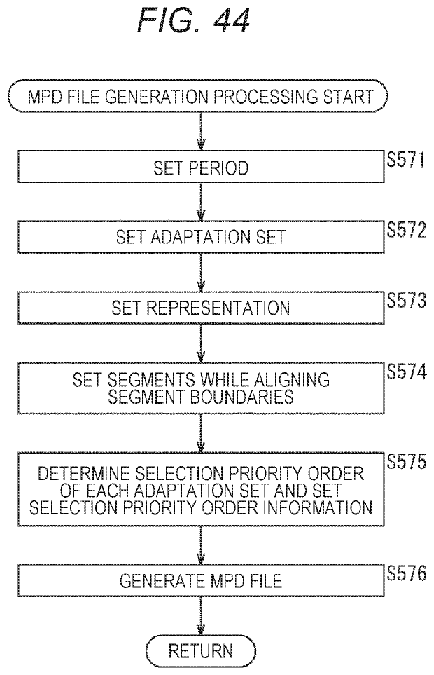

In this case also, the distribution data generation processing is executed in the manner similar to that in a case of the first embodiment (FIG. 32). An example of a flow of the MPD file generation processing in this case is described with reference to a flowchart in FIG. 44.

In this case also, processing at each of steps S571 to S574 is executed in a manner similar to that of processing at each of steps S511 to S514 in FIG. 33.

At step S575, the selection priority order information setting unit 701 determines the selection priority order of each Adaptation Set and sets the selection priority order information indicating the selection priority order. The selection priority order information setting unit 701 determines the selection priority order on the basis of arbitrary information such as various types of information of the MP4 file, instructions of the user and the like, for example.

At step S576, the file generation unit 527 generates an MPD file reflecting the various settings performed at steps S571 to S575. When the MPD file is generated, the MPD file generation processing is finished, and the procedure returns to FIG. 32.

By executing each processing as described above, the file generation device 501 may generate the MPD file having the extended attribute to which the present technology is applied. That is, the file generation device 501 may set the information regarding the switching to which the present technology is applied. As a result, it is possible to suppress the switching not intended by the distribution side and transmit the content data as intended by the distribution side. That is, the content data may be transmitted more stably.

<Reproduction Terminal>

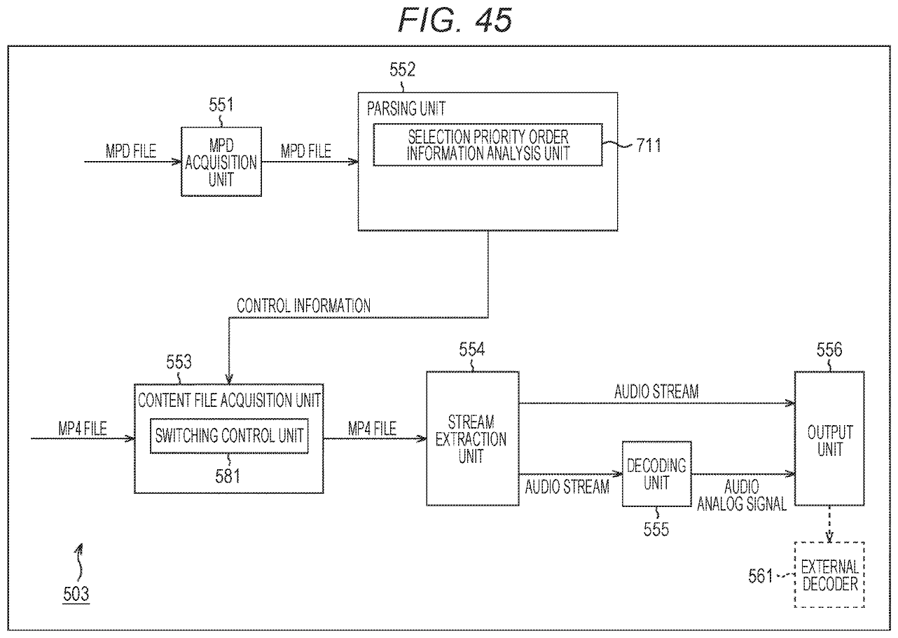

FIG. 45 illustrates a principal configuration example of the reproduction terminal 503 in this case. In this case also, the reproduction terminal 503 has a configuration basically similar to that in a case of the first embodiment (FIG. 34). However, in this case, the parsing unit 552 includes a selection priority order information analysis unit 711. The selection priority order information analysis unit 711 performs processing regarding analysis of the selection priority order information.

For example, the switching control unit 581 of the content file acquisition unit 553 controls the switching on the basis of an analysis result of the selection priority order information analysis unit 711 (on the basis of control information reflecting the analysis result of the selection order priority information analysis unit 711).

<Flow of Parsing Processing>

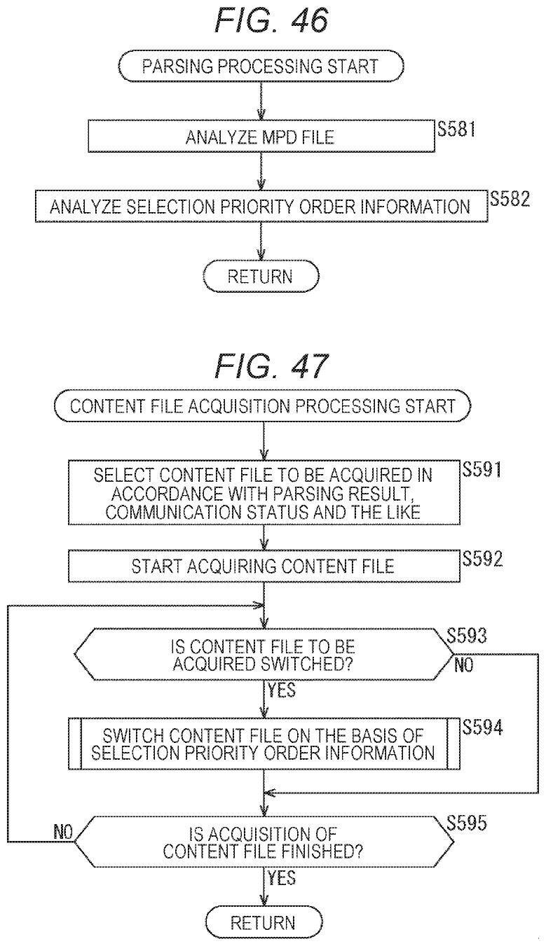

In this case also, the reproduction processing is executed in a manner similar to that in a case of the first embodiment (FIG. 35). An example of a flow of parsing processing in this case is described with reference to a flowchart in FIG. 46.

When the parsing processing is started, the parsing unit 552 analyzes the MPD file at step S581. At step S582, the selection priority order information analysis unit 711 analyzes the selection priority order information included in the MPD file.

When the processing at step S582 is finished, the parsing processing is finished, and the procedure returns to FIG. 35. As described above, the parsing unit 552 may analyze the MPD file and further analyze the extended attribute (@stabilityRanking and the like) to which the present technology is applied.

<Flow of Content File Acquisition Processing>

Next, with reference to a flowchart in FIG. 47, an example of a flow of content file acquisition processing in this case is described. In this case also, processing at each of steps S591 to S593 is executed in a manner similar to that of processing at each of steps S551 to S553 in FIG. 37.

At step S594, the switching control unit 581 executes switching processing and switches the content file (MP4 file) to be acquired on the basis of the selection priority order information. When the processing at step S594 is finished, the procedure shifts to step S595.

Processing at step S595 is executed in a manner similar to that of processing at step S556 in FIG. 37. That is, in a case where it is determined at step S595 that the acquisition of the MP4 file regarding the desired content is finished, the content file acquisition processing is finished.

<Flow of Switching Processing>

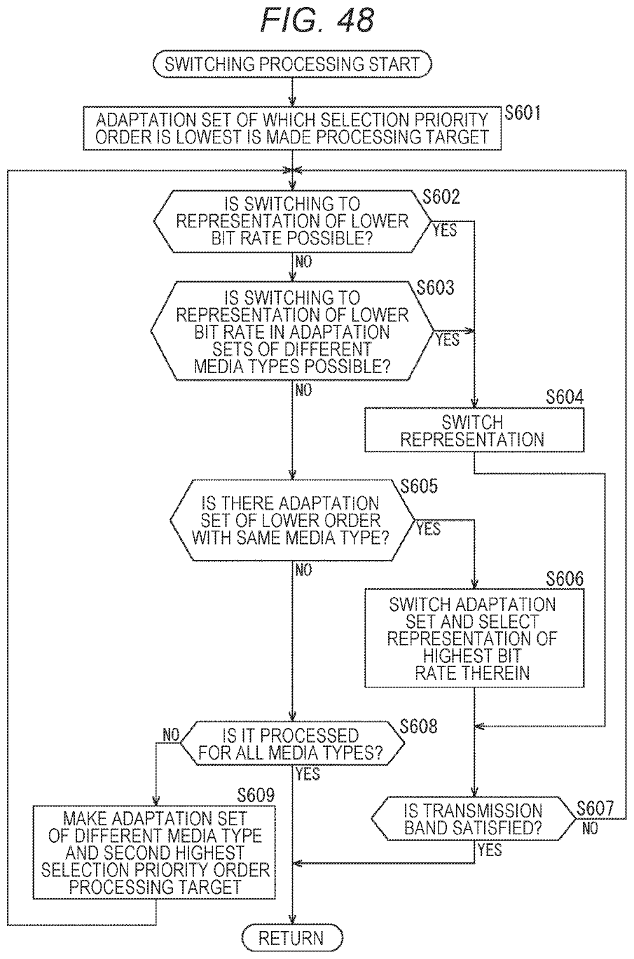

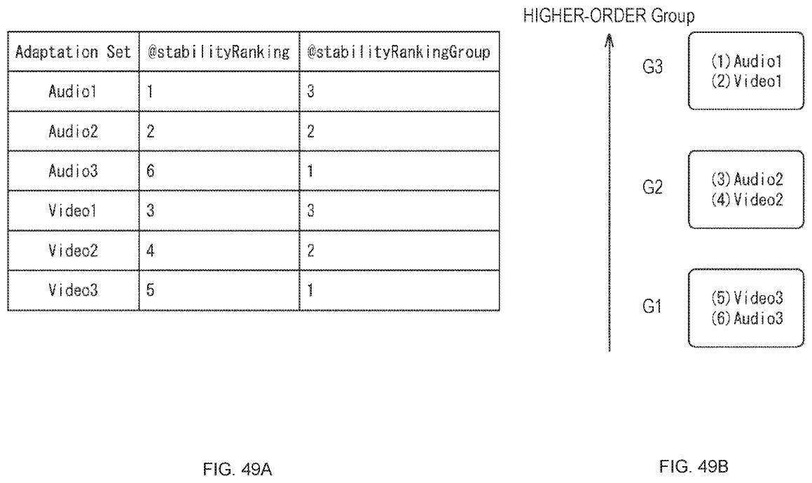

Next, an example of a flow of switching processing executed at step S594 in FIG. 47 is described with reference to a flowchart in FIG. 48.

When the switching processing is started, the switching control unit 581 makes the Adaptation Set of the lowest selection priority order a processing target at step S601.

At step S602, the switching control unit 581 determines whether or not it is possible to switch to Representation of a lower bit rate. In a case where it is determined that the switching is impossible, the procedure shifts to step S603.

At step S603, the switching control unit 581 determines whether or not it is possible to switch to Representation of a lower bit rate within Adaptation Sets of different media types. In a case where it is determined that the switching is possible, the procedure shifts to step S604. Meanwhile, in a case where there are three or more Adaptation Sets being selected/reproduced: for example, video, audio, subtitles and the like, and there are two or more Adaptation Sets which may be switched, it is switched from the Representation in the Adaptation Set of lower selection priority order.

Also, in a case where it is determined that the switching is possible at step S602, the procedure shifts to step S604. At step S604, the switching control unit 581 switches the Representation which may be switched. When the processing at step S604 is finished, the procedure shifts to step S607.

Also, in a case where it is determined that the switching is impossible at step S603, the procedure shifts to step S605. At step S605, the switching control unit 581 determines whether or not there is lower-order Adaptation Set of the same media type. In a case where it is determined to there is one, the procedure shifts to step S606.

At step S606, the switching control unit 581 switches the Adaptation Set and selects the Representation with the highest bit rate among them. When the processing at step S606 is finished, the procedure shifts to step S607.

At step S607, the switching control unit 581 determines whether or not the transmission band is satisfied in the state after the switching. In a case where it is determined that the transmission band is not sufficient, the procedure returns to step S602 and subsequent processing is repeated.

Also, in a case where it is determined at step S607 that the transmission band is satisfied, the switching processing is finished and the procedure returns to FIG. 47.

Also, in a case where it is determined at step S605 that there is no lower-order Adaptation Set of the same media type, the procedure shifts to step S608. At step S608, the switching control unit 581 determines whether or not processing is performed for all the media types. For example, in a case where it is determined that there is an unprocessed media type such that audio is not yet processed though video is processed, the procedure shifts to step S609.

At step S609, the switching control unit 581 makes the Adaptation Set of the different media type and having second highest selection priority order the processing target. When the processing at step S609 is finished, the procedure returns to step S602 and subsequent processing is repeated.

In a case where it is determined at step S608 that the processing is performed for all the media types, the switching processing is finished and the procedure returns to FIG. 47.

By executing each processing as described above, the reproduction terminal 503 may acquire the content file according to the MPD file having the extended attribute to which the present technology is applied. That is, the reproduction terminal 503 may perform the switching as intended by the distribution side in accordance with the MPD file. That is, it is possible to realize the transmission of the content data as intended by the distribution side, and realize more stable transmission of the content data.

### 4. Third Embodiment

<Setting of Switching Priority Group>

The information regarding the priority order of the Adaptation Sets described in the second embodiment may be hierarchized. For example, as information regarding priority order, information indicating priority order of a group of first management units may be further set. By hierarchizing the information regarding the priority order as described above, it is possible to control more various switching, and it is possible to further suppress switching not intended by a distribution side from being performed. As a result, content data may be transmitted as intended by the distribution side, and the content data may be transmitted more stably.

Meanwhile, the data to be reproduced may be the content data (audio stream), management information may be MPD of MPEG-DASH, and the first management unit may be Adaptation Set. By doing so, distribution using the MPEG-DASH may be performed more stably.

For example, an attribute @stabilityRankingGroup may be set as the information regarding the priority order. This attribute @stabilityRankingGroup is information indicating grouping of Adaptation Sets and the priority of the group from a viewpoint of switching. This attribute @stabilityRankingGroup may take a value of “0” or a positive integer. The larger the value of this attribute @stabilityRankingGroup, the more the distribution side assumes that this is the group of higher-quality Adaptation Sets.

Meanwhile, the value “0” has a special meaning and indicates that this is special Adaptation Set prepared for continuation of reproduction though this is not selected in general. The Adaptation Set in which the value of this attribute @stabilityRankingGroup is “0” belongs to a group of Adaptation Sets in which the value of this attribute @stabilityRankingGroup is “1”. That is, the fact that the value of the attribute @stabilityRankingGroup is “0” indicates that the Adaptation Set is the Adaptation Set having the special meaning within the group 1.

Also, the Adaptation Set in which the value of this attribute @stabilityRankingGroup is “0” indicates that the content should not be selected at the start of reproduction and during normal reproduction regardless of the value of the attribute @stabilityRanking described above. On the other hand, when the value of this attribute @stabilityRankingGroup is a value other than “0”, the value of the attribute @stabilityRanking is regarded as relative order within the group. In a case where this attribute @stabilityRankingGroup does not exist (is not set), grouping of Adaptation Sets is omitted. A player determines the priority of selection according to the attribute @stabilityRanking.

<Adding Example 1 of Attribute @stabilityRankingGroup>

A case of using both the attribute @stabilityRanking and attribute @stabilityRankingGroup is described.

As described above, the attribute @stabilityRankingGroup is the attribute that classifies and ranks the Adaptation Sets from the viewpoint of switching. For example, the distribution side intends that the Adaptation Set used for reproduction is selected from the Adaptation Sets having the same value of the attribute @stabilityRankingGroup (that is, the Adaptation Sets of the same group) for each Media Type such as video and audio. The larger the value of the attribute @stabilityRankingGroup, the higher priority to be selected the Adaptation Set has. The priority order in the group of the Adaptation Sets having the same value of the attribute @stabilityRankingGroup is determined by the attribute @stabilityRanking.

For example, assume that the value of the attribute @stabilityRanking of each Adaptation Set and the value of the attribute @stabilityRankingGroup are set as illustrated in a table in A of FIG. 49. In a case of the example in A of FIG. 49, there are three types of values of the attribute @stabilityRankingGroup: “1” to “3”. That is, as illustrated in B of FIG. 49, each Adaptation Set is divided into three groups: group G1, group G2, and group G3. Since the higher the value of the attribute @stabilityRankingGroup is, the higher the priority, in this case, the priority of the Adaptation Set of the group G3 is the highest, and the priority of the Adaptation Set of the group G1 is the lowest.

The attribute @stabilityRanking is to arrange all the Adaptation Sets in line to rank tolerance of switching thereof, but the attribute @stabiltyRankingGroup is to set a delimiter in this sequential order. With such attribute, it is possible to realize switching reflecting intention of the distribution side more by notifying the player of a set of Adaptation Sets suitable to be simultaneously reproduced.

### Adding Example 2 of Attribute @stabilityRankingGroup

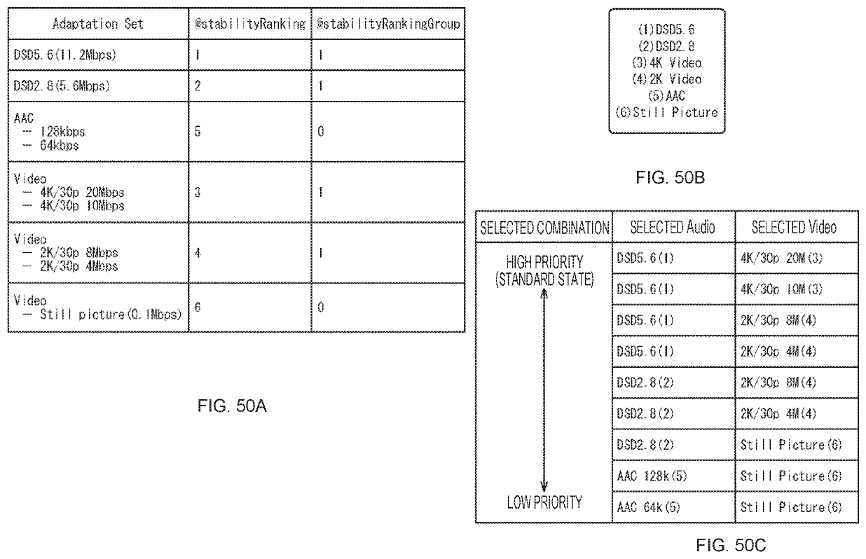

Another example of adding the attribute @stabilityRanking and attribute @stabilityRankingGroup is described. For example, assume that the value of the attribute @stabilityRanking and the value of the attribute @stabilityRankingGroup are set as illustrated in a table in A of FIG. 50. In this case, two values of “0” and “1” are used as the value of the attribute @stabilityRankingGroup. Therefore, all the Adaptation Sets belong to one group G1 as illustrated in B of FIG. 50. However, the value “0” is set to the attribute @stabilityRankingGroup of the Adaptation Set of AAC and the Adaptation Set of Still Picture.

By setting the attribute @stabilityRanking and the attribute @stabilityRankingGroup of such value in each Adaptation Set and using the same for switching control, the player may select each data in the priority order as illustrated in a table in C of FIG. 50. Meanwhile, in the table in C of FIG. 50, the number in parentheses indicates the value of the attribute @stabilityRanking of the Adaptation Set.

As described above, since the value of the attribute @stabilityRankingGroup of the Adaptation Set of Still Picture is “0”, in this case, as illustrated in the table in C of FIG. 50, audio data of is switched instead of switching to Still Picture while audio data of DSD 5.6 or DSD 2.8 is selected.

### Adding Example 3 of Attribute @stabilityRankingGroup

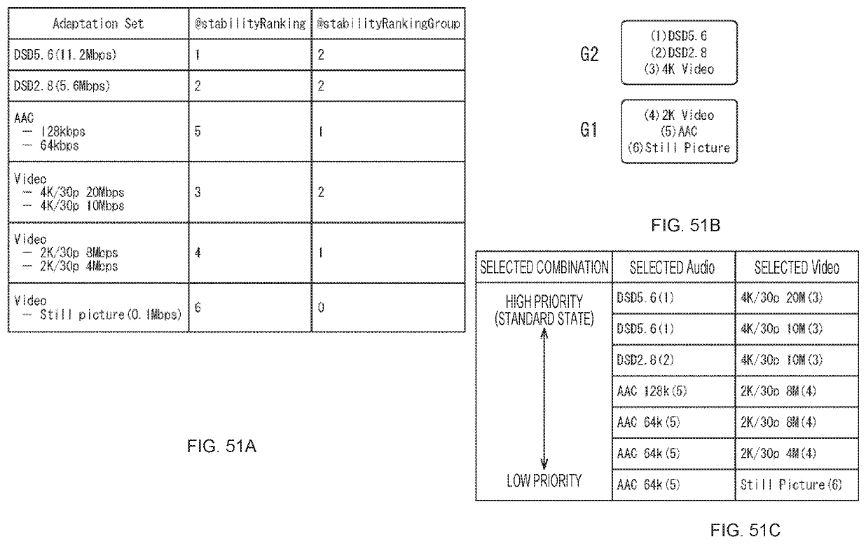

Also, for example, assume that the value of the attribute @stabilityRanking and the value of the attribute @stabilityRankingGroup are set as illustrated in a table in A of FIG. 51. In this case, three values of “0”, “1”, and “2” are used as the value of the attribute @stabilityRankingGroup. Therefore, the Adaptation Sets are divided into the group G1 and the group G2 as illustrated in B of FIG. 51. However, the value of the attribute @stabilityRankingGroup of the Adaptation Set of Still Picture is “0”.

By setting the attribute @stabilityRanking and the attribute @stabilityRankingGroup of such value in each Adaptation Set and using the same for switching control, the player may select each data in the priority order as illustrated in a table in C of FIG. 51. Meanwhile, in the table in C of FIG. 51, the number in parentheses indicates the value of the attribute @stabilityRanking of the Adaptation Set.

In this case, as illustrated in C of FIG. 51, the Adaptation Set belonging to the group G2 is preferentially selected.

### Adding Example 4 of Attribute @stabilityRankingGroup

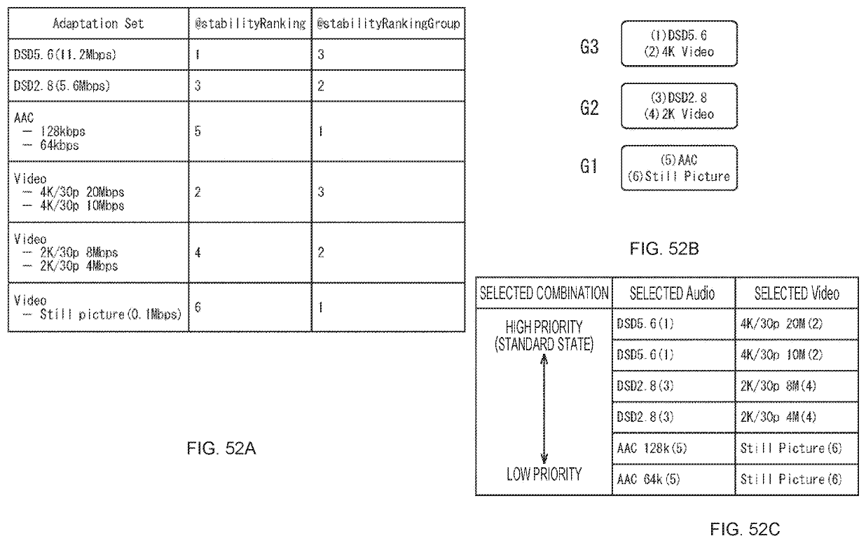

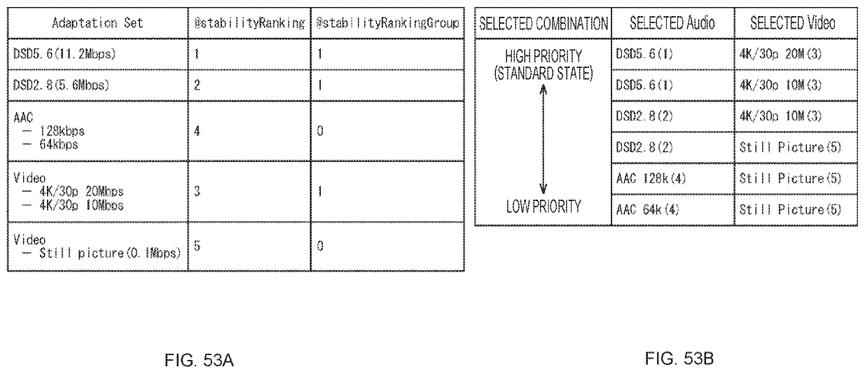

Also, for example, assume that the value of the attribute @stabilityRanking and the value of the attribute @stabilityRankingGroup are set as illustrated in a table in A of FIG. 52. In this case, three values of “1”, “2”, and “3” are used as the value of the attribute @stabilityRankingGroup. Therefore, the Adaptation Sets are divided into the group G1, the group G2, and the group G3 as illustrated in B of FIG. 52. In this case, as illustrated in C of FIG. 52, the Adaptation Set belonging to the group G3 is preferentially selected.

### Adding Example 5 of Attribute @stabilityRankingGroup

Also, for example, assume that the value of the attribute @stabilityRanking and the value of the attribute @stabilityRankingGroup are set as in a table illustrated in A of FIG. 53 for each Adaptation Set of the MPD having a Period configuration as illustrated in A of FIG. 39. In this case, two values of “0” and “1” are used as the value of the attribute @stabilityRankingGroup.

By setting the attribute @stabilityRanking and the attribute @stabilityRankingGroup of such value in each Adaptation Set and using the same for switching control, the player may select each data in the priority order as illustrated in a table in B of FIG. 53. Meanwhile, in the table in B of FIG. 53, the number in parentheses indicates the value of the attribute @stabilityRanking of the Adaptation Set.

In a case of the example in FIG. 53, the value of the attribute @stabilityRankingGroup of the Adaptation Set of AAC of the audio data is set to “0”, and the value of the attribute @stabilityRankingGroup of the Adaptation Set of Still Picture of the video data is set to “0”. In this manner, by clearly indicating a final evacuation Adaptation Set (fail-safe Adaptation Set which should not be selected as much as possible) for each media type such as video and audio, it is possible to suppress selection of a combination which is undesirable for the distribution side because of too large difference in quality between audio and video such as DSD5.6+Still Picture, for example, and it is possible to realize more balanced switching.

Of course, the values of the attribute @stabilityRanking and the attribute @stabilityRankingGroup described above are examples, and the values of the attribute @stabilityRanking and the attribute @stabilityRankingGroup are not limited to these examples.

<File Generation Device>

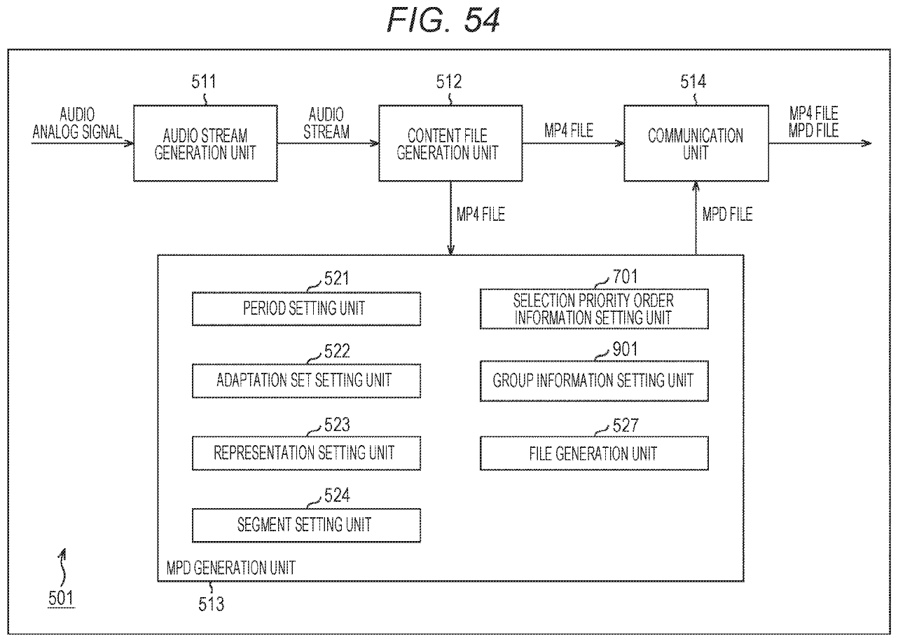

A principal configuration example of the file generation device 501 in this case is illustrated in FIG. 54. In this case also, the file generation device 501 has a configuration basically similar to that in a case of the second embodiment (FIG. 43). However, in this case, the MPD generation unit 513 further includes a group information setting unit 901.

The group information setting unit 901 performs processing regarding setting of group information. This group information is information for grouping Adaptation Sets regarding the selection priority order and indicating the priority order of the group, and includes, for example, the extended attribute @stabilityRankingGroup and the like to which the present technology is applied.

<Flow of MPD File Generation Processing>

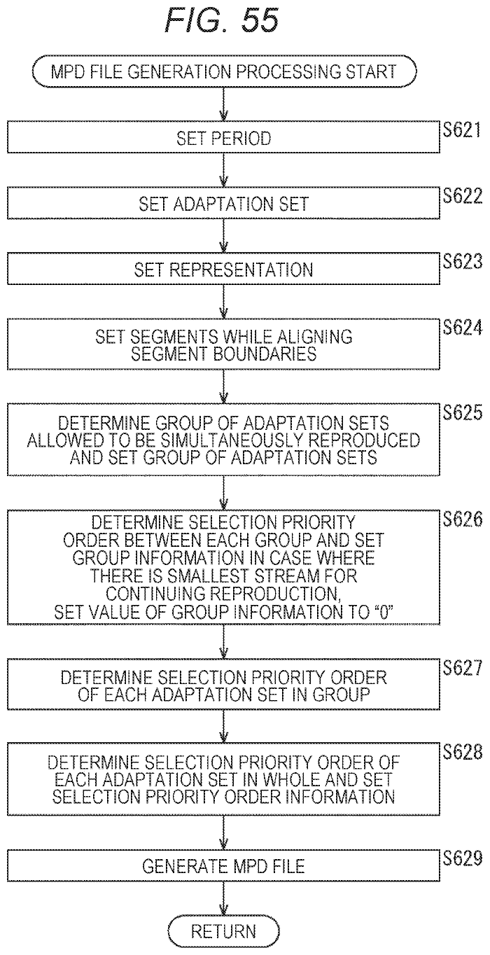

In this case also, the distribution data generation processing is executed in the manner similar to that in a case of the first embodiment (FIG. 32). An example of a flow of the MPD file generation processing in this case is described with reference to a flowchart in FIG. 55.

In this case also, processing at each of steps S621 to S624 is executed in a manner similar to that of processing at each of steps S511 to S514 in FIG. 33.

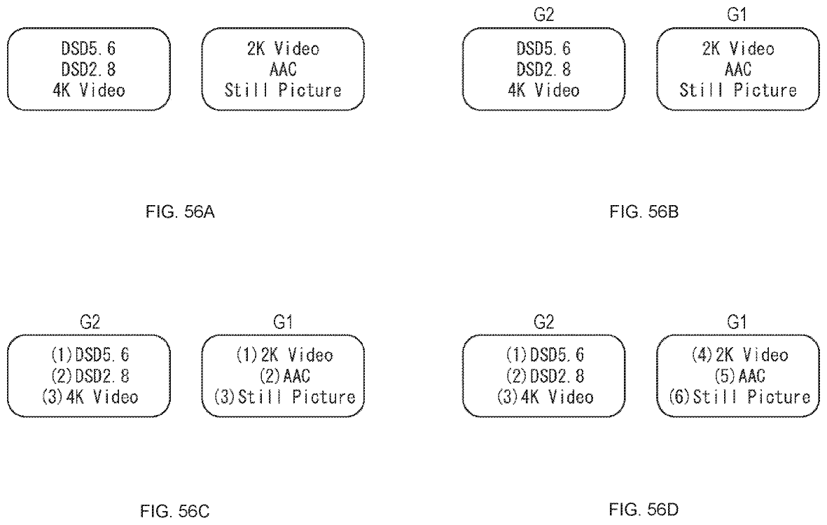

At step S625, the group information setting unit 901 determines a group of Adaptation Sets allowed to be simultaneously reproduced, and sets the group of Adaptation Sets. By this processing, for example, as illustrated in A of FIG. 56, each Adaptation Set is classified into two groups.

At step S626, the group information setting unit 901 determines the selection priority order among the groups, and in a case where there is a smallest stream for continuing the reproduction to set the group information, sets the value of the group information to “0”. By this processing, for example, as illustrated in B of FIG. 56, the selection priority order such as “G1” and “G2” is added to each group. Also, for example, the value of the attribute @stabilityRankingGroup of the Adaptation Set of Still Picture is set to “0”.

At step S627, the group information setting unit 901 determines the selection priority order of each Adaptation Set in the group. By this processing, for example, as illustrated in C of FIG. 56, the selection priority order of each Adaptation Set is set within each group. In C of FIG. 56, the number in parentheses indicates the priority order within the group allocated to each Adaptation Set.

At step S628, the selection priority order information setting unit 701 determines the selection priority order of each Adaptation Set in the whole and sets the selection priority order information. By this processing, for example, as illustrated in D of FIG. 56, the selection priority order of each Adaptation Set is set. In D of FIG. 56, the number in parentheses indicates the selection priority order allocated to each Adaptation Set.

At step S629, the file generation unit 527 generates the MPD file reflecting the various settings performed at steps S621 to S628. When the MPD file is generated, the MPD file generation processing is finished, and the procedure returns to FIG. 32.

By executing each processing as described above, the file generation device 501 may generate the MPD file having the extended attribute to which the present technology is applied. That is, the file generation device 501 may set the information regarding the selection priority order and the information regarding the group to which the present technology is applied. As a result, it is possible to realize more balanced switching according to the intention of the distribution side.

<Reproduction Terminal>

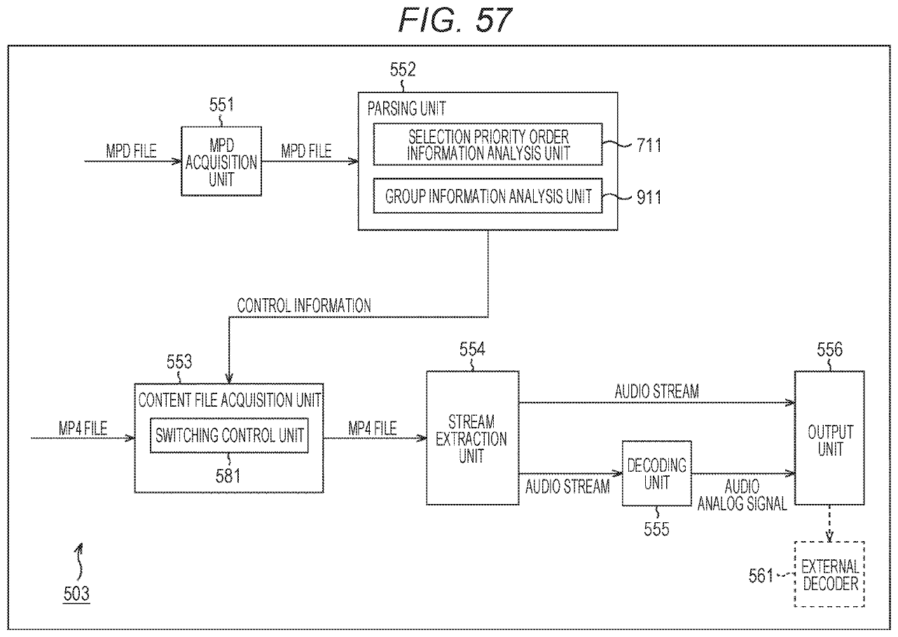

FIG. 57 illustrates a principal configuration example of the reproduction terminal 503 in this case. In this case also, the reproduction terminal 503 has a configuration basically similar to that in a case of the second embodiment (FIG. 45). However, in this case, a parsing unit 552 further includes a group information analysis unit 911. The group information analysis unit 911 performs processing regarding analysis of group information.

For example, a switching control unit 581 of a content file acquisition unit 553 controls this switching on the basis of an analysis result of the group information analysis unit 911 (on the basis of control information reflecting the analysis result of the group information analysis unit 911).

<Flow of Parsing Processing>

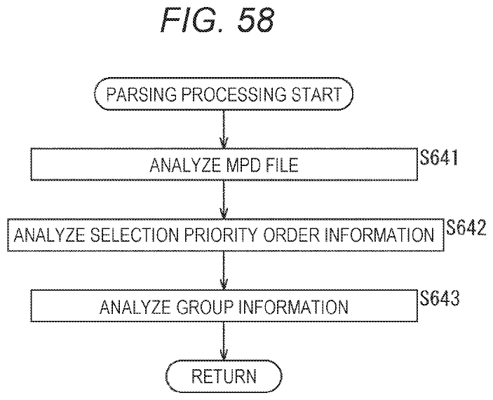

In this case also, the reproduction processing is executed in a manner similar to that in a case of the first embodiment (FIG. 35). An example of a flow of parsing processing in this case is described with reference to a flowchart in FIG. 58.

When the parsing processing is started, the parsing unit 552 analyzes the MPD file at step S641. At step S642, the selection priority order information analysis unit 711 analyzes the selection priority order information included in the MPD file. At step S643, the group information analysis unit 911 analyzes the group information included in the MPD file.

When the processing at step S643 is finished, the parsing processing is finished, and the procedure returns to FIG. 35. As described above, the parsing unit 552 may analyze the MPD file and further analyze the extended attribute (@stabilityRanking, @stabilityRankingGroup and the like) to which the present technology is applied.

<Flow of Content File Acquisition Processing>

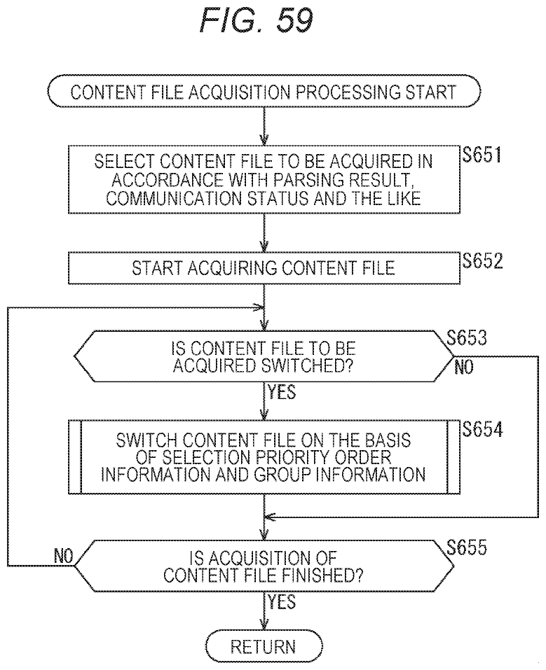

Next, with reference to a flowchart in FIG. 59, an example of a flow of content file acquisition processing in this case is described. In this case also, processing at each of steps S651 to S653 is executed in a manner similar to that of processing at each of steps S591 to S593 in FIG. 47.

At step S654, the switching control unit 581 executes the switching processing and switches the content file (MP4 file) to be acquired on the basis of the selection priority order information and the group information. When the processing at step S654 is finished, the procedure shifts to step S655.

Processing at step S655 is executed in a manner similar to that of processing at step S595 in FIG. 47. That is, in a case where it is determined at step S655 that the acquisition of the MP4 file regarding the desired content is finished, the content file acquisition processing is finished.

<Flow of Switching Processing>

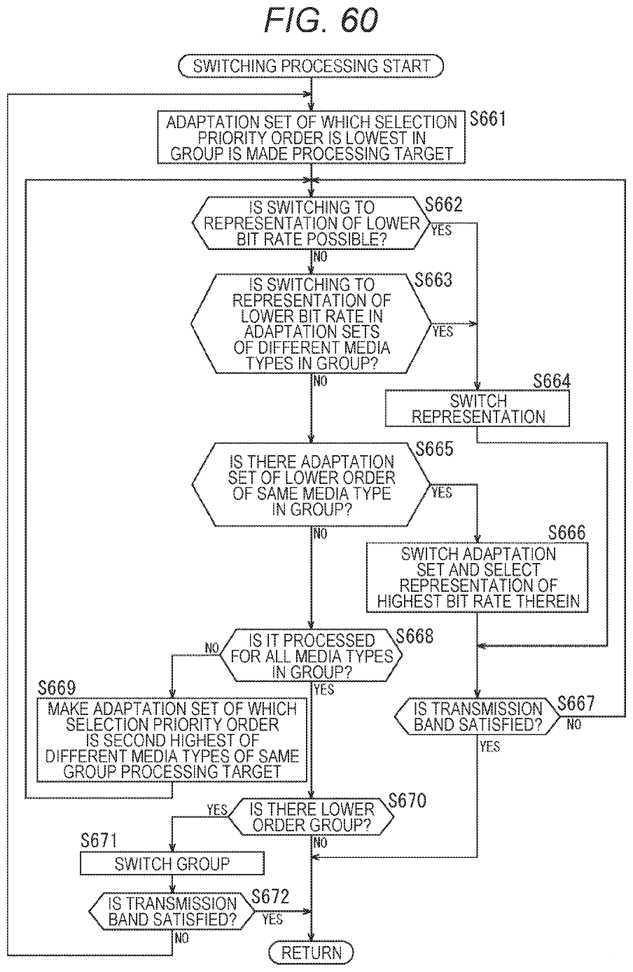

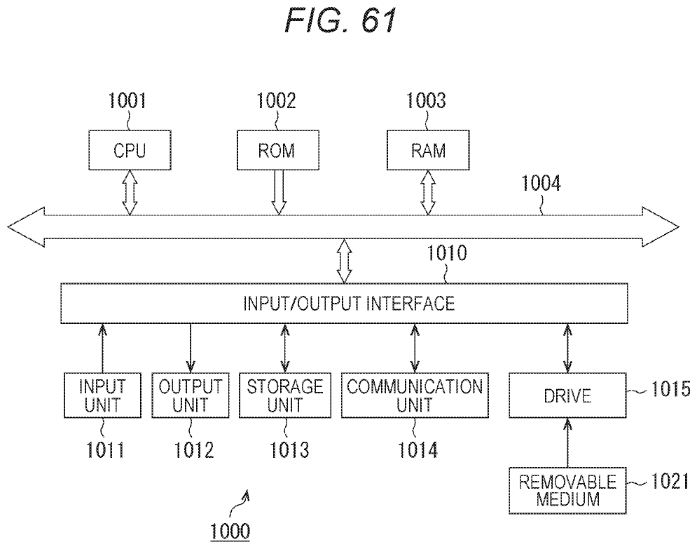

Next, an example of a flow of switching processing executed at step S654 in FIG. 59 is described with reference to a flowchart in FIG. 60.

When the switching processing is started, the switching control unit 581 makes the Adaptation Set of the lowest selection priority order in the group a processing target at step S661.

At step S662, the switching control unit 581 determines whether or not it is possible to switch to Representation of a lower bit rate. In a case where it is determined that the switching is impossible, the procedure shifts to step S663.

At step S663, the switching control unit 581 determines whether or not it is possible to switch to Representation of a lower bit rate within Adaptation Sets of different media types in the group. In a case where it is determined that the switching is possible, the procedure shifts to step S664.

Meanwhile, in a case where there are three or more Adaptation Sets being selected/reproduced in the group: for example, video, audio, subtitles and the like, and there are two or more Adaptation Sets which may be switched, it is switched from the Representation in the Adaptation Set of lower selection priority order.

Also, in a case where it is determined that the switching is possible at step S662, the procedure shifts to step S664. At step S664, the switching control unit 581 switches the Representation which may be switched. When the processing at step S664 is finished, the procedure shifts to step S667.

Also, in a case where it is determined that the switching is impossible at step S663, the procedure shifts to step S665. At step S665, the switching control unit 581 determines whether or not there is lower-order Adaptation Set of the same media type in the group. In a case where it is determined to there is one, the procedure shifts to step S666.

At step S666, the switching control unit 581 switches the Adaptation Set and selects the Representation of the highest bit rate among them. When the processing at step S666 is finished, the procedure shifts to step S667.

At step S667, the switching control unit 581 determines whether or not a transmission band is satisfied in a state after the switching. In a case where it is determined that the transmission band is not sufficient, the procedure returns to step S662 and subsequent processing is repeated.

Also, in a case where it is determined at step S667 that the transmission band is satisfied, the switching processing is finished and the procedure returns to FIG. 59.

Also, in a case where it is determined at step S665 that there is no lower-order Adaptation Set of the same media type, the procedure shifts to step S668. At step S668, the switching control unit 581 determines whether or not processing is performed for all the media types in the group. For example, in a case where it is determined that there is an unprocessed media type such that audio is not yet processed though video is processed, the procedure shifts to step S669.

At step S669, the switching control unit 581 makes the Adaptation Set of the different media type and having the second highest selection priority order in the same group the processing target. When the processing at step S669 is finished, the procedure returns to step S662, and the subsequent processing is repeated.

In a case where it is determined at step S668 that the processing is performed for all the media types, the procedure shifts to step S670. At step S670, the switching control unit 581 determines whether or not there is a lower-order group. In a case where it is determined to there is one, the procedure shifts to step S671.

At step S671, the switching control unit 581 switches the group. For each media type, the highest-order Adaptation Set is selected. Furthermore, among each Adaptation Set, the Representation of the highest bit rate is selected.

At step S672, the switching control unit 581 determines whether or not the transmission band is satisfied in the state after the switching. In a case where it is determined that the transmission band is not sufficient, the procedure returns to step S661 and subsequent processing is repeated.

At step S670, in a case where it is determined that there is no lower-order group, the switching processing is finished and the procedure returns to FIG. 59. Also, in a case where it is determined at step S672 that the transmission band is satisfied, the switching processing is finished and the procedure returns to FIG. 59.

By executing each processing as described above, the reproduction terminal 503 may acquire the content file according to the MPD file having the extended attribute to which the present technology is applied. That is, according to the MPD file, the reproduction terminal 503 may realize more balanced switching according to the intention of the distribution side.

### 5. Others

<Standards>

In the above description, the case where the DSD lossless stream is stored in the MP4 file and distributed using the MPEG-DASH is described, but the present technology is also applicable to other examples. For example, the present technology is also applicable to arbitrary data other than the DSD lossless stream.

Also, the present technology is also applicable to the case of storing in an arbitrary file format other than the MP4 file. Furthermore, the present technology is also applicable to data distribution of any standard other than the MPEG-DASH.

<Application Field of Present Technology>

The system, device, processing unit and the like to which the present technology is applied may be used in arbitrary fields such as traffic, medical care, crime prevention, agriculture, livestock industry, mining, beauty care, factory, household appliance, weather, and natural surveillance, for example.

For example, the present technology is also applicable to a system and a device that transmits an image provided for viewing. Also, for example, the present technology is also applicable to a system and a device provided for traffic. Furthermore, for example, the present technology is also applicable to a system and a device used for security. Also, for example, the present technology is also applicable to a system or a device provided for sports. Furthermore, for example, the present technology is also applicable to a system or a device provided for agriculture. Also, for example, the present technology is also applicable to a system or a device provided for livestock industry. Furthermore, the present technology is also applicable to a system or device that monitor natural conditions such as volcanoes, forests, oceans, and the like. Also, the present technology is also applicable to weather observation systems and weather observation devices that observe weather, temperature, humidity, wind speed, sunshine time and the like, for example.

Furthermore, the present technology is also applicable to a system, a device and the like for observing ecology of wildlife such as birds, fish, reptiles, amphibians, mammals, insects, plants and the like.

<Computer>

It is possible that the above-described series of processes is executed by hardware or executed by software. When a series of processes is performed by the software, a program which forms the software is installed on a computer. Herein, the computer includes a computer built in dedicated hardware, a general-purpose personal computer, for example, capable of executing various functions by various programs installed and the like.

FIG. 61 is a block diagram illustrating a configuration example of hardware of a computer which executes the above-described series of processes by a program.

In a computer 1000 illustrated in FIG. 61, a central processing unit (CPU) 1001, a read only memory (ROM) 1002, and a random access memory (RAM) 1003 are connected to one another through a bus 1004.

An input/output interface 1010 is also connected to the bus 1004. An input unit 1011, an output unit 1012, a storage unit 1013, a communication unit 1014, and a drive 1015 are connected to the input/output interface 1010.

The input unit 1011 includes, for example, a keyboard, a mouse, a microphone, a touch panel, an input terminal and the like. The output unit 1012 includes, for example, a display, a speaker, an output terminal and the like. The storage unit 1013 includes, for example, a hard disk, a RAM disk, a nonvolatile memory and the like. The communication unit 1014 includes a network interface and the like. The drive 1015 drives a removable medium 1021 such as a magnetic disk, an optical disk, a magnetooptical disk, and a semiconductor memory.

In the computer 1000 configured in the above-described manner, the CPU 1001 loads the program stored in the storage unit 1013, for example, on the RAM 1003 through the input/output interface 1010 and the bus 1004 to execute, and thus, the above-described series of processes is performed. Data required for the CPU 1001 to execute the various processes or the like are appropriately stored in the RAM 1003.

The program executed by the computer 1000 may be recorded in the removable medium 1021 as a package medium and the like to be applied, for example. In this case, the program may be installed on the storage unit 1013 through the input/output interface 1010 by mounting the removable medium 1021 on the drive 1015.

The program may also be provided through a wired or wireless transmission medium such as a local area network, the Internet, and digital satellite broadcasting. In this case, the program may be received by the communication unit 1014 to be installed on the storage unit 1013.

In addition, the program may be installed in advance on the ROM 1002, the storage unit 1013 and the like.

<Others>

Meanwhile, various types of information regarding the encoded data (bit stream) may be multiplexed to the encoded data and transmitted or recorded, or may be transmitted or recorded as another data associated with the encoded data without being multiplexed to the encoded data. Herein, the term “associate” is intended to mean to make the other data available (linkable), for example, when processing one data. That is, the data associated with each other may be collected as one data or may be individual data. For example, information associated with the encoded data (image) may be transmitted on a transmission path different from that of the encoded data (image). Also, for example, the information associated with the encoded data (image) may be recorded in a recording medium (or another recording area of the same recording medium) different from the encoded data (image). Meanwhile, this “association” may be not the entire data but a part of data. For example, an image and information corresponding to the image may be associated with each other in arbitrary units such as a plurality of frames, one frame, or a part within a frame.

Also, as described above, in this specification, the terms “synthesize”, “multiplex”, “add”, “integrate”, “include”, “store”, “put”, “stick, “insert” and the like mean combining a plurality of objects into one, for example, such as combining encoded data and metadata into one data, and mean one method of “associating” described above.

Also, the embodiment of the present technology is not limited to the above-described embodiments and various modifications may be made without departing from the scope of the present technology.

Also, in this specification, a system is intended to mean assembly of a plurality of components (devices, modules (parts) and the like), for example, and it does not matter whether or not all the components are in the same casing. Therefore, a plurality of devices stored in different casings connected through the network and one device realized by storing a plurality of modules in one casing are the systems.

It is also possible to divide the configuration described as one device (or processing unit) into a plurality of devices (or processing units), for example. Other way round, it is also possible to put the configurations described above as a plurality of devices (or processing units) together as one device (or processing unit). Also, of course, it is possible that a configuration other than the above-described one is added to the configuration of each device (or each processing unit). Furthermore, it is also possible that a part of the configuration of a certain device (or processing unit) is included in the configuration of another device (or another processing unit) as long as a configuration and operation as an entire system are substantially the same.

Also, for example, the present technology may be configured as cloud computing in which one function is shared by a plurality of devices through a network for processing in cooperation.

Also, for example, the above-described program may be executed by an arbitrary device. In that case, the device may have necessary functions (function blocks and the like) so that necessary information may be acquired.

Also, for example, each step described in the above-described flowchart may be executed by one device or executed by a plurality of devices in a shared manner. Furthermore, in a case where a plurality of processes is included in one step, a plurality of processes included in one step may be executed by one device or by a plurality of devices in a shared manner.

Meanwhile, the program executed by the computer may be such that processes at steps of describing the program are executed in chronological order in the order described in this specification or that the processes are executed in parallel or individually executed at required timing such as when a call is issued. That is, as long as there is no inconsistency, the processes at respective steps may be executed in order different from the order described above. Furthermore, the process at the step of describing this program may be executed in parallel with the process of another program, or may be executed in combination with the process of another program.

Meanwhile, as long as there is no inconsistency, each of a plurality of technologies described in this specification may be independently implemented as a single unit. Of course, it is also possible to implement by combining arbitrary plural technologies. For example, the present technology described in any of the embodiments may be implemented in combination with the present technology described in other embodiments. Also, the arbitrary technology described above may be implemented in combination with other technologies not described above.

Meanwhile, the present technology may also have following configurations.

(1) An information processing device provided with:

a setting unit which sets information regarding switching across first management units for managing a data group of same content of data to be reproduced in management information for managing reproduction of data of the content.

(2) The information processing device according to (1),

in which the management information is Media Presentation Description (MPD), and

a first management unit is Adaptation Set.

(3) The information processing device according to (1) or (2),

in which the information regarding the switching is information regarding a switching destination of the switching across the first management units of the data to be reproduced.

(4) The information processing device according to any one of (1) to (3),

in which the information regarding the switching destination is ContentSwitchingDestinationId.

(5) The information processing device according to any one of (1) to (4),

in which the information regarding the switching destination is information for designating a management unit allowed as the switching destination.

(6) The information processing device according to any one of (1) to (5),

in which the information for designating the management unit is information for designating another first management unit allowed as the switching destination.

(7) The information processing device according to any one of (1) to (6),

in which the management information is Media Presentation Description (MPD), and

the first management unit is Adaptation Set.

(8) The information processing device according to any one of (1) to (7),

in which the information for designating the management unit is information for designating a second management unit for managing each data in the other first management unit allowed as the switching destination.

(9) The information processing device according to any one of (1) to (8),

in which the management information is Media Presentation Description (MPD),

the first management unit is Adaptation Set, and

the second management unit is Representation.

(10) The information processing device according to any one of (1) to (9),

in which the setting unit sets the information regarding the switching destination in the first management unit of the management information.

(11) The information processing device according to any one of (1) to (10),

in which the management information is Media Presentation Description (MPD),

the first management unit is Adaptation Set, and

the setting unit is configured to set the information regarding the switching destination in the Adaptation Set which manages data to be currently reproduced.

(12) The information processing device according to any one of (1) to (11),

in which the setting unit sets the information regarding the switching destination in the second management unit which manages each data in the first management unit of the management information.

(13) The information processing device according to any one of (1) to (12),

in which the management information is Media Presentation Description (MPD),

the first management unit is Adaptation Set,

the second management unit is Representation, and

the setting unit is configured to set the information regarding the switching destination in the Representation which manages the data to be currently reproduced.

(14) The information processing device according to any one of (1) to (13),

in which the information regarding the switching is information regarding timing of the switching across the first management units of the data to be reproduced.

(15) The information processing device according to any one of (1) to (14),

in which the information regarding the timing is information for designating the timing at which the switching across the first management units of the data to be reproduced is allowed.

(16) The information processing device according to any one of (1) to (15),

in which the timing is a boundary of the second management unit which is a management unit in a reproduction time direction of the data, and

the information for designating the timing is information for designating the boundary of the second management unit at which the switching across the first management units of the data to be reproduced is allowed.

(17) The information processing device according to any one of (1) to (16),

in which the information for designating the timing is information for designating the timing by the number of the second management units until next timing.

(18) The information processing device according to any one of (1) to (17),

in which the management information is Media Presentation Description (MPD),

the first management unit is Adaptation Set, and

the second management unit is Segment.

(19) The information processing device according to any one of (1) to (18),

in which reproduction time coincides between switching source data and switching destination data at the timing.

(20) The information processing device according to any one of (1) to (19),

in which the information regarding the timing is Content SwitchingAlignmentCycle.

(21) The information processing device according to any one of (1) to (20),

in which the setting unit sets the information regarding the timing in the first management unit of the management information.

(22) The information processing device according to any one of (1) to (21),

in which the management information is Media Presentation Description (MPD),

the first management unit is Adaptation Set, and

the setting unit is configured to set the information regarding the timing in the Adaptation Set which manages the data to be currently reproduced.

(23) The information processing device according to any one of (1) to (22),

in which the setting unit sets the information regarding the timing in the second management unit which manages each data in the first management unit of the management information.

(24) The information processing device according to any one of (1) to (23),

in which the management information is Media Presentation Description (MPD),

the first management unit is Adaptation Set,

the second management unit is Representation, and

the setting unit is configured to set the information regarding the timing in the Representation which manages the data to be currently reproduced.

(25) The information processing device according to any one of (1) to (24),

in which the information regarding the switching is information regarding priority order of the switching across the first management units of the data to be reproduced.

(26) The information processing device according to any one of (1) to (25),

in which the information regarding the priority order is information indicating priority order of the first management unit.

(27) The information processing device according to any one of (1) to (26),

in which the management information is Media Presentation Description (MPD), and

the first management unit is Adaptation Set.

(28) The information processing device according to any one of (1) to (27),

in which the information regarding the priority order is @stabilityRanking.

(29) The information processing device according to any one of (1) to (28),

in which the information regarding the priority order is information indicating priority order of a group of the first management units.

(30) The information processing device according to any one of (1) to (29),

in which the management information is Media Presentation Description (MPD), and

the first management unit is Adaptation Set.

(31) The information processing device according to any one of (1) to (30),

in which the information regarding the priority order is @stabilityRankingGroup.

(32) The information processing device according to any one of (1) to (31),

in which the setting unit sets the information regarding the priority order in the first management unit.

(33) The information processing device according to any one of (1) to (32),

in which the management information is Media Presentation Description (MPD), and

the first management unit is Adaptation Set.

(34) The information processing device according to any one of (1) to (33),

in which the data is a file of a file format compliant with ISO/IEC 14496 which stores a DSD lossless stream acquired by lossless encoding of direct stream digital (DSD) data acquired by performing ΔΣ modulation on an audio analog signal.

(35) The information processing device according to any one of (1) to (34), further provided with:

a file generation unit which generates a file of the management information on the basis of setting of the setting unit.

(36) The information processing device according to any one of (1) to (35), further provided with:

a data generation unit which generates the data,

in which the file generation unit is configured to generate the file of the management information of data generated by the data generation unit.

(37) The information processing device according to any one of (1) to (36), further provided with:

a transmission unit which transmits the file generated by the file generation unit to a server.

(38) An information processing method provided with:

setting information regarding switching across first management units for managing a data group of same content of data to be reproduced in management information for managing reproduction of data of the content.

(39) An information processing device provided with:

an analysis unit which analyzes information regarding switching across first management units for managing a data group of same content of data to be reproduced included in management information for managing reproduction of data of the content; and

a control unit which controls the switching of the data to be reproduced on the basis of an analysis result of the analysis unit.

(40) An information processing method provided with:

analyzing information regarding switching across first management units for managing a data group of same content of data to be reproduced included in management information for managing reproduction of data of the content; and

controlling the switching of the data to be reproduced on the basis of an analysis result.

### REFERENCE SIGNS LIST

500 Distribution system
501 File generation device
502 Distribution server
503 Reproduction terminal
504 Network
511 Audio stream generation unit
512 Content file generation unit
513 MPD generation unit
514 Communication unit
521 Period setting unit
522 Adaptation Set setting unit
523 Representation setting unit
524 Segment setting unit
525 Switching destination designation information setting unit
526 Timing designation information setting unit
527 File generation unit
551 MPD acquisition unit
552 Parsing unit
553 Content file acquisition unit
554 Stream extraction unit
555 Decoding unit
556 Output unit
561 External decoder
571 Switching destination designation information analysis unit
572 Timing designation information analysis unit
581 Switching control unit
701 Selection priority order information setting unit
711 Selection priority order information analysis unit
901 Group information setting unit
911 Group information analysis unit
1000 Computer

1. An information processing device comprising:
a setting unit which sets information regarding switching across first management units for managing a data group of same content of data to be reproduced in management information for managing reproduction of data of the content.

2. The information processing device according to claim 1,
wherein the information regarding the switching is information for designating a management unit allowed as a switching destination of the switching across the first management units of the data to be reproduced.

3. The information processing device according to claim 2,
wherein the information for designating the management unit is information for designating another first management unit allowed as the switching destination or information for designating a second management unit for managing each data in the other first management unit.

4. The information processing device according to claim 2,
wherein the setting unit sets the information for designating the management unit in a first management unit of the management information or a second management unit for managing each data in the first management unit of the management information.

5. The information processing device according to claim 1,
wherein the information regarding the switching is information for designating timing at which the switching across the first management units of the data to be reproduced is allowed.

6. The information processing device according to claim 5,
wherein the timing is a boundary of a second management unit which is a management unit in a reproduction time direction of the data, and
the information for designating the timing is information for designating the boundary of the second management unit at which the switching across the first management units of the data to be reproduced is allowed.

7. The information processing device according to claim 6,
wherein the information for designating the timing is information for designating the timing by the number of second management units until next timing.

8. The information processing device according to claim 5,
wherein reproduction time coincides between switching source data and switching destination data at the timing.

9. The information processing device according to claim 5,
wherein the setting unit sets the information for designating the timing in a first management unit of the management information or a second management unit for managing each data in the first management unit of the management information.

10. The information processing device according to claim 1,
wherein the information regarding the switching is information regarding priority order of the switching across the first management units of the data to be reproduced.

11. The information processing device according to claim 10,
wherein the information regarding the priority order is information indicating priority order of a first management unit.

12. The information processing device according to claim 10,
wherein the information regarding the priority order is information indicating priority order of a group of the first management units.

13. The information processing device according to claim 10,
wherein the setting unit sets the information regarding the priority order in a first management unit.

14. The information processing device according to claim 1,
wherein the data is a file of a file format compliant with ISO/IEC 14496 which stores a DSD lossless stream acquired by lossless encoding of direct stream digital (DSD) data acquired by performing ΔΣ modulation on an audio analog signal.

15. The information processing device according to claim 1, further comprising:
a file generation unit which generates a file of the management information on the basis of setting of the setting unit.

16. The information processing device according to claim 15, further comprising:
a data generation unit which generates the data,
wherein the file generation unit is configured to generate a file of the management information of the data generated by the data generation unit.

17. The information processing device according to claim 15, further comprising:
a transmission unit which transmits the file generated by the file generation unit to a server.

18. An information processing method comprising:
setting information regarding switching across first management units for managing a data group of same content of data to be reproduced in management information for managing reproduction of data of the content.

19. An information processing device comprising:
an analysis unit which analyzes information regarding switching across first management units for managing a data group of same content of data to be reproduced included in management information for managing reproduction of data of the content; and
a control unit which controls the switching of the data to be reproduced on the basis of an analysis result of the analysis unit.

20. An information processing method comprising:
analyzing information regarding switching across first management units for managing a data group of same content of data to be reproduced included in management information for managing reproduction of data of the content; and
controlling the switching of the data to be reproduced on the basis of an analysis result.
